(19) United States
(12) Patent Application Publication
(10) Pub. No.: US 2002/0043813 A1
(43) Pub. Date: Apr. 18, 2002

(54) Magnetic latching mechanism for a slide out room

(76) Inventors: Patrick W. McManus, Osceola, IN (US); Martin P. McManus, Mishawaka, IN (US)

Correspondence Address: BAKER & DANIELS, 205 W. JEFFERSON BOULEVARD, SUITE 250, SOUTH BEND, IN, 46601, US

(21) Appl. No.: 09/977,581

(22) Filed: Oct. 15, 2001

Related U.S. Application Data
(60) Provisional application No. 60/268,819, filed on Feb. 14, 2001.
(60) Provisional application No. 60/240,235, filed on Oct. 13, 2000.

(51) Int. Cl. B62D 33/08

(52) U.S. Cl. 296/26.13

(57) ABSTRACT

A latching mechanism for a slide out room of mobile living quarters that latches the slide out room to the side wall of the living quarters, sealing the fascia of the slide out room to the side wall when the slide out room is in the retracted position. The seal formed prevents moisture or other contaminants from entering the inner space of the mobile living quarters. Compressible bubble seal is used to further seal off the inner space from the elements ensuring better protection of the slide out room while it is in the retracted position. In an effort to increase the effectiveness of the magnetic seal, booster magnets may be utilized, along with many different variations of magnetic camming mechanisms. Separation of the slide out room from the mobile living quarters is achieved through a number of manual releases intended to overcome the magnetic sealing force, allowing the slide out room to be extended.

This application claims the benefit of U.S. Provisional Patent Application Serial Nos. 60/240,235, filed Oct. 13, 2000, and 60/268,819, filed Feb. 14, 2001, the complete disclosure of which is hereby expressly incorporated by reference.

### BACKGROUND OF THE INVENTION

1. Field Of the Invention

This invention relates to a latching mechanism for latching a slide out room of mobile living quarters (such as a recreational vehicle) to the main living area when the slide out room is retracted into the main living area.

2. Review of the Prior Art

The width of mobile living quarters, such as recreational vehicles, is limited to that which may be accommodated for travel on the highways. Accordingly, it has become common to provide slide out rooms which can be retracted into the vehicle during travel, and extended to enlarge the living area of the vehicle when parked. For example, a common slide out area is in the living room area where a sofa abuts the back wall of the slide out room. When the vehicle living area is to be enlarged, the slide out room together with the sofa is moved outwardly from the vehicle to enlarge the floor space of the vehicle. Other living areas, such as a sleeping area, may also be enlarged by using a slide out room.

Slide out rooms are normally supported by telescoping tubes which are mounted to the frame supporting the main living area, and are driven between the extended and retracted positions by hydraulic rams or electric motors. Sealing material is provided around the perimeter of the room to seal the slide out room in both the retracted and extended positions. Slide out rooms, however, are only semi-rigid, and portions of the rooms farthest from the hydraulic rams or motors are not sufficiently rigid to ensure that the seals are compressed. Such driving mechanisms can be adjusted so that the portions of the room closest to the rams (typically the bottom of the room) are drawn firmly against the seals when the room is retracted, but the portion of the room farthest from the rams (typically the top of the room) may deflect sufficiently such that the seals are not engaged.

A variety of attempts have been made to rectify this situation. First, some manufacturers have created the slide out room in a trapezoidal shape, as viewed from the side, such that the leading edge of the room is the top edge of the back wall. Others have attempted to “jack” the lower edge upwardly so as to cause a tilting of the room inwardly at the upper edge. Alternatively, so-called “travel locks” may be used to latch and maintain the upper edge of a slide out room in the retracted position in firm engagement with the seals around the perimeter of the vehicle opening which receives the room. However, these travel locks must be engaged and disengaged manually. Manual travel locks may be inconvenient to operate because they are generally positioned on the inside of the vehicle near the ceiling. Moreover, vehicle owners may forget to disengage the locks and attempt to move the room to the extended position, causing damage to any of the locks, the room and the vehicle.

Most manufacturers provide slide out rooms with a back wall having a peripherally extending lip or fascia that projects outwardly in all directions beyond the outer room dimensions such that when the room is in the fully retracted position, the fascia is flush with the vehicle side wall. At least one sealing bead is typically provided which extends along the periphery of the fascia and becomes compressed between the fascia and the vehicle side wall when the room is fully retracted. Thus, any latching mechanism which is devised should not violate the integrity of this seal during installation or operation.

An additional sealing function is typically provided by a wiper seal which is located on the inwardly facing side and top edges of the room opening defined by the vehicle side wall. The wiper seal flexes against the slide out room to remove water and debris from the room side walls and ceiling to prevent such water and debris from entering the main living area. This wiper seal also should not be violated or damaged in any way.

The present invention provides a latching mechanism for a slide out room that magnetically latches the slide out room to the vehicle side wall so that the sealing around the periphery of the room is engaged with the vehicle side wall, thereby preventing entry of moisture or other environmental elements into the vehicle. The latching mechanism magnetically draws the slide out room into engagement with the vehicle side wall as the room approaches the retracted position, and retains the room in the retracted position. The latching mechanism may also automatically disengage as the room begins to move away from the fully retracted position. Accordingly, the risk that the vehicle operator forgets to engage or disengage the latching mechanism is effectively eliminated. These and other advantages of the present invention will become more apparent and the invention better understood by reference to the following description in conjunction with the accompanying drawings.

### BRIEF DESCRIPTION OF THE DRAWINGS

FIG. 1 is a perspective view of a recreational vehicle having a slide out room shown in an extended position.

FIG. 2 is a perspective view similar to FIG. 1.

FIG. 3 is a partially fragmented, cross-sectional, side elevational view of a recreational vehicle with a slide out room in a retracted position.

FIG. 4 is a partially fragmented, perspective view of a latching mechanism according to the present invention.

FIG. 5 is a partially fragmented, side elevational view of the latching mechanism of FIG. 4.

FIG. 6 is a partially fragmented, perspective view of another embodiment of the present invention.

FIG. 7A is a partially fragmented, top plan view of a slide out room with another embodiment of the latching mechanism according to the present invention.

FIG. 7B is a partially fragmented, perspective view of the embodiment shown in FIG. 7A

FIG. 7C is a side elevational view of the embodiment of FIGS. 7A and 7B.

FIG. 7D is a side elevational view of a modified version of the embodiment of FIGS. 7A-7C.

FIG. 8A is a partially fragmented, top plan view of another embodiment of a latching mechanism according to the present invention

FIG. 8B is a partially fragmented, perspective view of the embodiment shown in FIG. 8A.

FIG. 9A is a partially fragmented, top plan view of another embodiment of the present invention.

FIG. 9B is a partially fragmented, perspective view of the embodiment shown in FIG. 9A.

FIG. 10 is a partially fragmented, perspective view of another embodiment of the present invention.

FIG. 11A is a partially fragmented, perspective view of another embodiment of the present invention.

FIG. 11B is a partially fragmented, side elevational view of a modified version of the embodiment of FIG. 11A.

FIG. 12 is a partially fragmented, perspective view of another embodiment of the present invention.

FIG. 13A is a partially fragmented, perspective view of another embodiment of the present invention.

FIG. 13B is a view similar to FIG. 13A.

FIG. 14A is a partially fragmented, top plan view of another embodiment of the present invention.

FIG. 14B is a partially fragmented, side elevational view of a portion of the embodiment shown in FIG. 14A.

FIG. 14C is a partially fragmented, top plan view of a variation of the embodiment shown in FIG. 14A.

FIG. 14D is a partially fragmented, side elevational view of a portion of a variation of the embodiment shown in FIG. 14A.

FIG. 15A is a partially fragmented, top plan view of another embodiment of the present invention.

FIG. 15B is a partially fragmented, top plan view of a variation of the embodiment shown in FIG. 15A

FIG. 16A is a partially fragmented, top plan view of another embodiment of the present invention.

FIG. 16B is a partially fragmented, top plan view of a variation of the embodiment shown in FIG. 16A.

FIG. 17A is a partially fragmented, top plan view of another embodiment of the present invention.

FIG. 17B is a partially fragmented, top plan view of a variation of the embodiment shown in FIG. 17A.

FIG. 18A is a partially fragmented, top plan view of another embodiment of the present invention.

FIG. 18B is a partially fragmented, top plan view of a variation of the embodiment shown in FIG. 18A.

FIG. 19A is a partially fragmented, top plan view of another embodiment of the present invention.

FIG. 19B is a partially fragmented, top plan view of a variation of the embodiment shown in FIG. 19A

FIG. 20A is a partially fragmented, top plan view of another embodiment of the present invention.

FIG. 20B is a partially fragmented, top plan view of a variation of the embodiment shown in FIG. 20A.

FIG. 21A is a partially fragmented, top plan view of another embodiment of the present invention.

FIG. 21B is a partially fragmented, top plan view of a variation of the embodiment shown in FIG. 21A.

FIG. 22A is a partially fragmented, top plan view of another embodiment of the present invention.

FIG. 22B is a partially fragmented, top plan view of a variation of the embodiment shown in FIG. 22A.

FIG. 23A is a partially fragmented, top plan view of another embodiment of the present invention.

FIG. 23B is a partially fragmented, top plan view of a variation of the embodiment shown in FIG. 23A.

FIGS. 24A-24C are partially fragmented, top plan views of another embodiment of the present invention.

FIG. 25A is a partially fragmented, top plan view of another embodiment of the present invention.

FIG. 25B is a partially fragmented, top plan view of a variation of the embodiment shown in FIG. 25A.

FIG. 26A is a partially fragmented, top plan view of another embodiment of the present invention.

FIG. 26B is a partially fragmented, top plan view of a variation of a portion of the embodiment shown in FIG. 26A.

FIG. 26C is a partially fragmented, top plan view of a variation of the embodiment shown in FIG. 26A.

FIG. 27A is a partially fragmented, top plan view of another embodiment of the present invention.

FIG. 27B is a partially fragmented, top plan view of a variation of the embodiment shown in FIG. 27A.

FIG. 28 are partially fragmented, top plan views of another embodiment of the present invention.

FIG. 29 is a partially fragmented, top plan view of the embodiment shown in FIG. 28 in a engaged position.

FIGS. 30A and 30B are a partially fragmented, top plan views of another embodiment of the present invention.

FIG. 31 is a partially fragmented, top plan view of another embodiment of the present invention.

FIG. 32 is a partially fragmented, top plan view of another embodiment of the present invention.

FIG. 33 is a partially fragmented, top plan view of another embodiment of the present invention.

FIG. 34 is a partially fragmented, perspective view of a manual release for use with a magnetic latching mechanism according to the present invention.

FIG. 35 is a partially fragmented, perspective view of another embodiment of a manual release.

FIG. 36 is a fragmented, side elevational view of another embodiment of a manual release.

FIG. 37 is a fragmented, side elevational view of another embodiment of a manual release.

FIG. 38 is a partially fragmented, perspective view of an automatic release for use with a magnetic latching mechanism according to the present invention.

FIGS. 39A and 39B are sectioned, perspective views of a vertically expandable mobile living area.

FIG. 40 is a sectioned, perspective view of a magnetic seal according to the present invention.

FIG. 41A is a sectioned, perspective view of another embodiment of a magnetic seal according to the present invention.

FIG. 42B is a sectioned, perspective view of a variation of the embodiment shown in FIG. 41A.

FIG. 42A is a sectioned, perspective view of another embodiment of a magnetic seal according to the present invention.

FIG. 42B is a sectioned, perspective view of a variation of the embodiment shown in FIG. 42A.

FIG. 43A is a sectioned, perspective view of another embodiment of a magnetic seal according to the present invention.

FIG. 43B is a sectioned, perspective view of a variation of the embodiment shown in FIG. 43A.

### DETAILED DESCRIPTION OF EMBODIMENTS OF THE INVENTION

The embodiments of the invention described herein are not intended to be exhaustive or to limit the invention to the precise forms disclosed. Rather, the embodiments selected for description have been chosen to enable one skilled in the art to practice the invention.

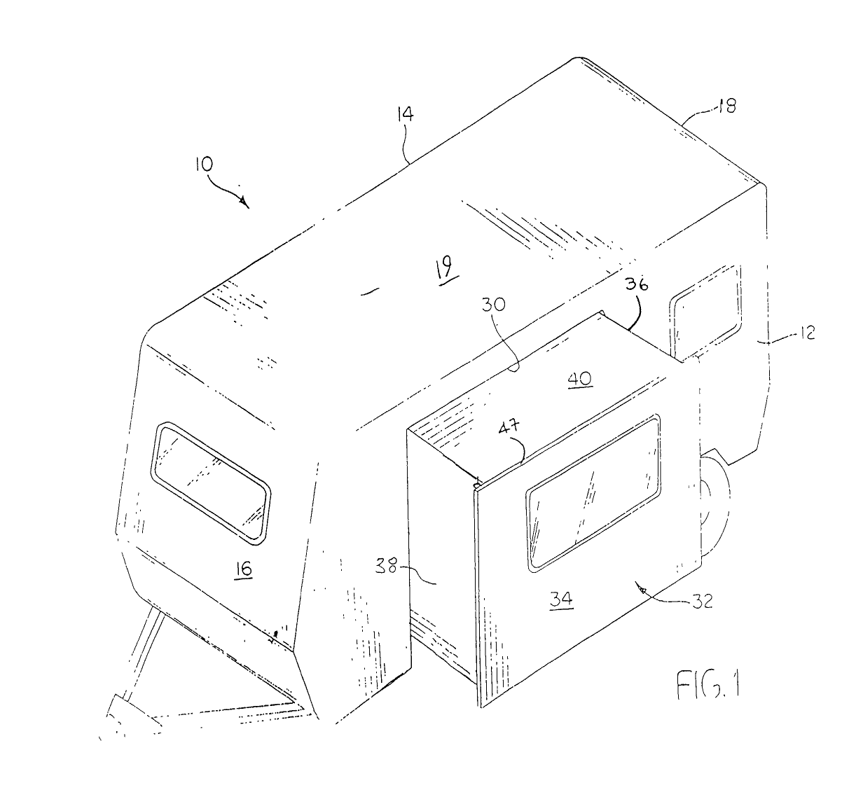

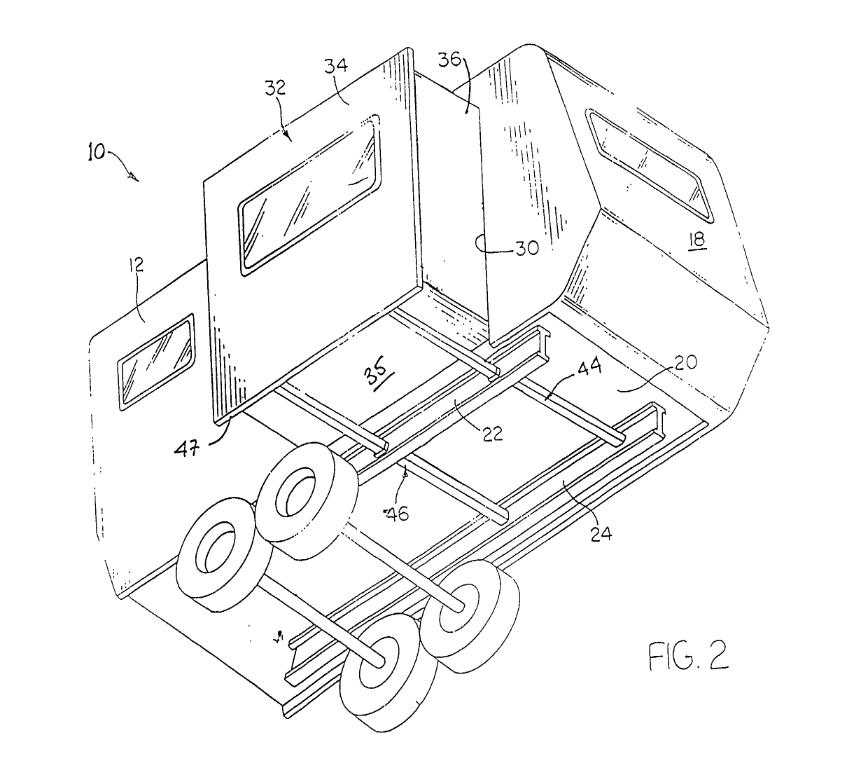

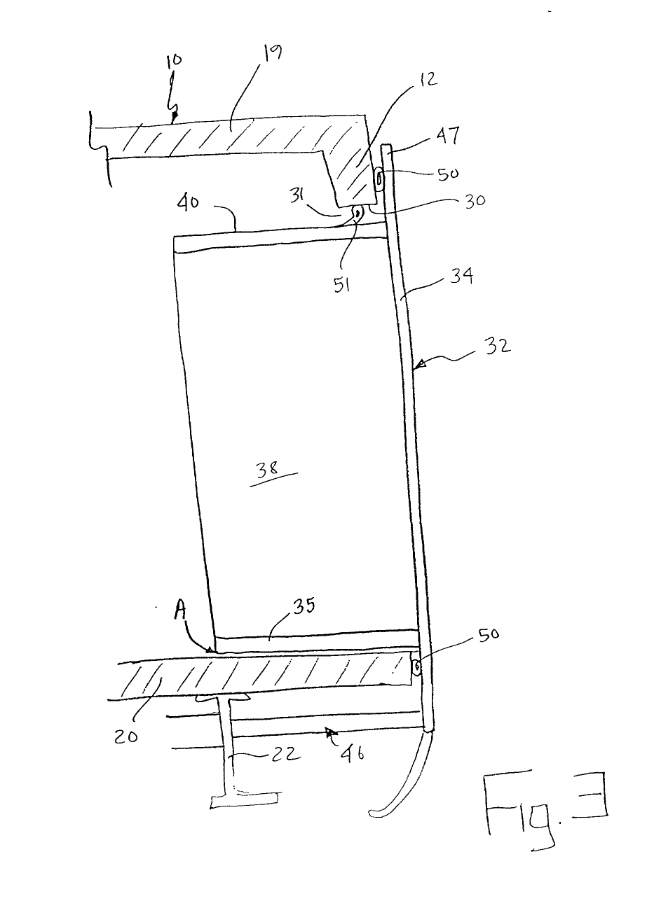

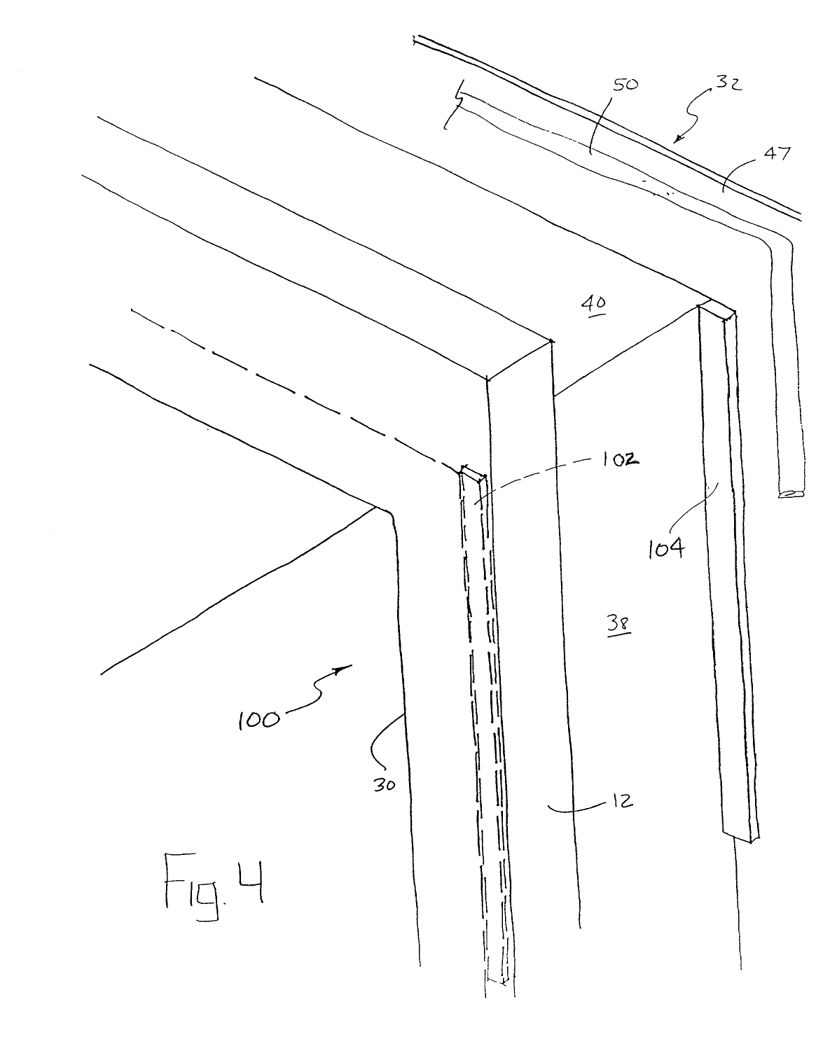

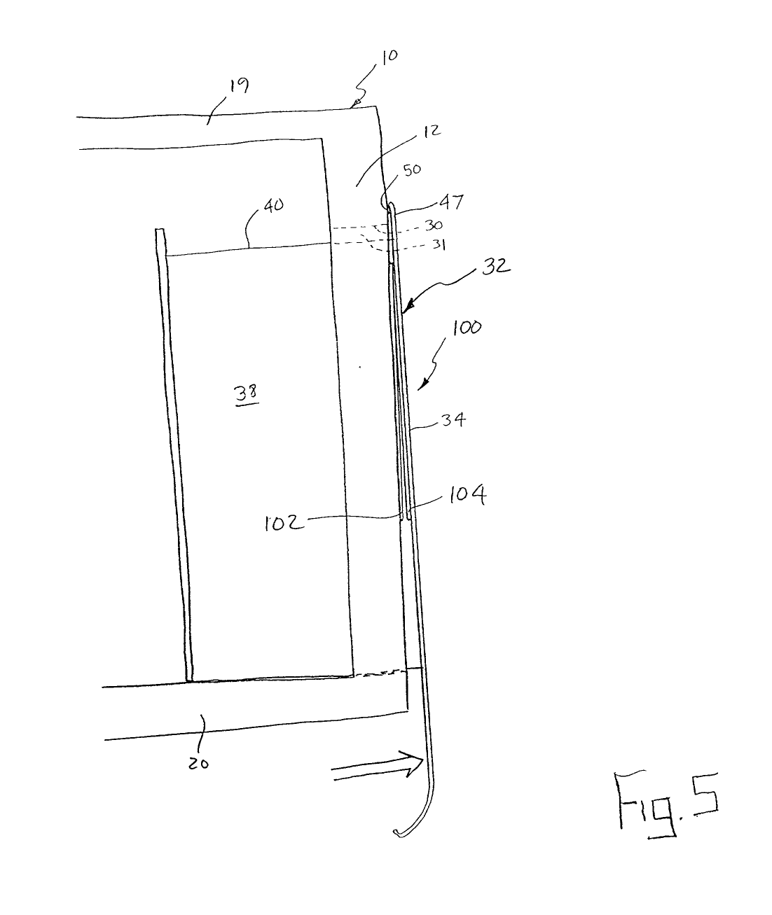

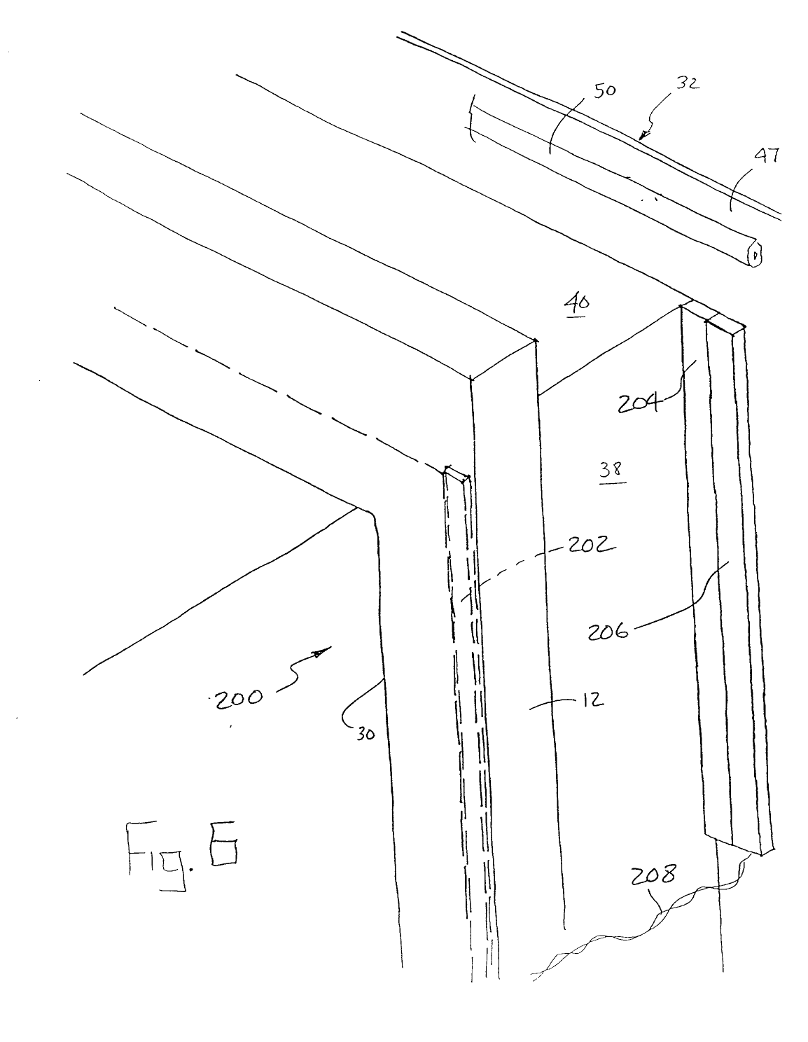

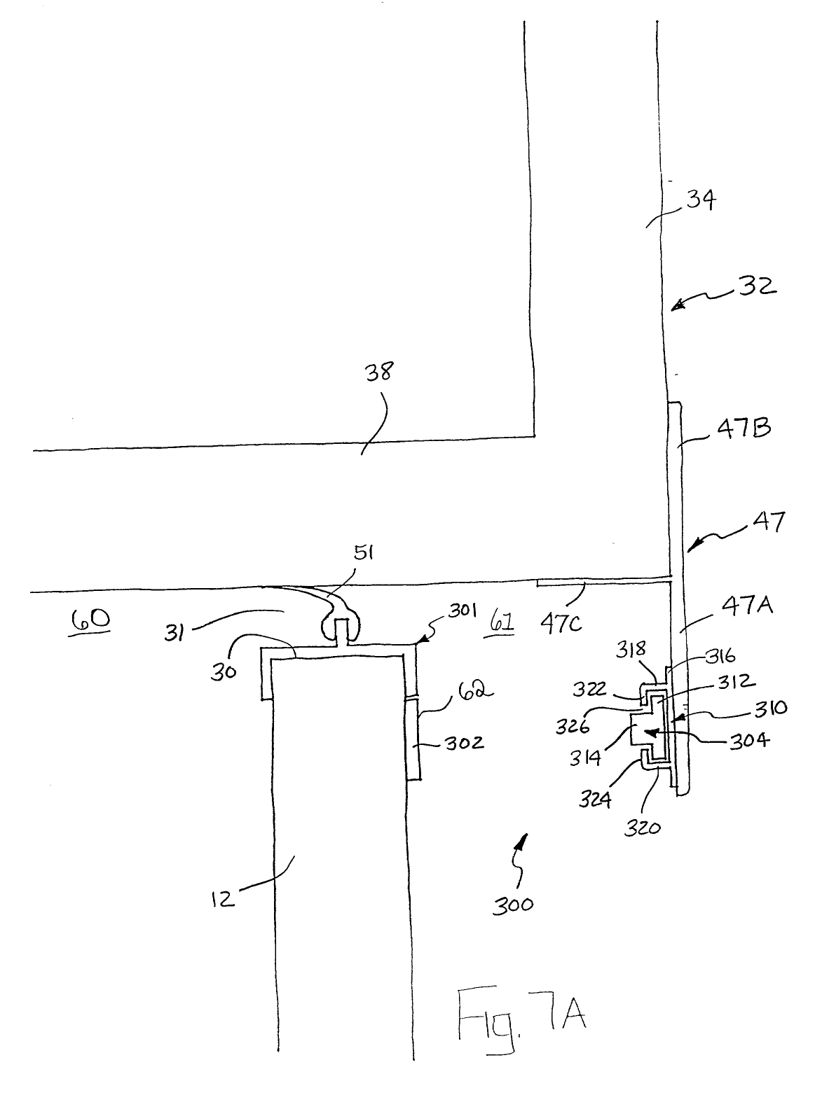

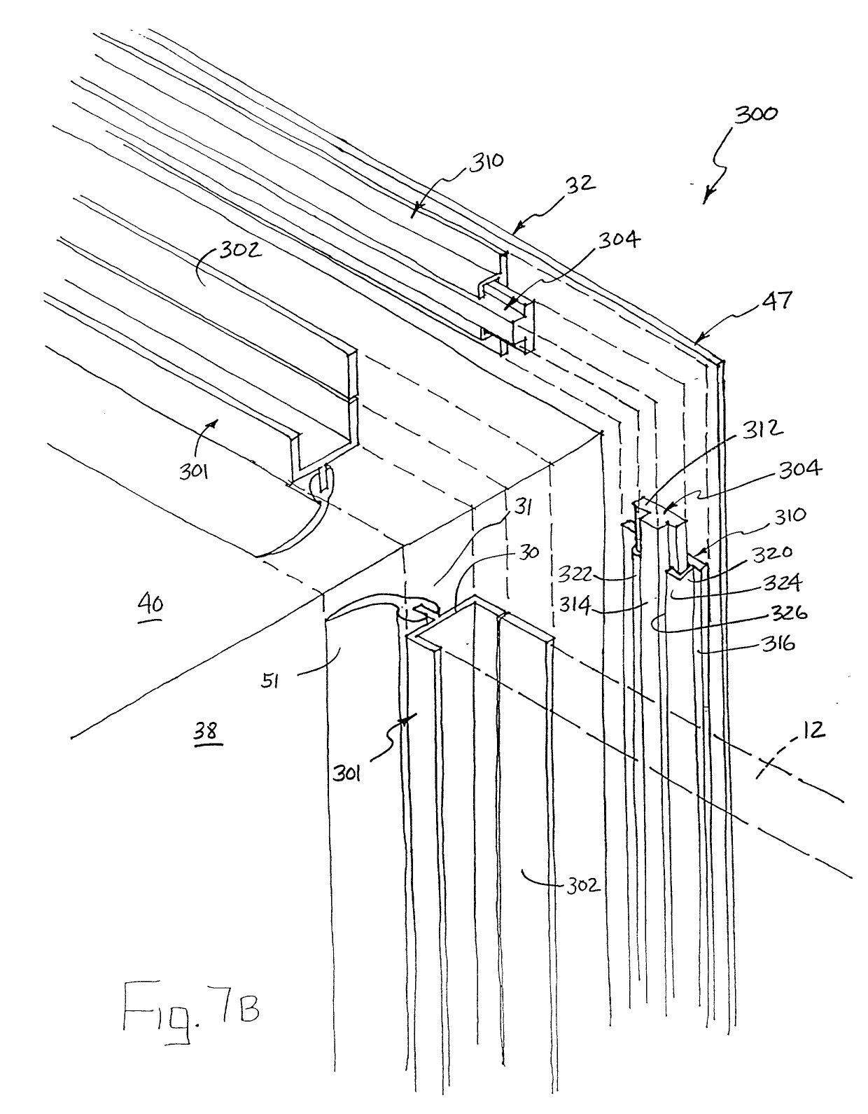

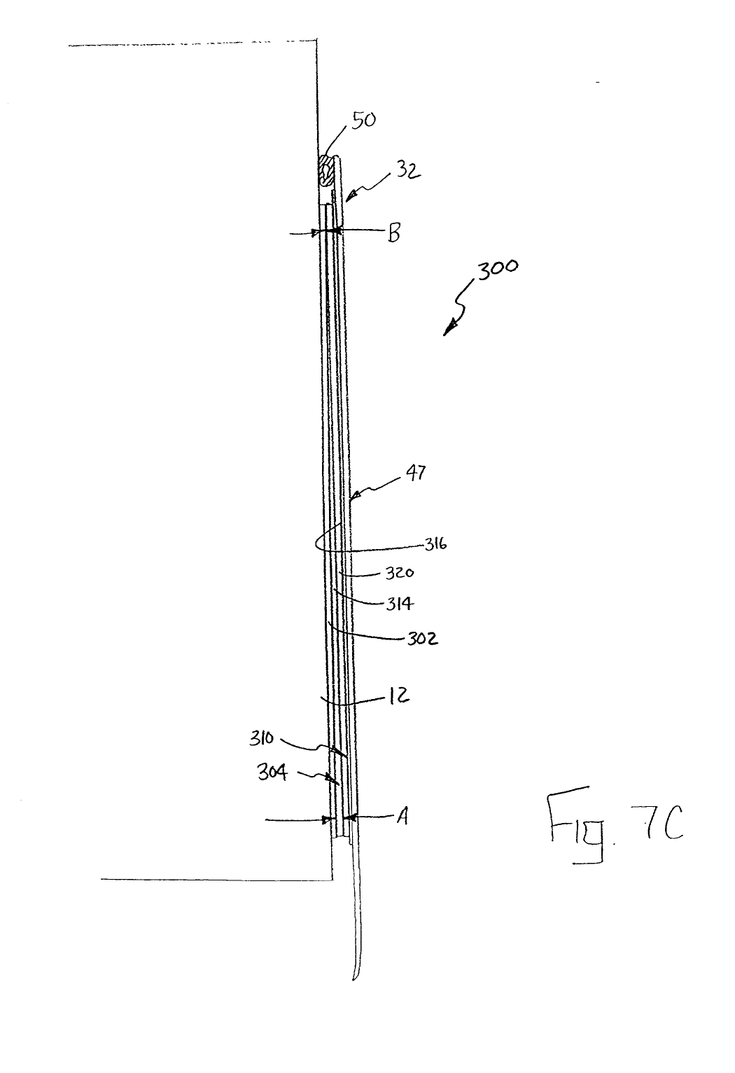

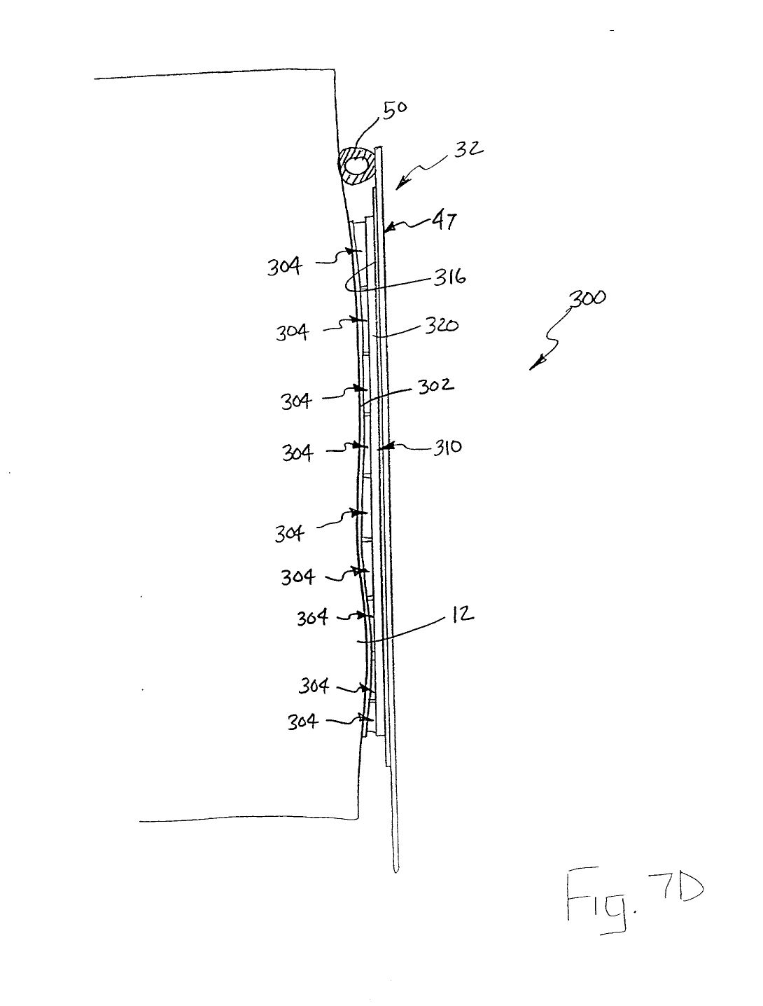

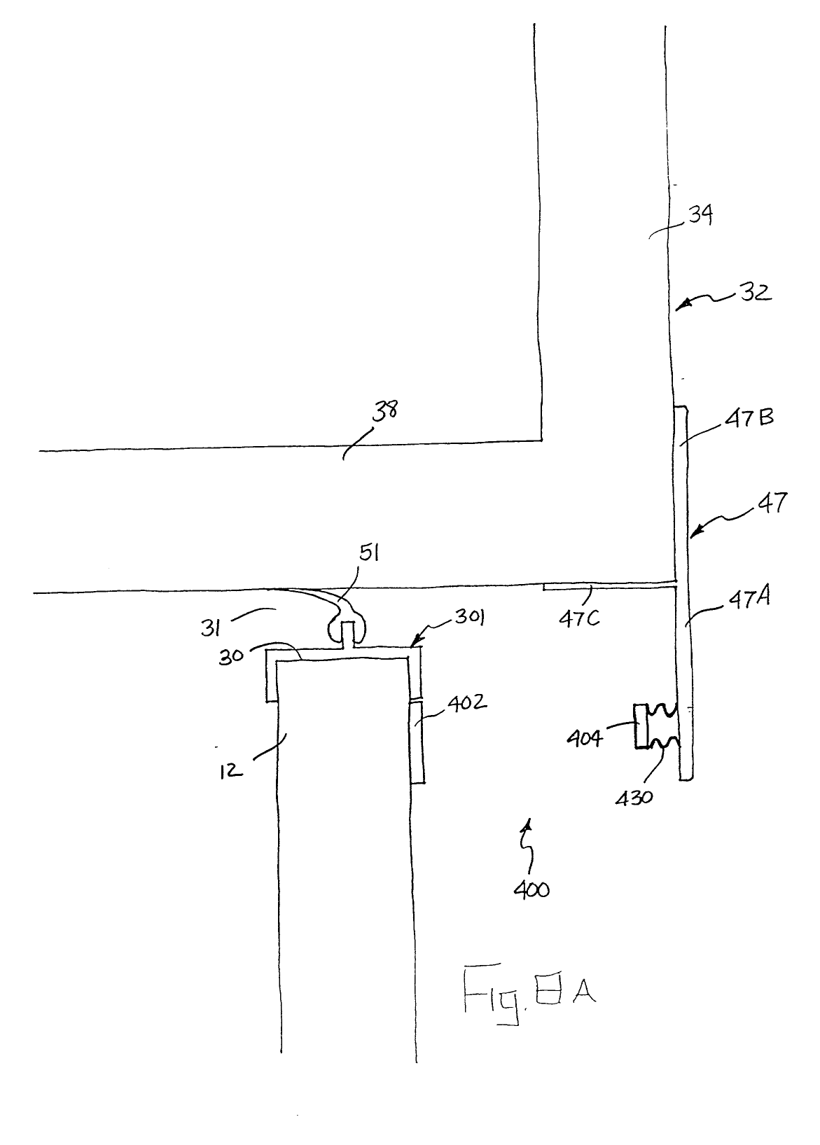

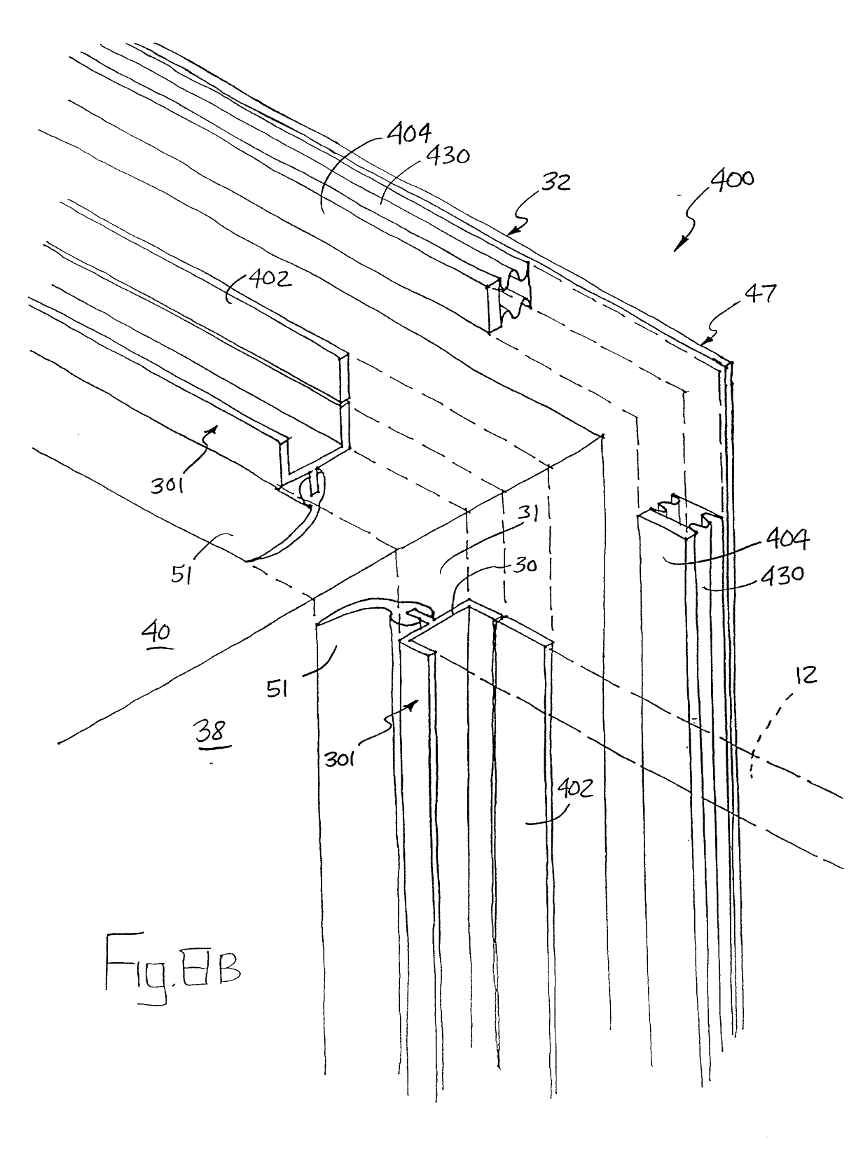

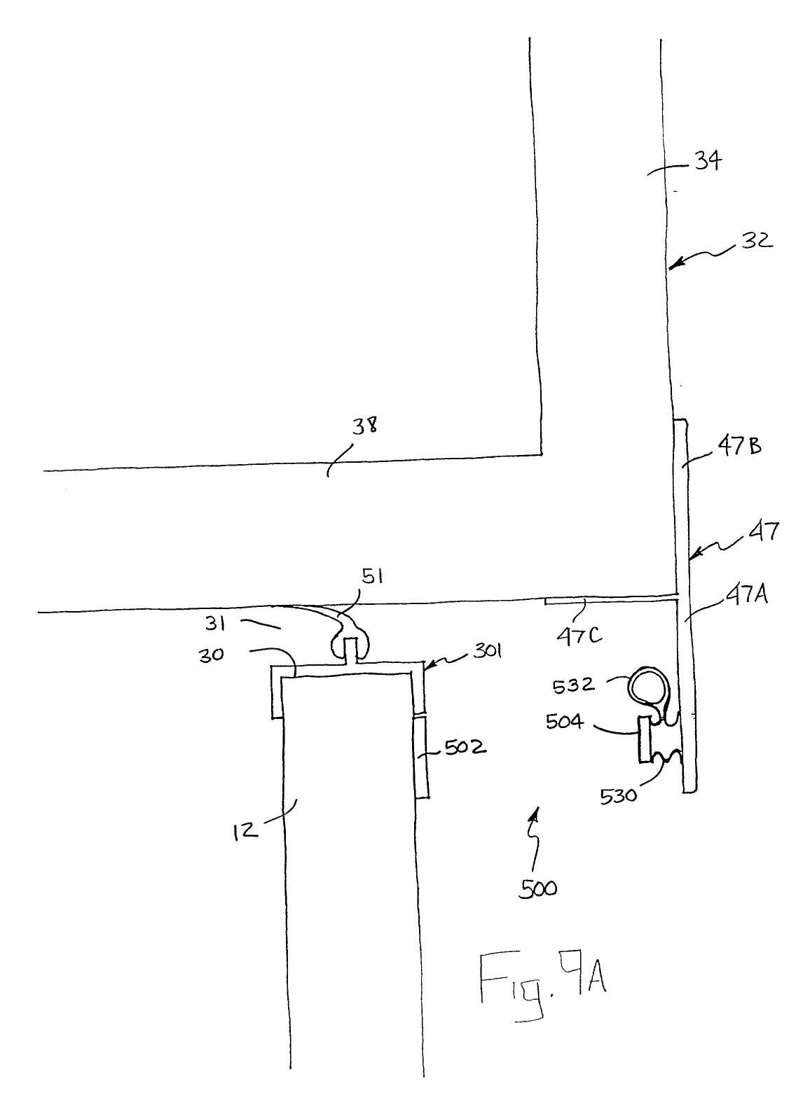

Referring now to the drawings, particularly FIGS. 1 and 2, a mobile living quarters or vehicle is generally indicated by the numeral 10. Vehicle 10 is defined by side walls 12 and 14, end walls 16 and 18, a ceiling 19, and a floor 20. As shown in FIG. 2, vehicle 10 is supported by longitudinally extending, transversely spaced frame members 22, 24. Side wall 12 defines an opening 30 for receiving a slide out room generally indicated by the numeral 32, which may be moved away from vehicle 10 to an extended position to provide auxiliary living space when vehicle 10 is parked for use, and moved into vehicle 10 through opening 30 to a retracted position when vehicle 10 is to be moved.

Slide out room 32 includes a back wall 34, a ceiling 40, a floor 35 and opposite side walls 36, 38. Room 32 is supported for movement between the extended and retracted positions by a drive mechanism of conventional design including telescoping support members generally indicated by the numerals 44, 46. Back wall 34 includes a lip portion or fascia 47 that projects beyond ceiling 40, floor 35 and side walls 36, 38.

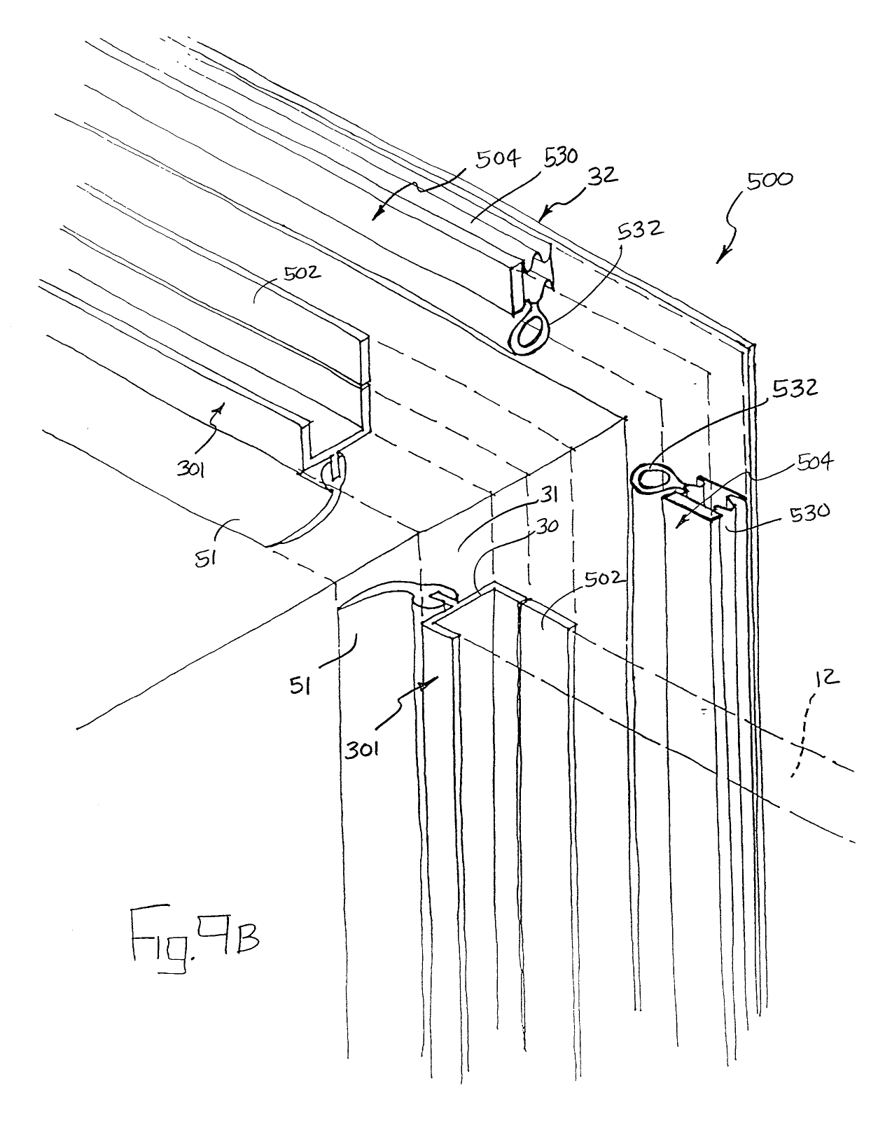

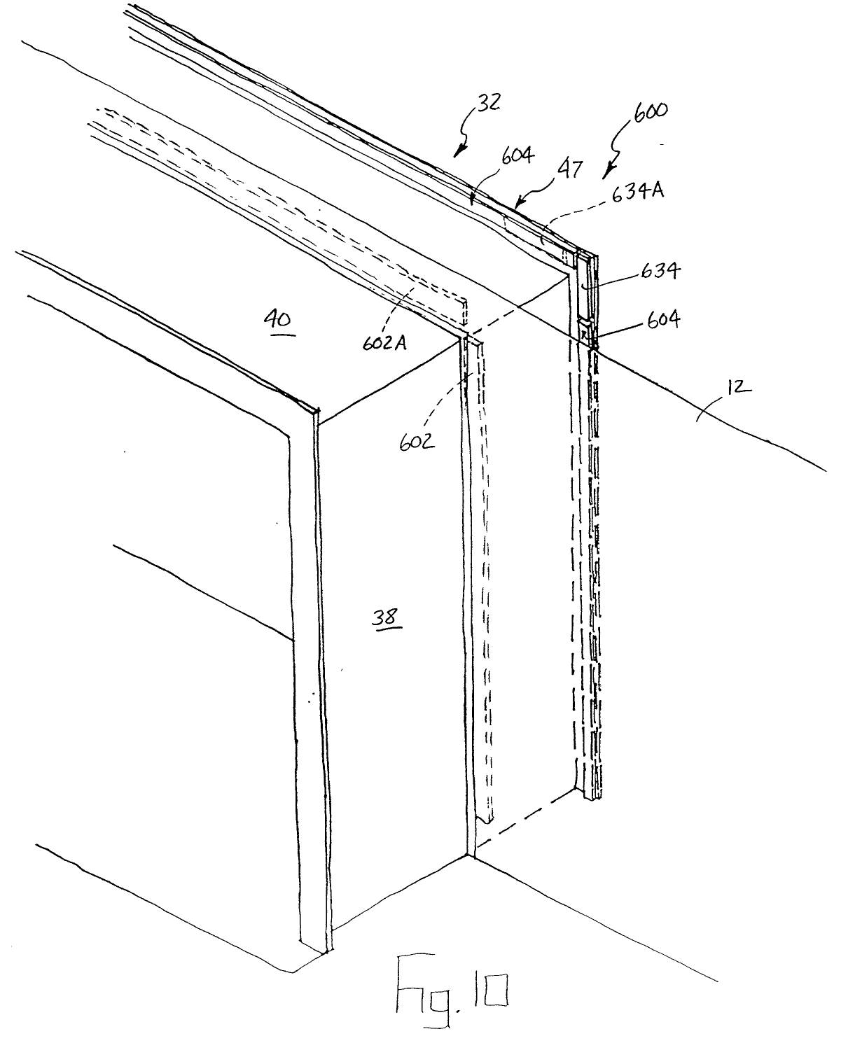

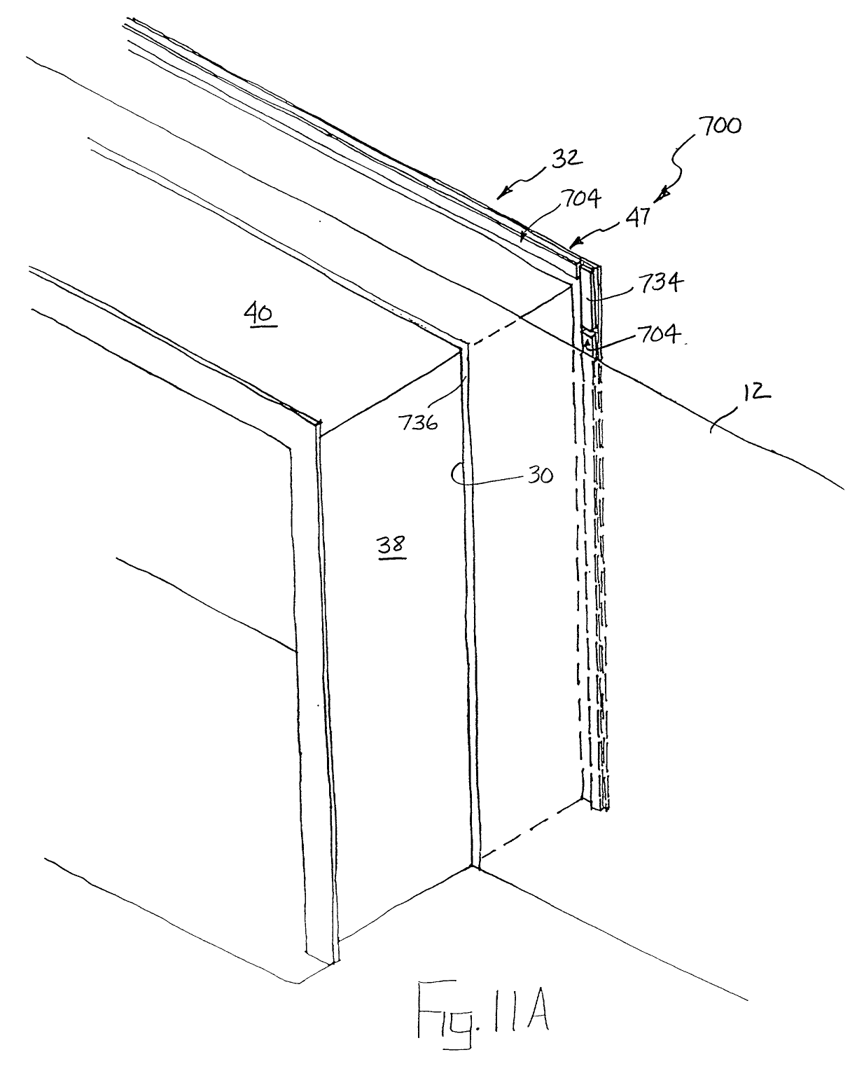

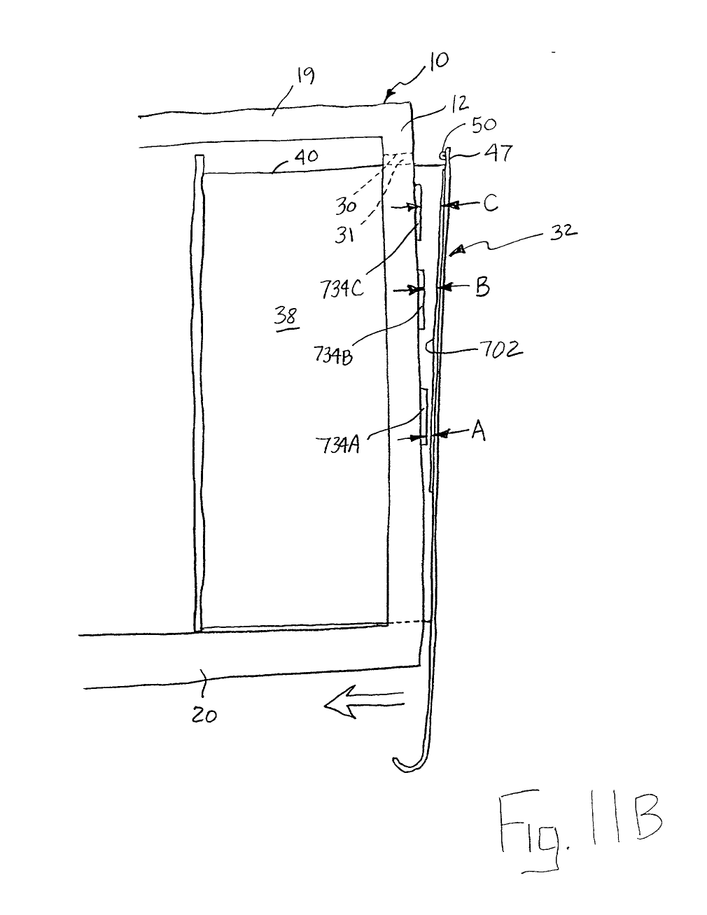

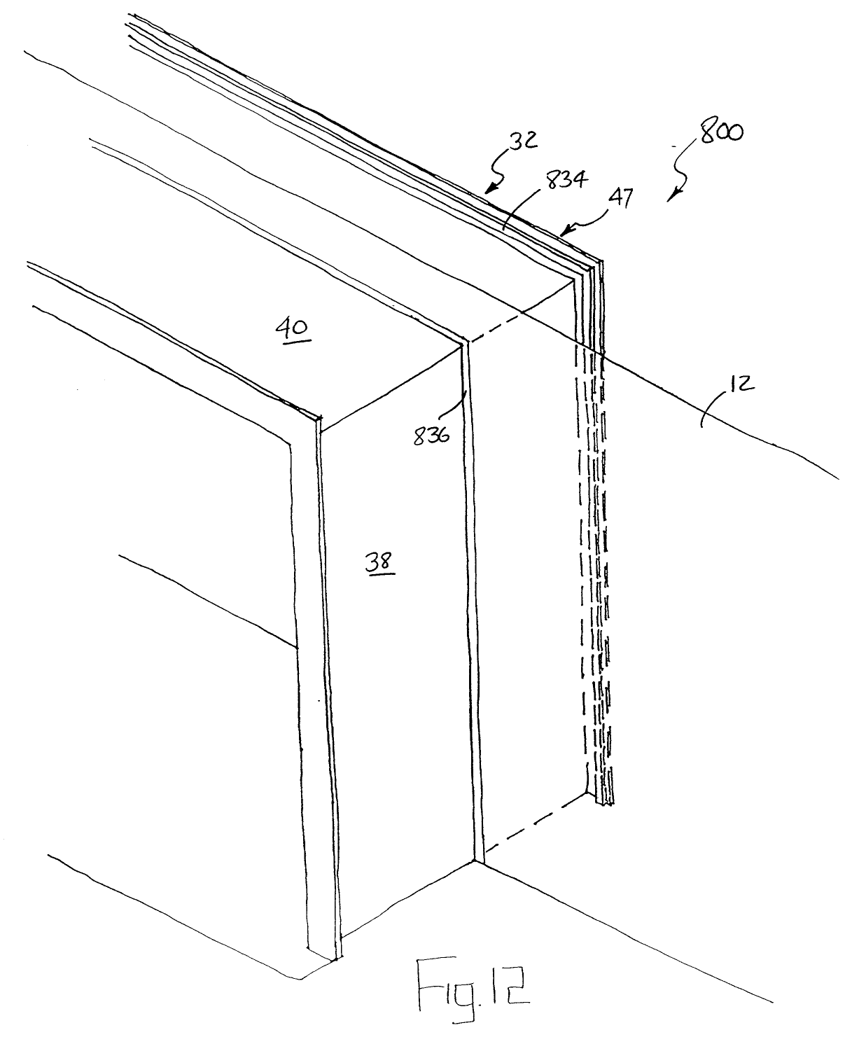

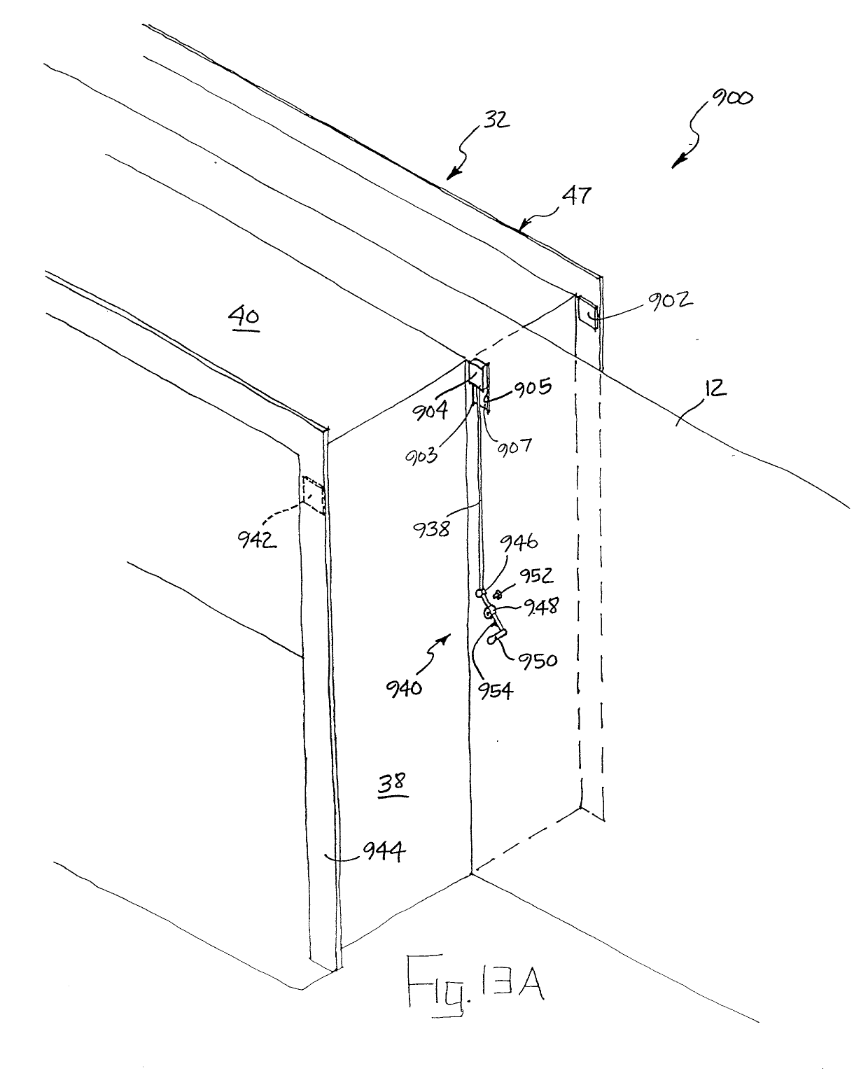

As shown in FIG. 3, a conventional bulb seal 50 extends around the perimeter of fascia 47 and is compressed between fascia 47 and vehicle side wall 12 around the perimeter of opening 30. A conventional wiper seal 51 is mounted within the gap 31 formed between opening 30, room ceiling 40 and room side walls 36, 38. Wiper seal 51 engages room 32 in a conventional manner to remove water and debris from the room as the room is retracted into vehicle 10.

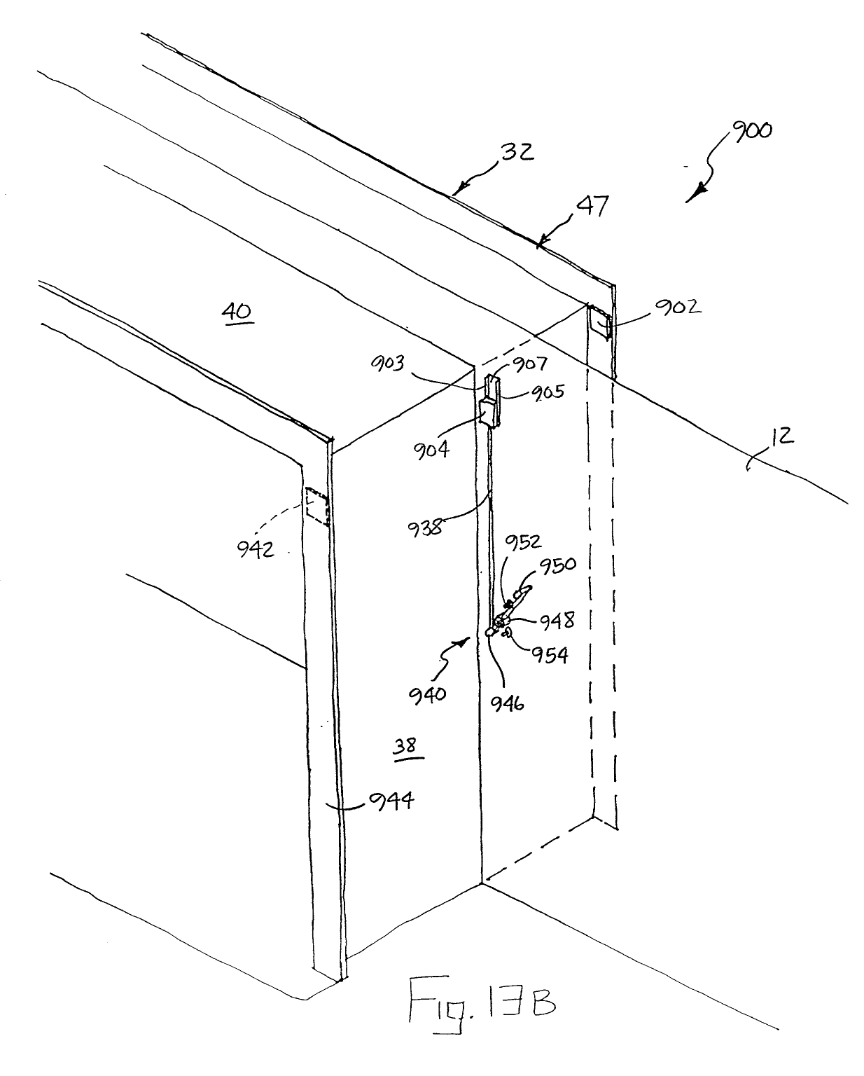

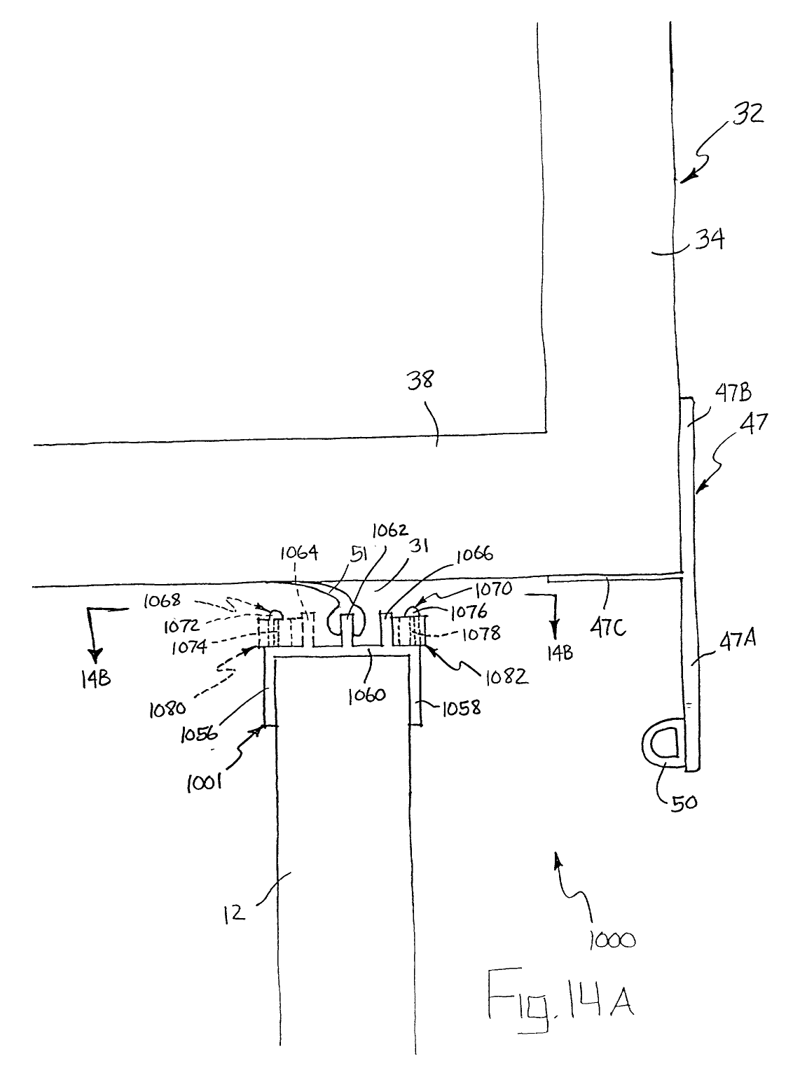

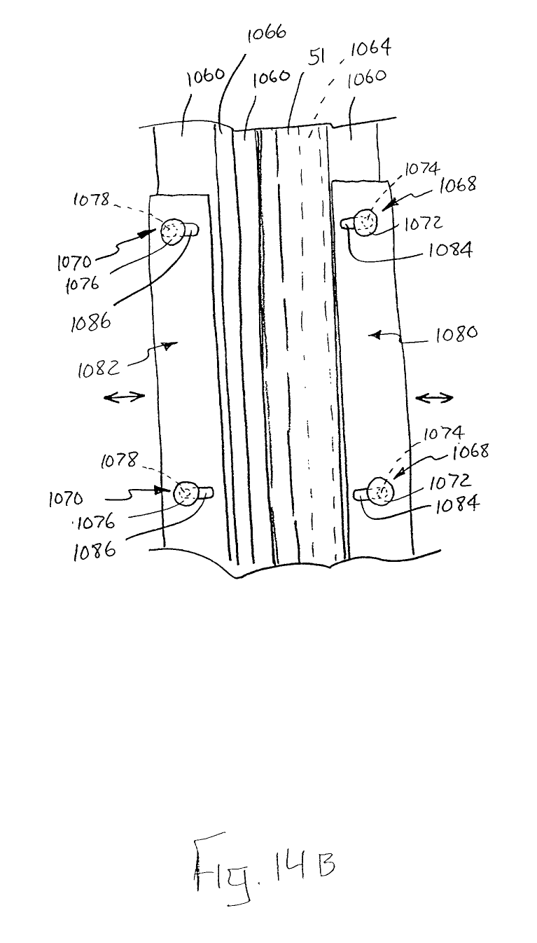

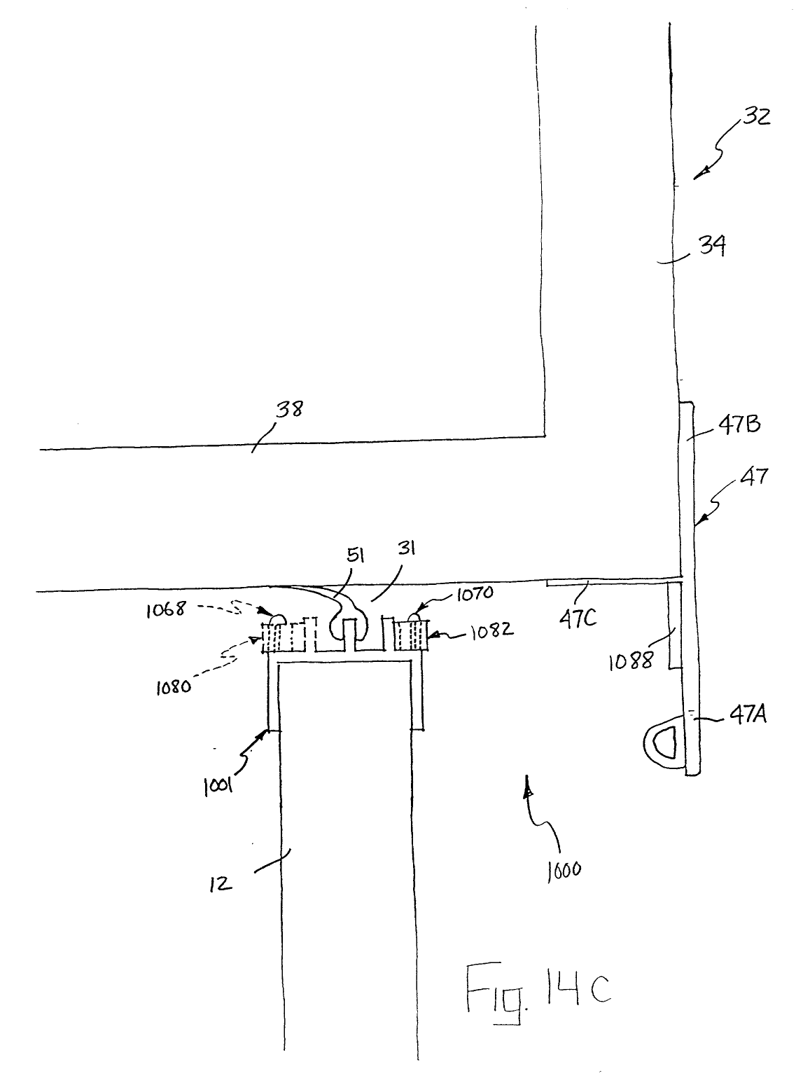

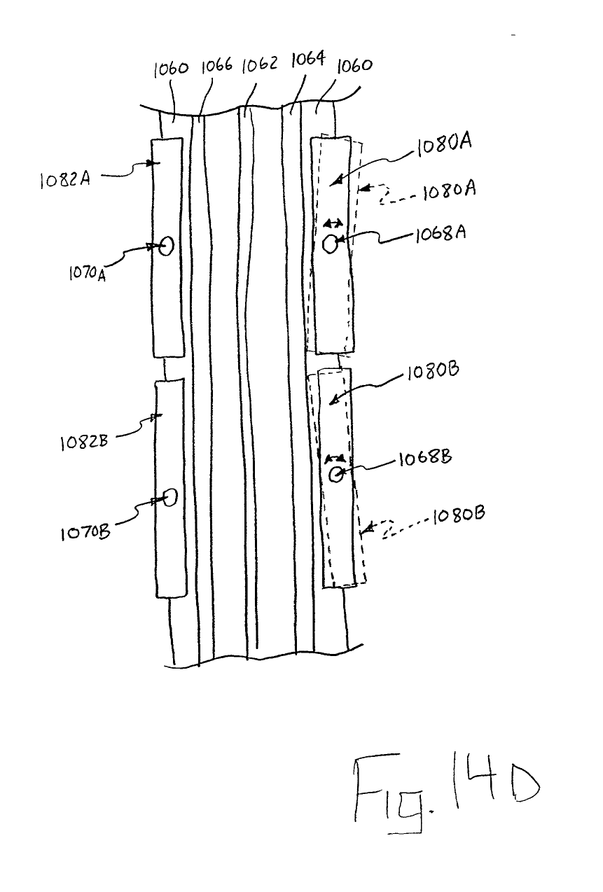

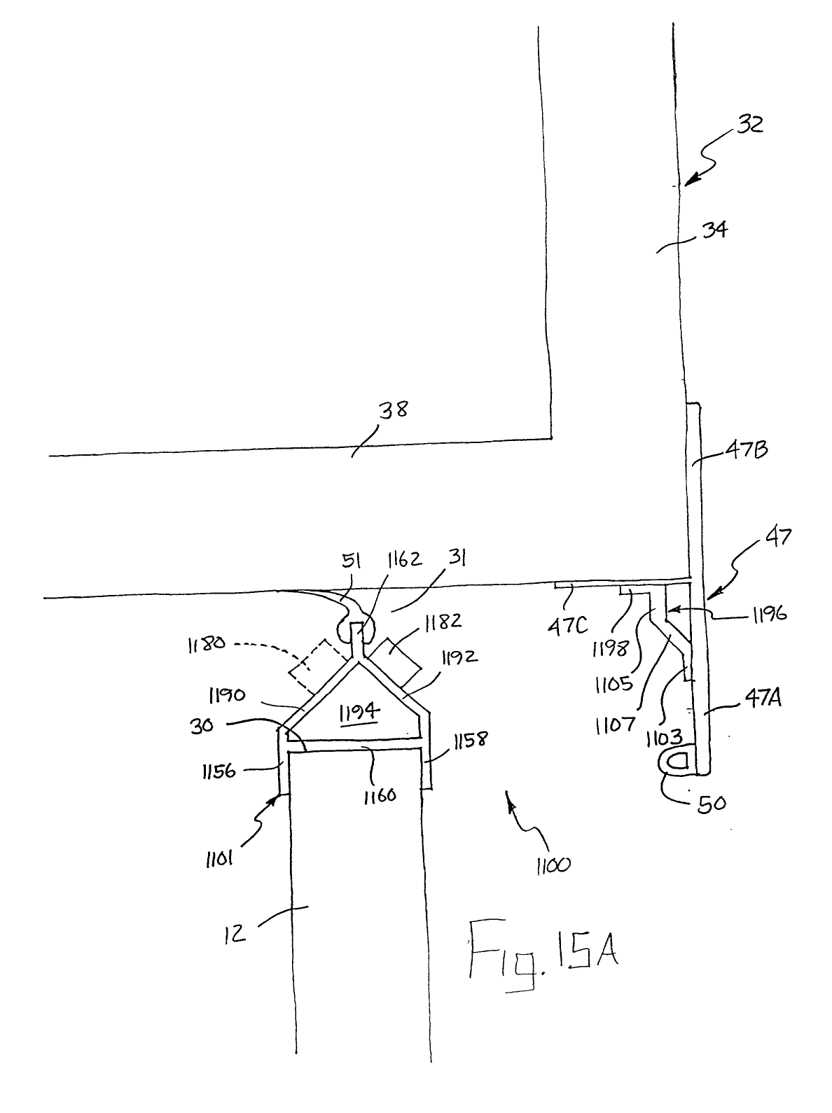

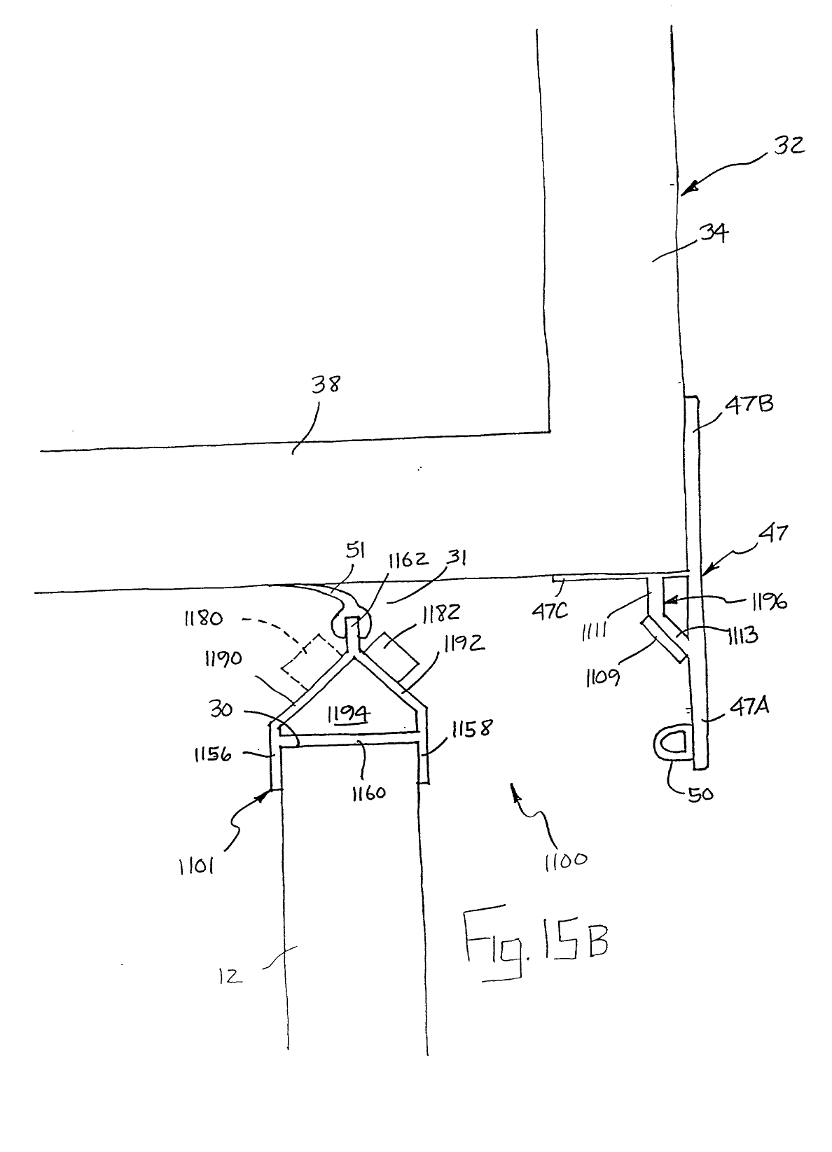

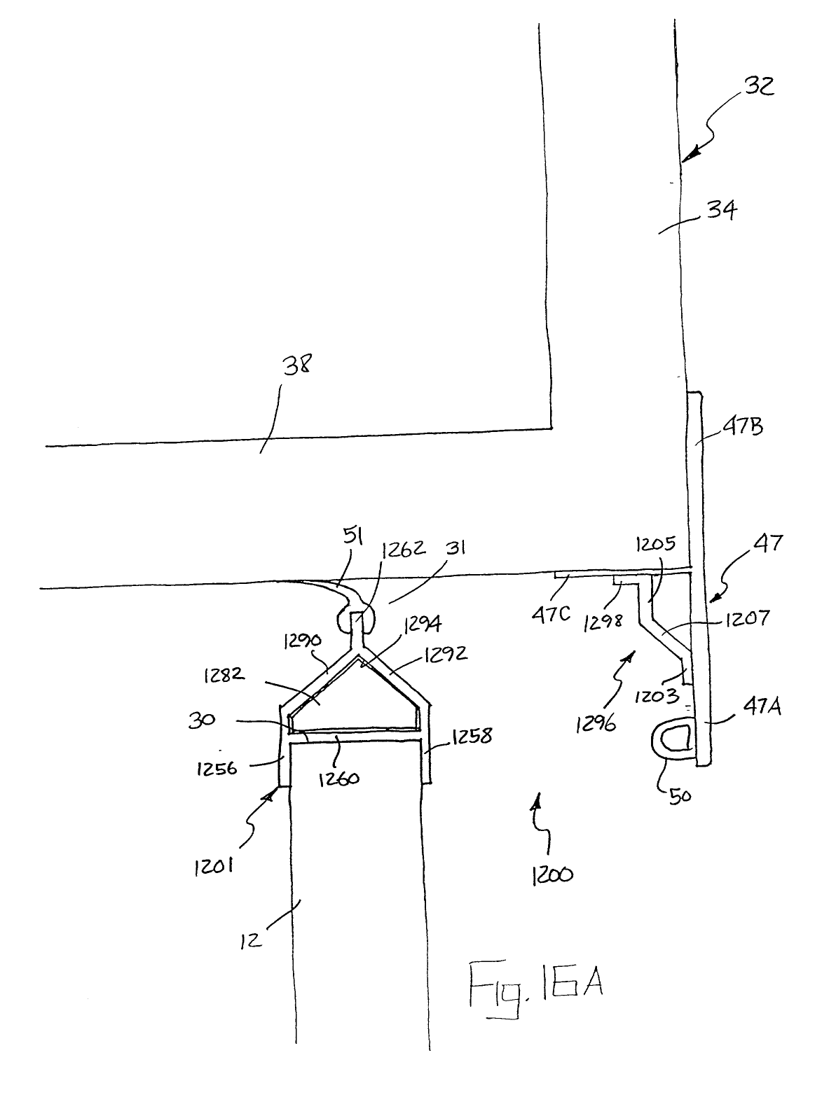

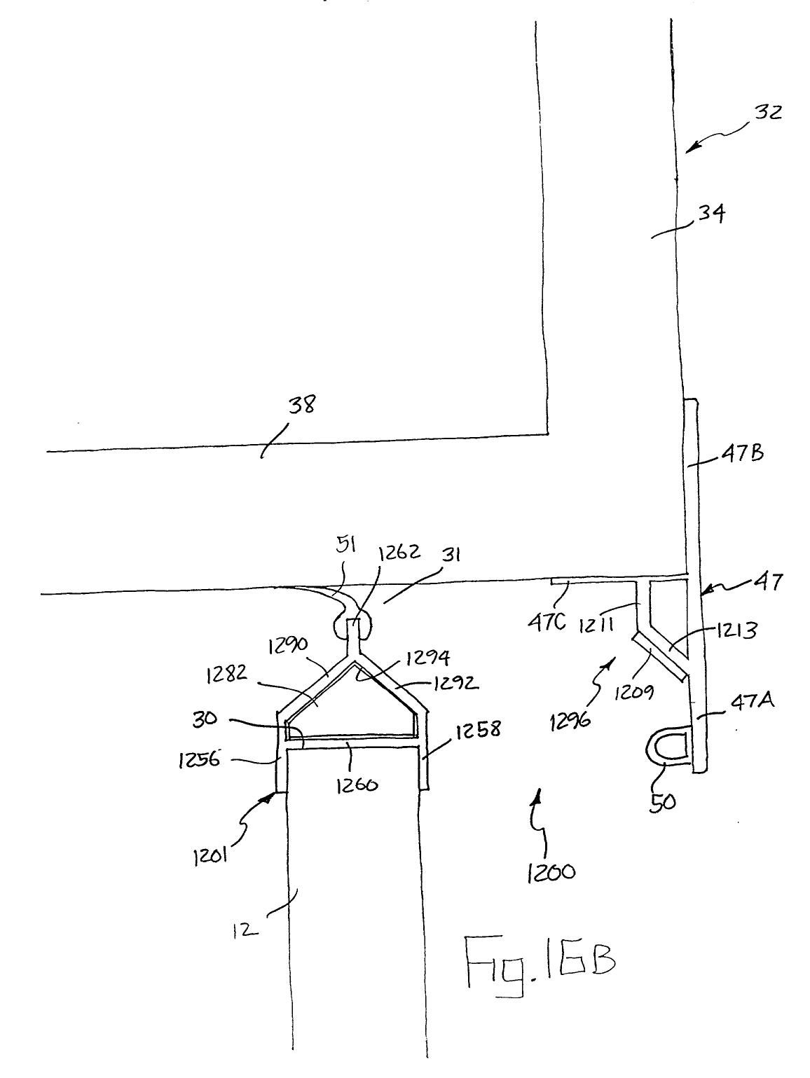

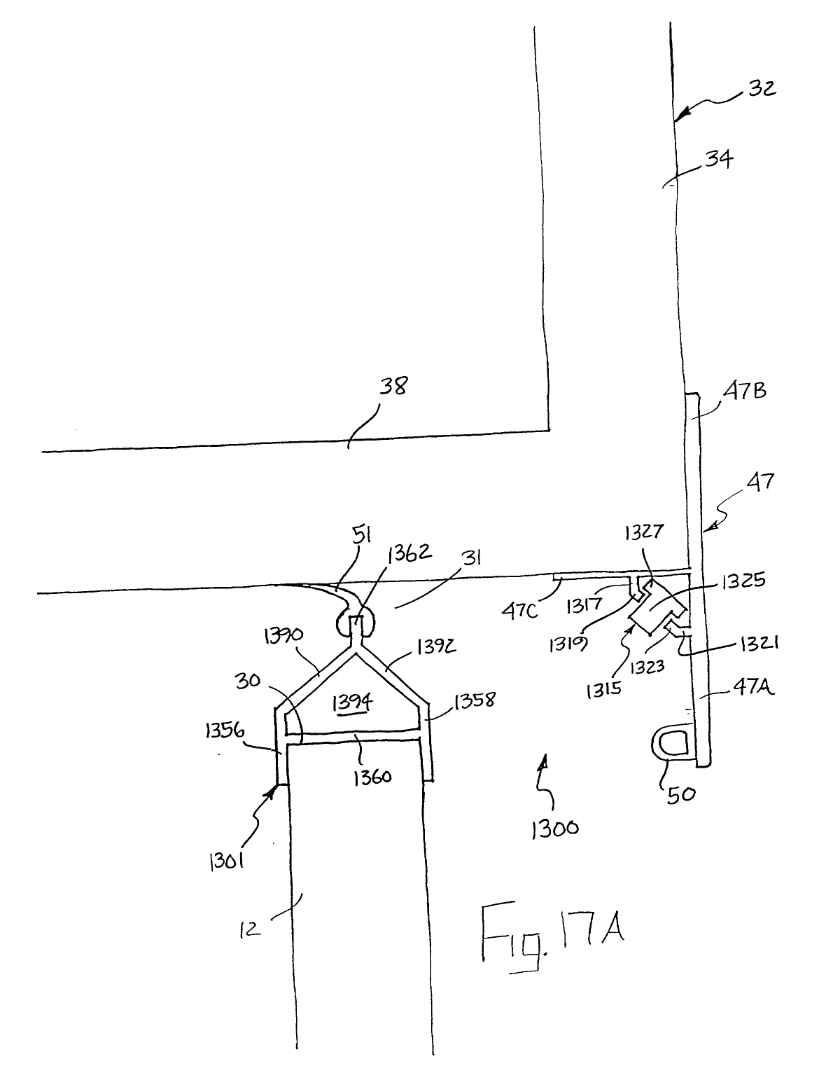

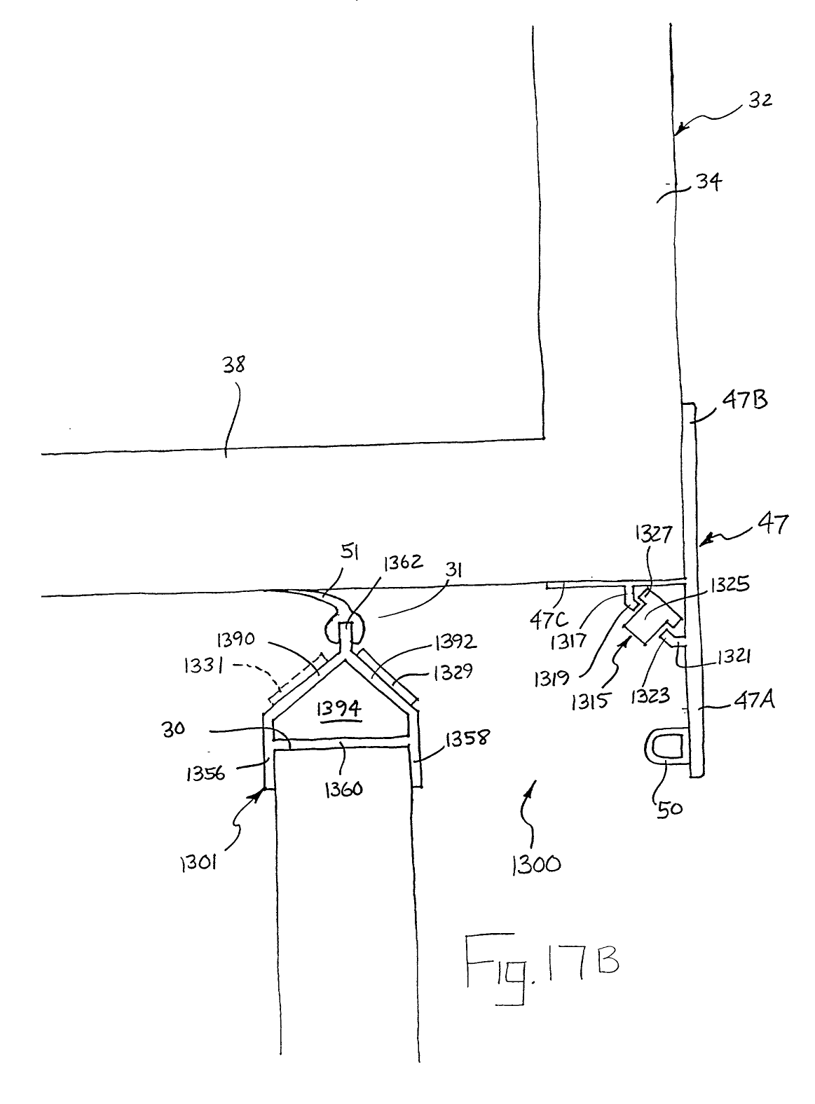

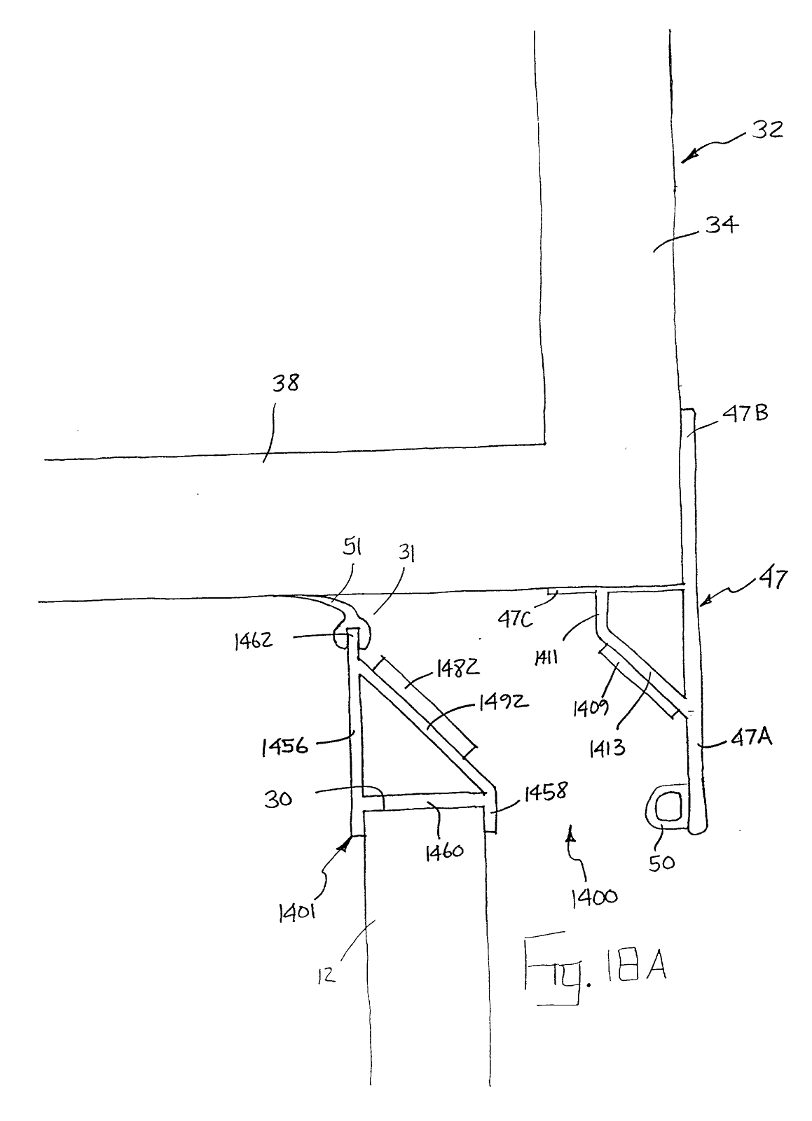

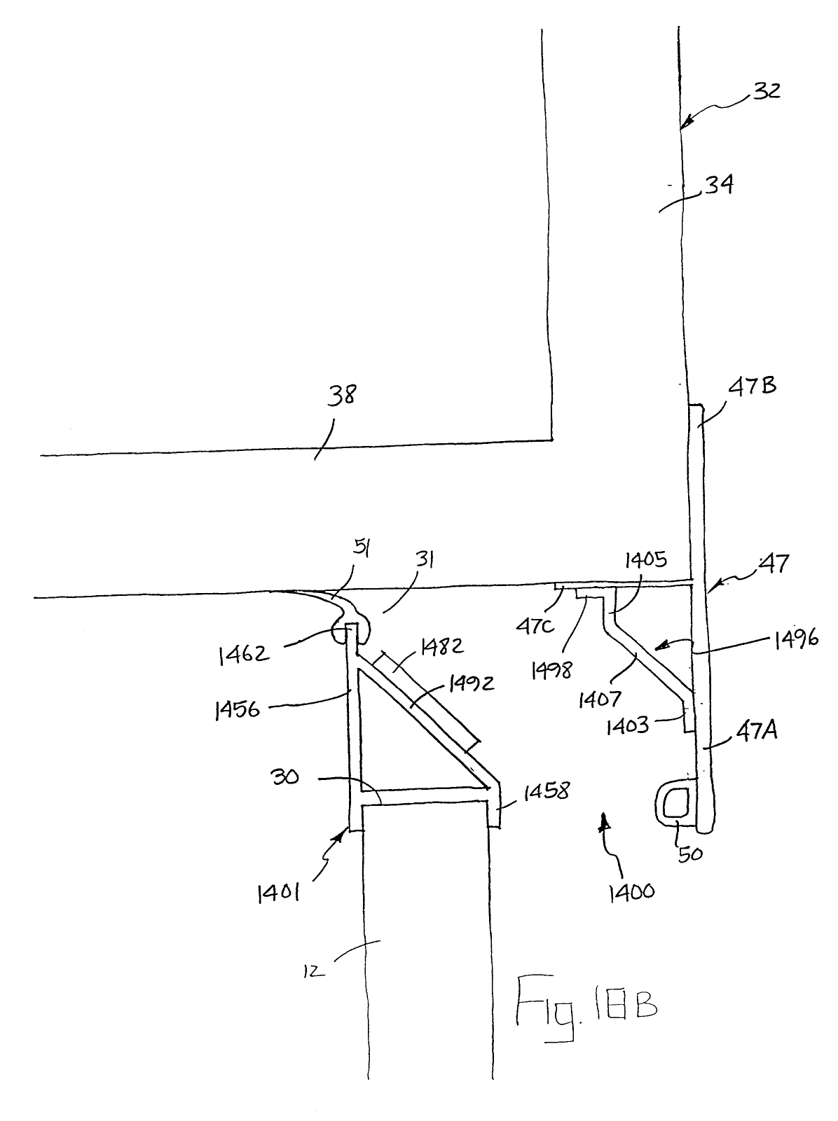

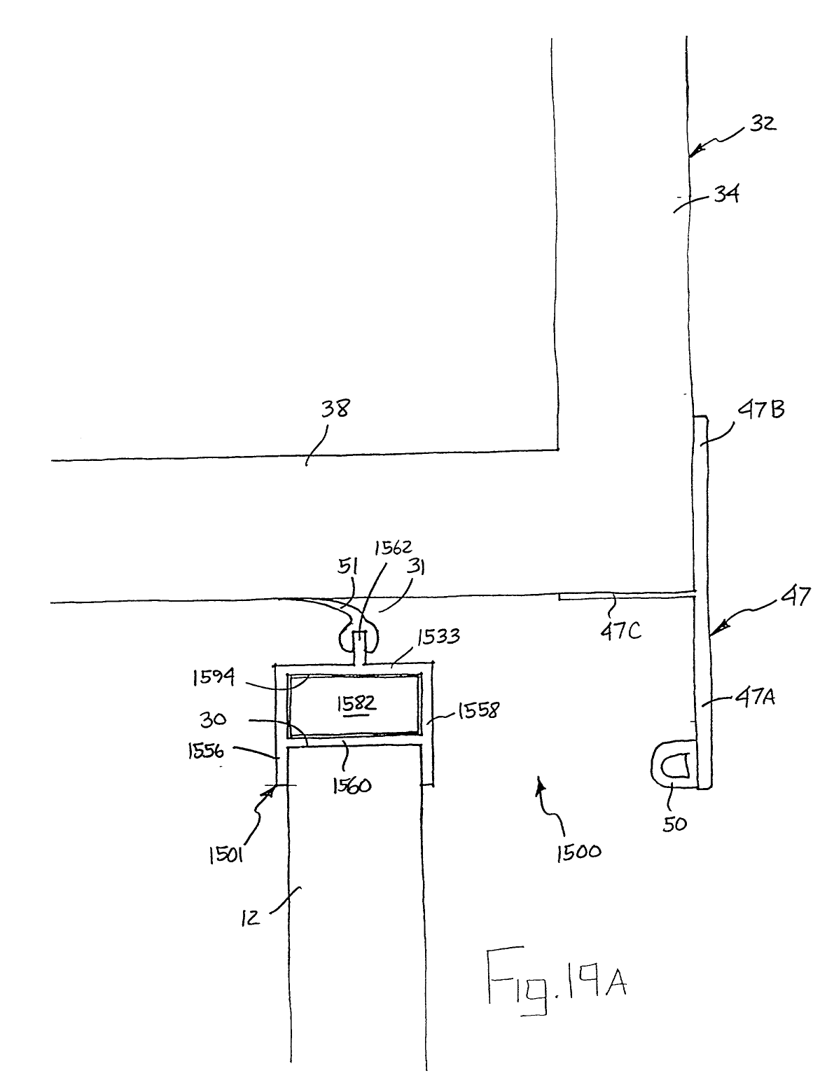

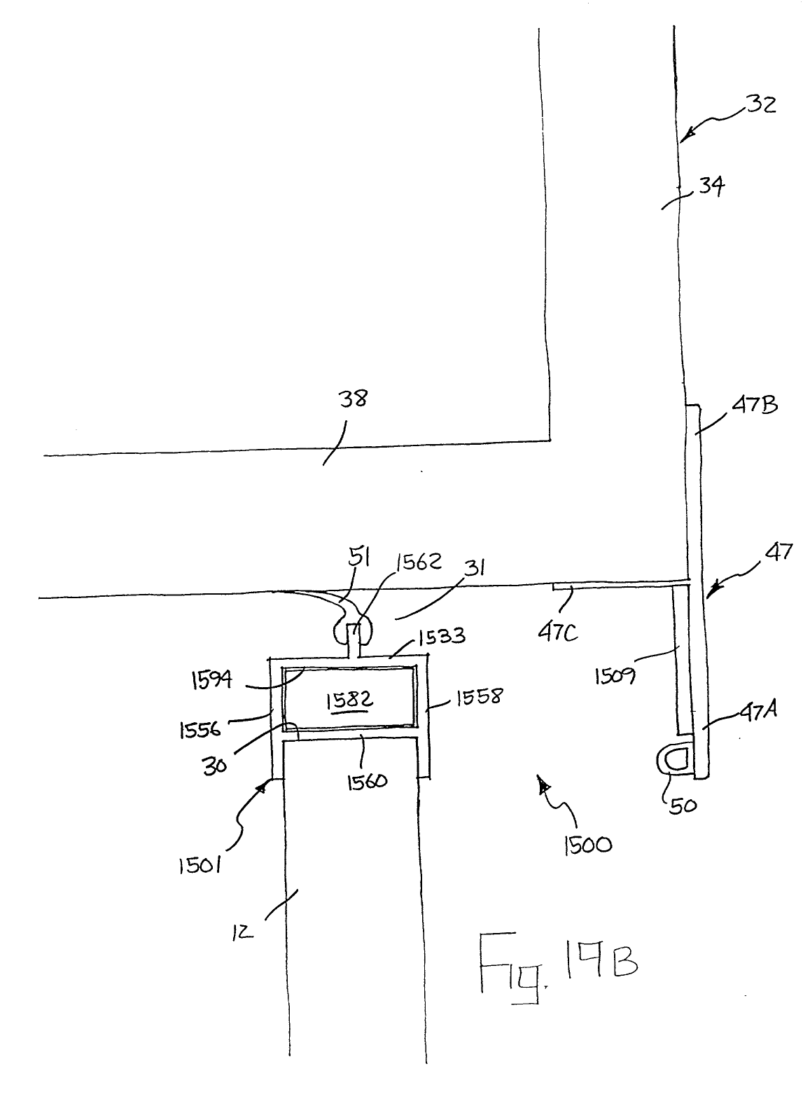

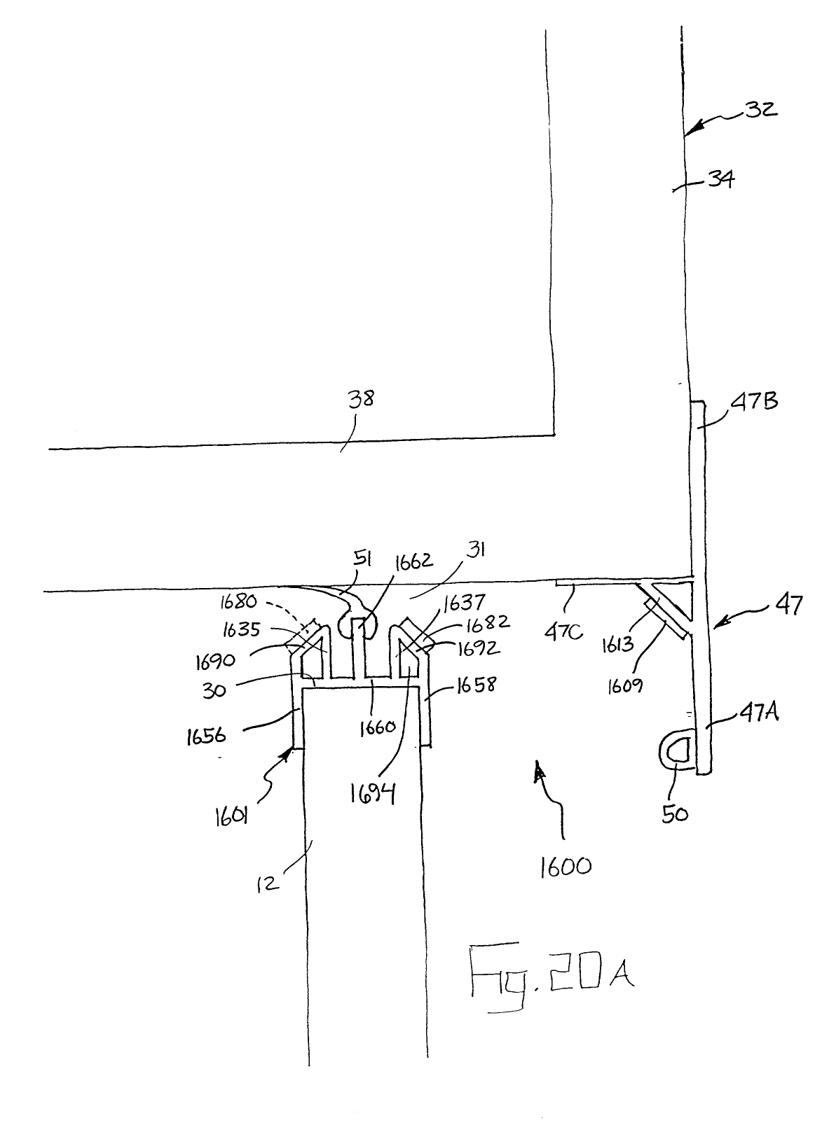

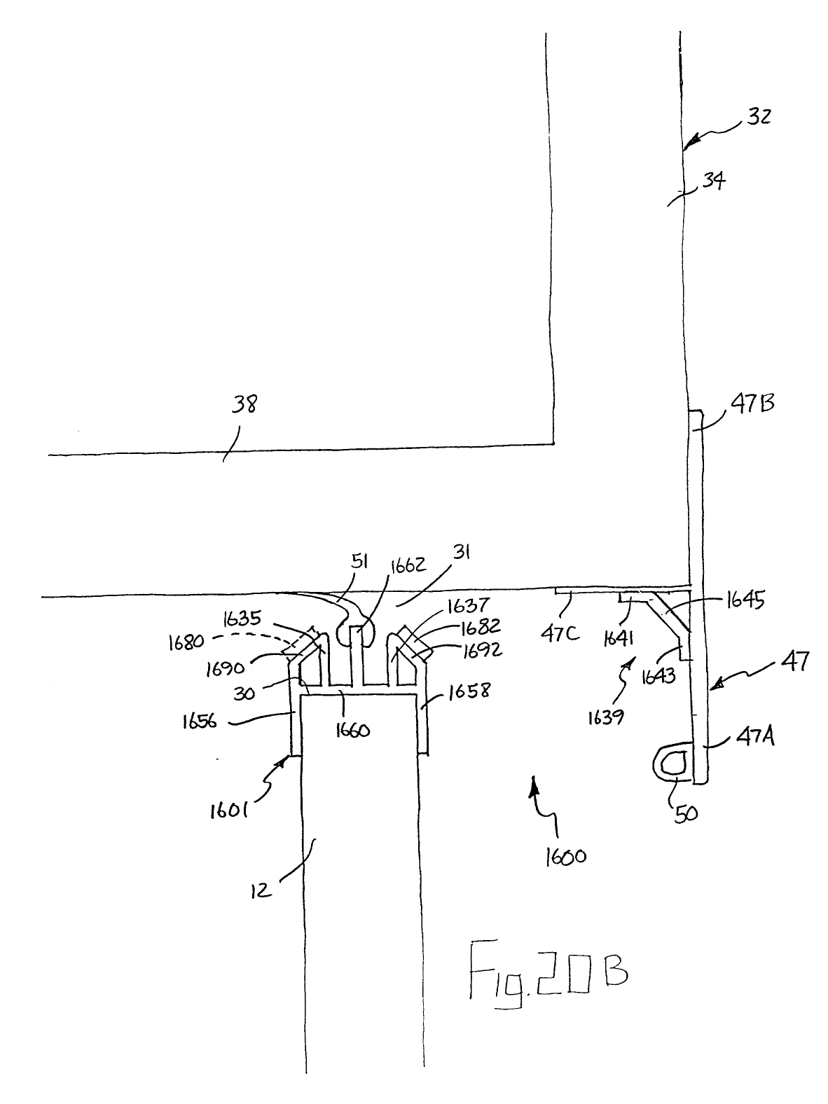

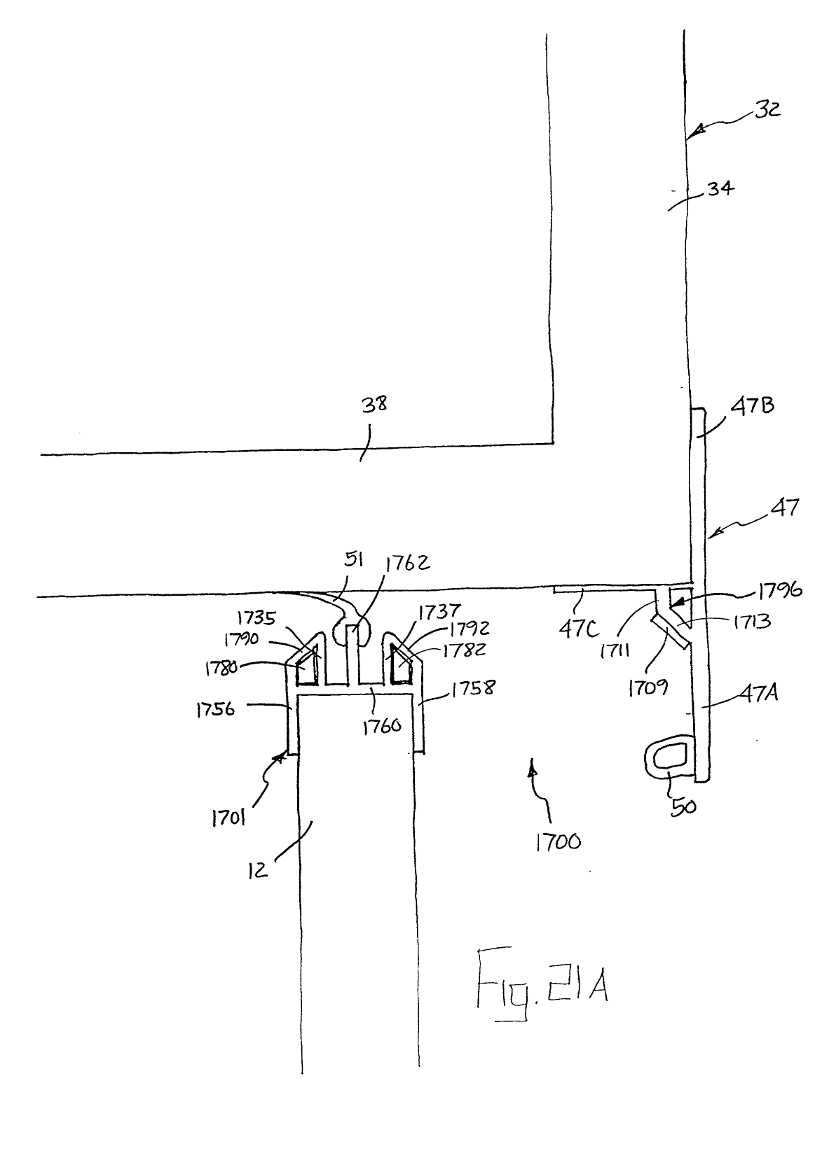

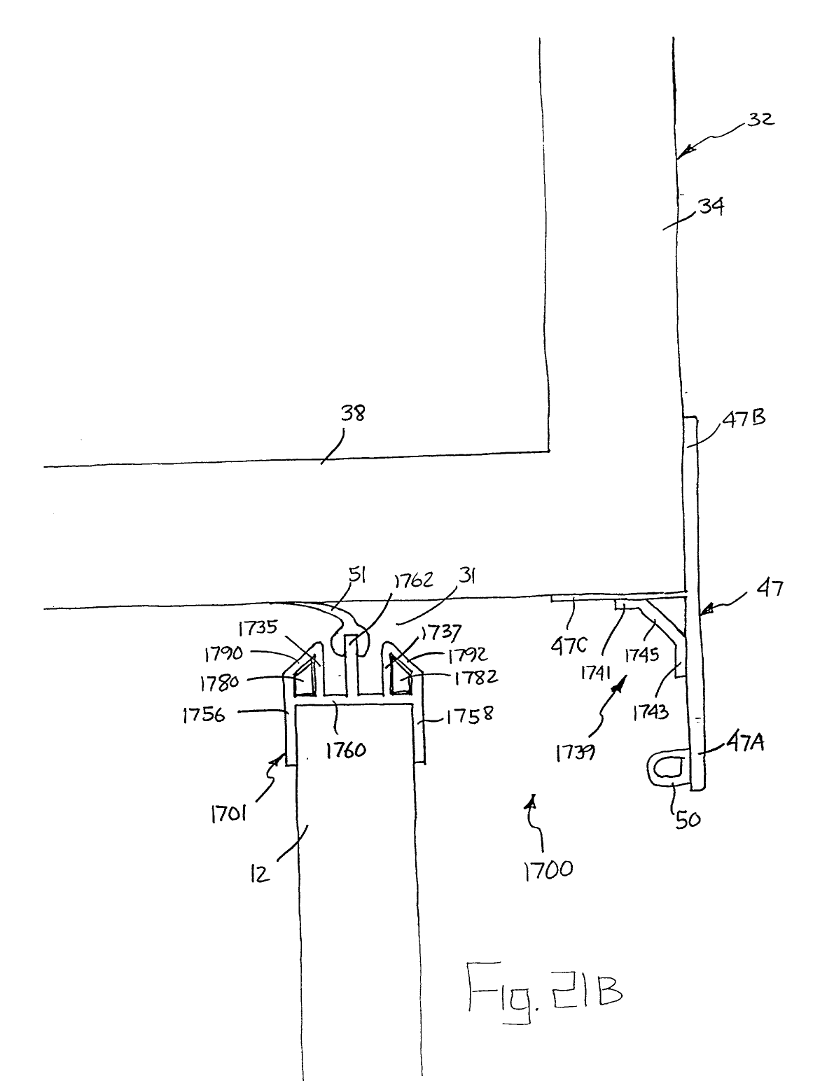

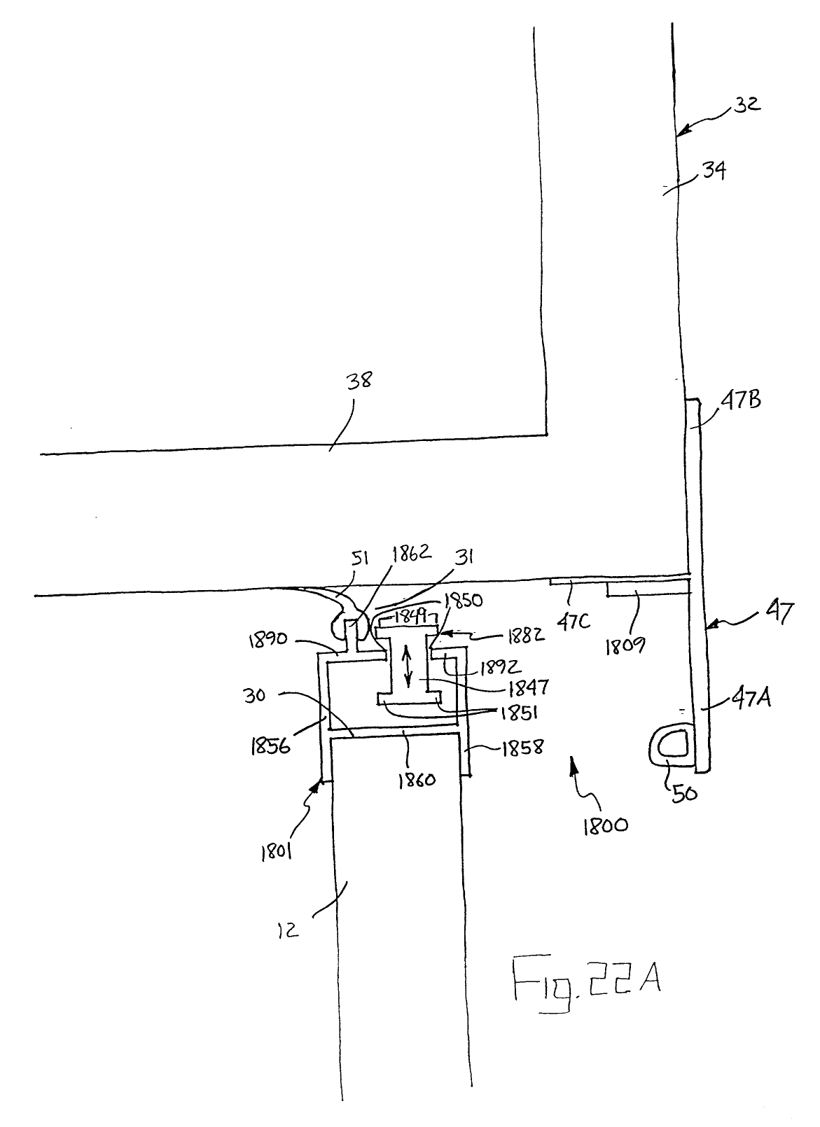

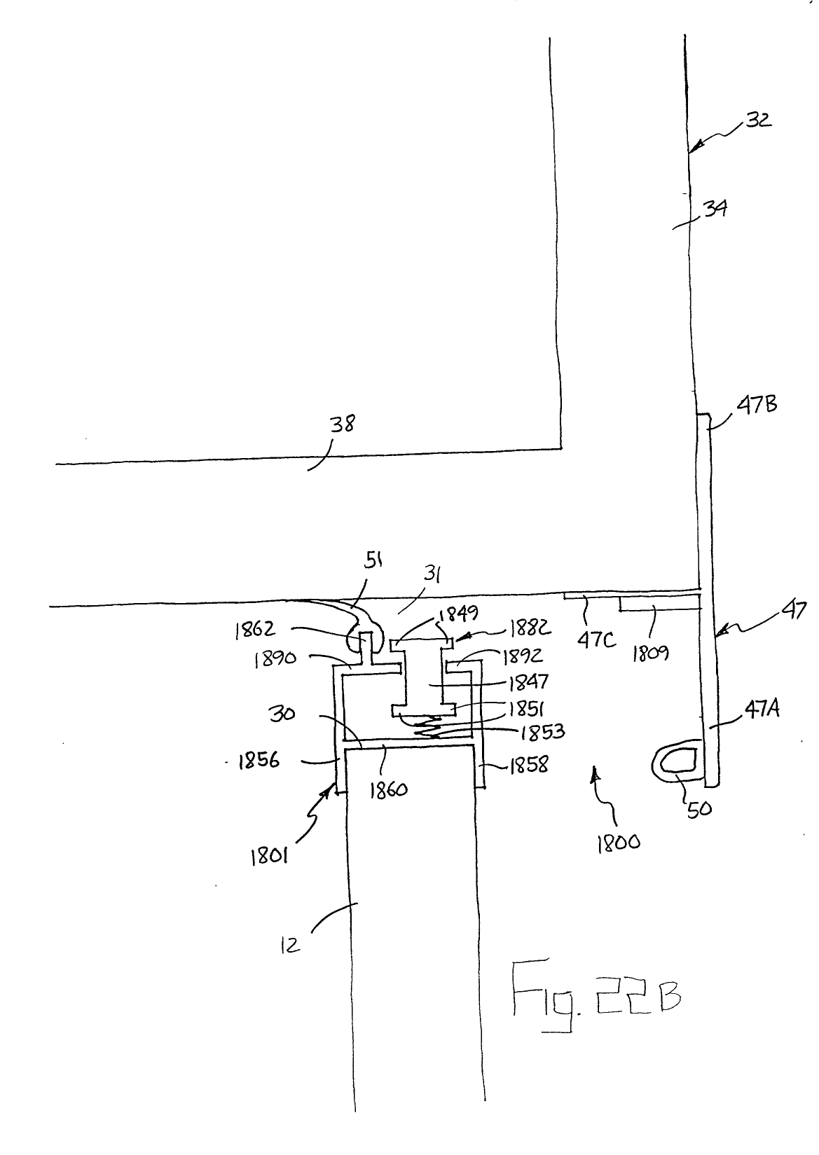

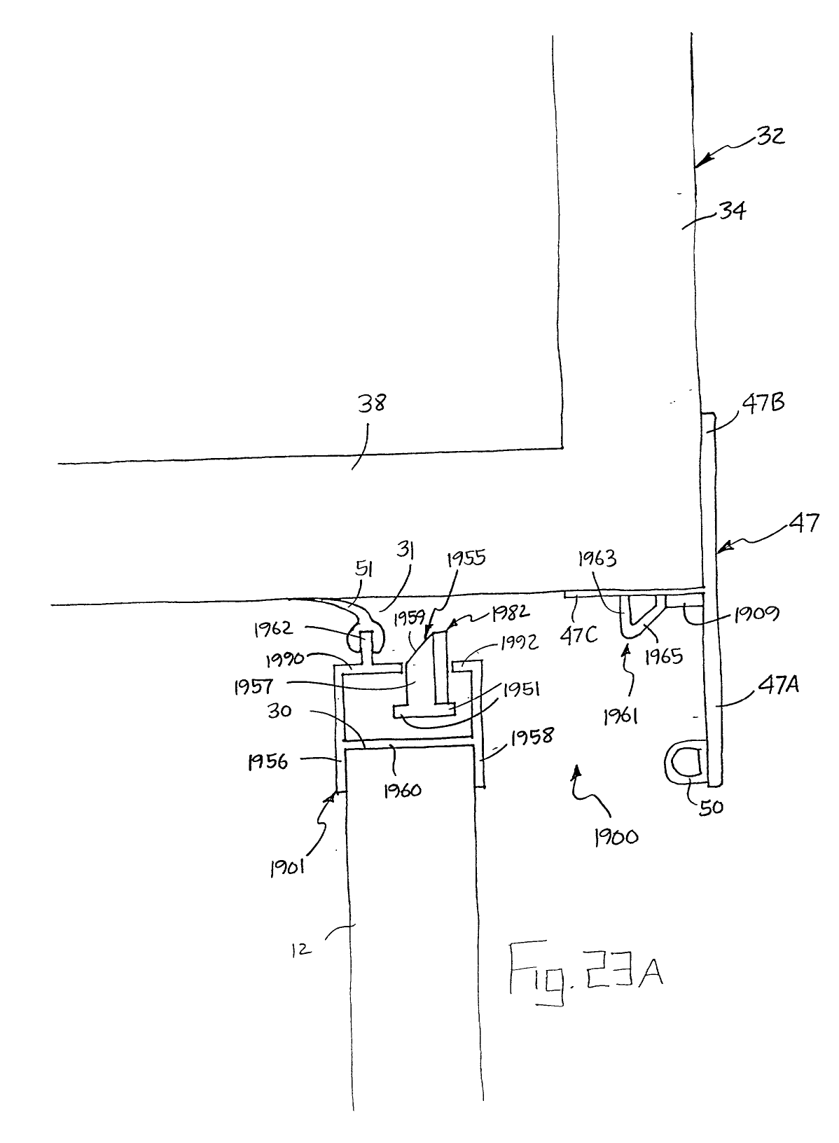

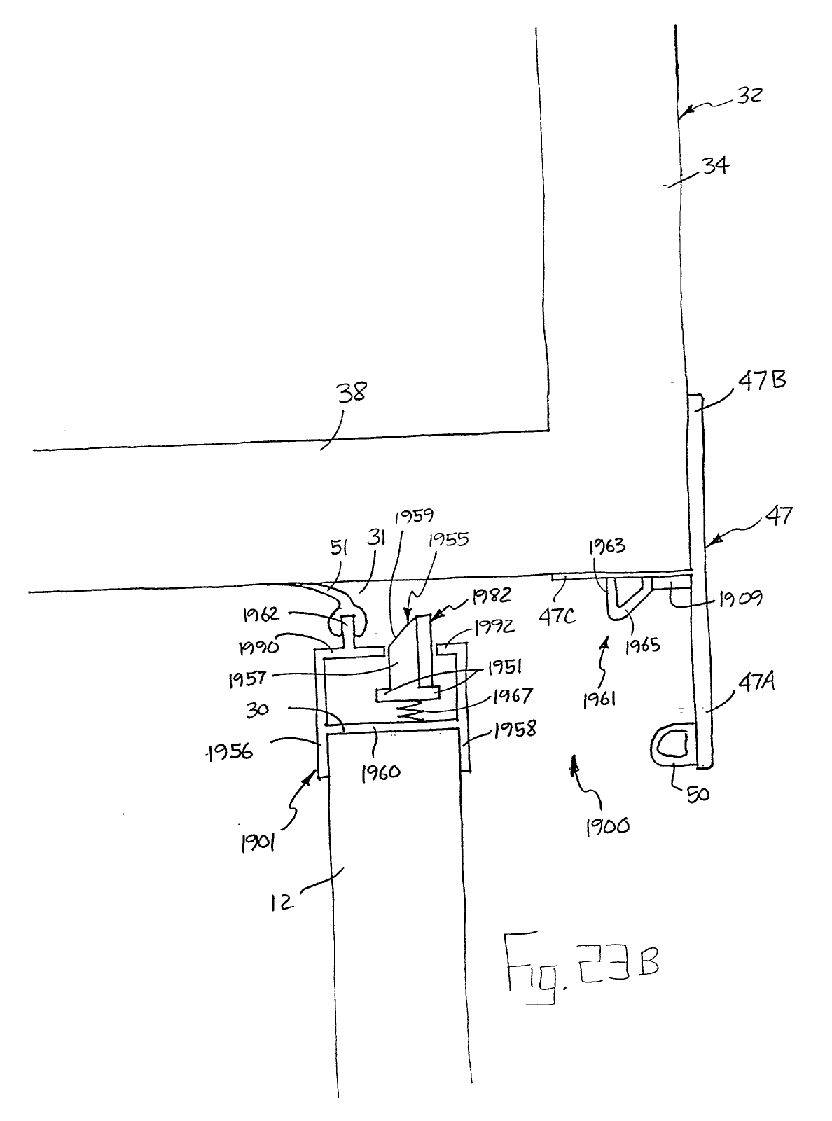

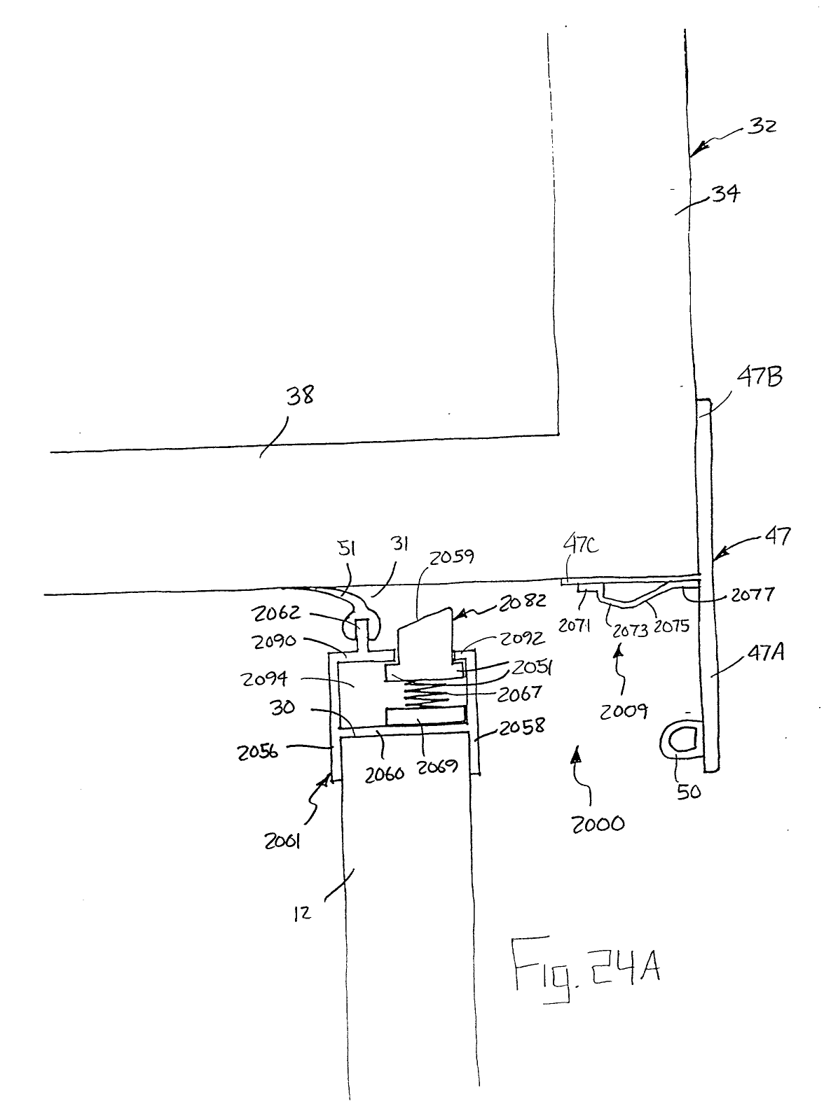

Referring now to FIG. 4, latching mechanism 100 includes an elongated plate 102 of ferrous material and an elongated magnet 104. As shown, plate 102 is mounted to the exterior of vehicle side wall 12 adjacent opening 30. Magnet 104 is mounted to fascia 47 of room 32 in a location aligned with the location of plate 102. It should be understood that both plate 102 and magnet 104 and any corresponding components in the various embodiments of the present invention described below, may be formed of a variety of lengths, may extend substantially from ceiling 40 of room 32 to floor 35 of room 32, and may extend across the upper edge of fascia 47 adjacent ceiling 40 and the upper edge of opening 30. Additionally, both plate 102 and magnet 104, and any corresponding components of the embodiments described below, may be formed in multiple segments or even include multiple vertical or horizontal strips. Moreover, plate 102 (and any corresponding components) may be mounted to fascia 47 and magnet 104 (and any corresponding components) may be mounted to vehicle side wall 12. Finally, plate 102 may be replaced with an additional magnet that is polarized to attract magnet 104, regardless of the placement of magnet 104.

Referring now to FIG. 5, when room 32 moves toward the retracted position, magnet 104 becomes attracted to and engages plate 102, forcing fascia 47 into sealing engagement with the perimeter of vehicle opening 30, and compressing seal 50 against vehicle side wall 12. Since conventional drive mechanisms (not shown) for slide out rooms are typically connected to a lower portion of back wall 34, force is applied to room 32 (particularly outward force) generally in the proximity of the arrow shown in FIG. 5. When room 32 is moved from the retracted position, room 32 may function as a lever arm as the drive mechanism (not shown) urges the bottom portion of room 32 outwardly. Accordingly, a separation force is primarily applied to the bottom portions of plate 102 and magnet 104. As such, plate 102 and magnet 104 are more easily separated during extension of room 32 as indicated by FIG. 5, yet maintain a solid magnetic connection when room 32 is retracted.

FIG. 6 shows a generalized version of an alternate embodiment of a latching mechanism according to the present invention. Latching mechanism 200 includes a plate 202 and a magnet 204 which are substantially identical to those described in conjunction with FIGS. 4 and 5. Latching mechanism 200 further includes an electromagnet 206 mounted adjacent magnet 204 and connected by wires 208 to a power source (not shown). In operation, as room 32 is retracted, magnet 204 engages plate 202 to urge fascia 47 into sealing engagement with the perimeter of vehicle side wall opening 30. To extend room 32, an operator actuates a switch (not shown) to begin extension of the drive mechanism (not shown) which powers room 32 toward the extended position. By actuating the switch (not shown), the operator also provides power through wires 208 to electromagnet 206. Electromagnet 206, once energized, provides a repulsive magnetic force which disengages magnet 204 from plate 202 to release room 32 from the retracted position.

Referring now to FIGS. 7A and 7B, latching mechanism 300 is shown. As shown, a metal plate 302 is mounted in a conventional manner to vehicle side wall 12 adjacent a standard edge channel 301 which supports wiper seal 51 and divides inner space 60 and outer area 61. Latching mechanism 300 further includes a magnet 304 and a channel 310. Magnet 304 includes a body portion 312 and a projection 314. Channel 310 includes a mounting plate 316, a pair of parallel side walls 318, 320, and a pair of opposed end walls 322, 324 which extend from side walls 318, 320, respectively, to form a slot 326.

As best shown in FIG. 7A, fascia 47 includes an outer flange 47A, an inner flange 47B for mounting to room back wall 34, and a perpendicular flange 47C for mounting to one of side walls 36, 38 or ceiling 40 (shown mounted to side wall 38). Mounting plate 316 of channel 310 is fastened to outer flange 47A in a conventional manner such that magnet 304 is aligned with plate 302. The thickness of magnet body portion 312 is less than the inside dimension of channel 310 as measured between end walls 322, 324 and mounting plate 316. Additionally, the width of slot 326 is greater than the thickness of projection 314 of magnet 304. Accordingly, magnet 304 “floats” within channel 310 such that one part of magnet 304 may be spaced farther from outer flange 47A than another part of magnet 304 as described below with reference to FIG. 7C. As room 32 is moved toward the retracted position, magnet 304 becomes attracted to plate 302 and draws fascia 47 against vehicle side wall 12, magnet 304 sealing against plate 302, the where the sealing occurred on the plate 302 being a sealing surface 62.

Referring now to FIG. 7C, the advantage of a “floating” magnet 304 within channel 310 is shown. When room 32 is moved into the retracted position and magnet 304 engages plate 302, it is possible that fascia 47 will not be parallel to the exterior surface of vehicle side wall 12 (as shown exaggerated in FIG. 7C). However, since magnet 304 “floats” within channel 310 such that protrusion 314 may extend a variable distance through slot 326, magnet 304 still engages plate 302 along its entire length. In FIG. 7C, the distance that protrusion 314 extends from slot 326 beyond end walls 322, 324 (distance B) adjacent the upper end of room 32 is less than the distance protrusion 314 extends (distance A) adjacent the lower portion of room 32.

FIG. 7D illustrates one advantage of a segmented magnet 304. As shown, rather than a one-piece magnet 304, a plurality of shorter magnet segments 304 may be fitted within channel 310. Since each of magnets 304 floats within channel 310, latching mechanism 300 (as well as the embodiments described below) can accommodate curves or surface variations of vehicle side wall 12 to which plate 302 is mounted.

Referring now to FIGS. 8A and 8B, an alternate embodiment of a latching mechanism according to the present invention is shown. Latching mechanism 400 employs similar components to latching mechanism 300. Accordingly, like components have retained their reference designation, but have been incremented by 100 as is the case for the various embodiments described below. Latching mechanism 400 includes a plate 402 which is mounted to vehicle side wall 12 adjacent edge channel 301. Latching mechanism 400 further includes a magnet 404, shown as a continuous strip in the FIGS, which is connected to a flexible seal 430. Flexible seal 430 is attached to fascia 47 using any one of a variety of conventional attachment methods. As should be apparent from the drawings, flexible seal 430 accommodates variations in distance between fascia 47 and vehicle side wall 12 when room 32 is in the retracted position such that magnet 404 is in full engagement with plate 402 along its entire length, even if fascia 47 is not parallel to vehicle side wall 12 as described above. Flexible seal 430 provides a sealing function in addition to wiper seal 51 to prevent ingress of the elements through gap 31. Rubber, nylon, or other various suitable materials may be used to construct flexible seal 430 in the accordion shape shown.

FIGS. 9A and 9B show latching mechanism 500 which is identical to latching mechanism 400 with the exception of additional, compressible seal 532. Seal 532 is attached to seal 530 and is formed of a similar flexible material. As with conventional bulb seals, seal 530 is formed in a resilient, cylindrical shape which has an outer diameter that is preferably greater than the distance between the inner surface of outer flange 47A and the surface of magnet 504 which engages plate 502 when room 32 is in the retraced position. Accordingly, when magnet 504 engages plate 502 as room 32 approaches the retracted position, seal 532 is compressed slightly between outer flange 47A and vehicle side wall 12, edge channel 301, and/or plate 502 to provide an additional environmental seal to prevent ingress of the elements through gap 31.

FIG. 10 introduces a new variation which may be incorporated into the embodiments previously described and those hereinafter described. Latching mechanism 600 generally includes a plate 602 attached to vehicle side wall 12 in a vertical orientation parallel to room side wall 38, a booster or power magnet 634 attached to fascia 47 in alignment with plate 602, and a sealing magnet 604 connected to fascia 47 by a flexible seal, for example, as previously disclosed. Powerful magnets with high attractive force are generally more expensive than less powerful magnets. Accordingly, by providing a relatively small, powerful magnet such as magnet 634 adjacent the upper comers of room 32, a cost savings may be realized as opposed to using such a powerful magnet around the entire perimeter of room 32 to provide both the locking and sealing functions described herein. Power magnet 634 would be generally enclosed or connected to a seal in a manner similar to the connection between sealing magnet 604 and fascia 47 as previously described.

FIG. 10 is intended to depict a variety of alternate embodiments of this general concept. First, a power magnet 634 may be used in conjunction with a plate 602, without sealing magnet 604, to attract to plate 602 and lock room 32 in the retracted position as well as provide a seal about the perimeter of room 32 such as by compressing a bulb seal (not shown). Second, power magnet 634 may be used in conjunction with sealing magnet 604 which provides additional attraction and locking force and enhances the seal about the perimeter of room 32. Third, power magnet 634 may be used in conjunction with sealing magnet 604 which is designed to provide a seal about the perimeter of room 32, but does not enhance the locking force of power magnet 634. Finally, power magnet 634 may be used in conjunction with a less powerful magnet 604 which, while not enhancing the sealing function of power magnet 634, enhances the locking function of the magnet. It should also be understood that the location of plate 602 and magnet 634 may be reversed. Additionally, plate 602 may be replaced with a magnet which is oppositely polarized relative to power magnet 634. Finally, FIG. 10 shows plate 602A located parallel to ceiling 40 of room 32. Plate 602A, in this embodiment, would be aligned with a corresponding power magnet 634A mounted to fascia 47 parallel to room ceiling 40. While a power magnet is preferably located adjacent the upper portion of room 32, power magnets located at other positions on room 32 may also provide the desired function. If power magnet 634 is located parallel to room side wall 38 (as shown), disengagement between power magnet 634 and plate 602 is primarily provided by the peeling apart of the two components as room 32 is extended as described above. If, however, a plate 602A and power magnet 634A are used, the components would generally be disengaged as room 32 functions as a lever arm about a fulcrum provided by the engagement of the top edge of fascia 47 and vehicle side wall 12 when room 32 is extended.

FIG. 11A depicts latching mechanism 700 which is identical to latching mechanism 600 of FIG. 10 except that plate 602 is replaced by a piece of steel trim 736 mounted about the perimeter of opening 30 which receives room 32.

FIG. 11B illustrates the general concept of using multiple power magnets 734A-C to increase the pull-in range of a magnetic latching mechanism according to the present invention. In the embodiment shown, three power magnets 734A-C are spaced vertically along the outer surface of side wall 12. Since a drive mechanism (not shown) typically applies force to the bottom portion of room 32 as indicated by the arrow in FIG. 11B, the lower portions of fascia 47, in this embodiment, carrying ferrous plate 702, may be pulled closer to side wall 12 than the upper portions of fascia 47. Accordingly, distance C between power magnet 734C and plate 702 may be too large for the magnetic force of power magnet 734C to draw fascia 47 tight against the outer surface of side wall 12, to compress bulb seal 50. Distance A, however, is sufficiently small that power magnet 734A becomes attracted to plate 702, drawing fascia 47 closer to side wall 12. As distance A decreases to zero, distance B decreases to the point that power magnet 734B becomes attracted to plate 702, drawing fascia closer still to side wall 12. As a result, distance C is sufficiently reduced such that power magnet 734C becomes attracted to plate 702, thereby completing the magnetic lock and compressing bulb seal 50 about the perimeter of room 32. It should be understood that multiple power magnets may be used in this manner to increase the pull-in range of the magnetic latching mechanism in any of the latching mechanism embodiments described herein.

Latching mechanism 800 of FIG. 12 is identical to latching mechanism 700 of FIG. 11 except that power magnet 834 is formed as a continuous strip mounted on fascia 47 about the perimeter of room 32.

Referring now to FIGS. 13A and 13B, an alternate embodiment of the present invention is disclosed. Latching mechanism 900 generally includes a movable magnet 904, a plate 902, a linkage 938 connected to magnet 904, and a lever 940 connected to linkage 938. Movable magnet 904 is movable vertically within guides 903, 905 which define an opening 907 in vehicle side wall 12. In the embodiment shown, latching mechanism 900 also includes a second plate 942 mounted to an inner fascia 944 which extends along side walls 36, 38 and ceiling 40 in a manner similar to fascia 47. Lever 940 includes a coupling 946 connected to linkage 938, a body 948 pivotally attached to vehicle side wall 12 and connected to coupling 946, and a handle 950 extending from body 948. A room-out button 952 and a room-in button 954 may be mounted adjacent body 948 as shown in FIG. 13A and connected by wires (not shown) to control the drive mechanism for moving room 32.

In operation, an operator may move lever 940 to the position shown in FIG. 13A such that lever body 948 engages room-in button 954. As lever 940 is pivoted downwardly, linkage 938 urges movable magnet 904 upwardly into the position shown in FIG. 13A. Movable magnet 904 could also be spring biased to the upward position. When in this position, movable magnet 904 is horizontally aligned with plate 902 on outer fascia 47. Accordingly, as room 32 approaches the retracted position, magnet 904 becomes attracted to plate 902, thereby drawing fascia 47 into tight engagement with vehicle side wall 12.

To move room 32 from the retracted position, an operator may move handle 950 upwardly, thereby sliding movable magnet 904 out of engagement with plate 902. As magnet 904 becomes disengaged from plate 902, lever body 948 actuates room-out switch 952. This second position of latching mechanism 900 is depicted in FIG. 13B. As shown, movable magnet 904 is horizontally aligned with plate 942, such that when room 32 approaches the extended position, magnet 904 becomes attracted to plate 942 to draw fascia 944 into engagement with vehicle side wall 12.

It should be understood that magnet 904 may be moved manually as shown in the figures, and that such movement may coincide with the actuation of room in and out buttons. Alternatively, magnet 904 may be moved electrically with a motor that is actuated in one of two directions, depending upon whether the room-in or the room-out switch is actuated by the operator. Additionally, the position of magnet 904 may be hydraulically controlled through the use of shuttle valves which are connected to the plumbing that drives the telescopic supports (not shown) attached to room 32 between the extended and retracted positions.

FIGS. 14A-14D depict “in gap” embodiments of a magnetic latching mechanism according to the present invention. Latching mechanism 1000 includes a specially formed edge channel 1001 mounted to vehicle side wall 12. Edge channel 1001 includes a pair of side walls 1056, 1058 connected together by an end wall 1060. A central wall 1062 extends perpendicularly from end wall 1060 into gap 31. Wiper seal 51 is supported by wall 1062. A pair of parallel walls 1064, 1066 also extend perpendicularly from end wall 1060 into gap 31. Wall 1064 and the components associated with wall 1064 are shown in dotted lines to indicate that they are optional. Additionally, a plurality of studs (only two shown 1068, 1070) extend from end wall 1060 to capture a pair of magnets 1080, 1082, respectively, as further described below. Stud 1068 includes a head 1072 and a shaft 1074. Similarly, stud 1070 includes a head 1076 and a shaft 1078.

Referring now to FIG. 14B, magnet 1080 includes a slot 1084 associated with each stud 1068. Likewise, magnet 1082 includes a slot 1086 associated with each stud 1070. As shown in the Figure, all of slots 1084, 1086 are parallel and have a width of a dimension greater than the diameter of shafts 1074, 1078, but smaller than the diameter of stud heads 1072, 1076. Accordingly, magnets 1080, 1082 float, and are able to move horizontally in the direction of the arrows shown in FIG. 14B.

Referring again to FIG. 14A, fascia 47, in this embodiment, is made of steel such that as room 32 approaches the retracted position, magnet 1082 becomes attracted to fascia 47 and locks room 32 in the retracted position. Because magnet 1082 floats as described above, fascia 47 need not be perfectly parallel to the outwardly facing surface of magnet 1082. As should be apparent from the figures, magnet 1080 similarly engages an inner fascia (not shown) of room 32 to retain room 32 in an extended position. By mounting magnets 1080, 1082 within gap 31, latching mechanism 1000 may be more visually appealing than a latching mechanism mounted to either the interior or exterior surface of side wall 12. Additionally, no exterior space is used by latching mechanism 1000.

FIG. 14C illustrates a variation of latching mechanism 1000 shown in FIGS. 14A and 14B. Specifically, latching mechanism 1000 of FIG. 14C is identical to the previously described latching mechanism 1000 except that fascia 47 may be made from aluminum or some other non-ferrous material because a steel plate 1088 is attached to fascia 47 to engage magnet 1082.

FIG. 14D illustrates an alternate technique for mounting magnets such that the magnets float to accommodate misalignment between side wall 12 and fascia 47 when room 32 is in the retracted position. Unlike FIG. 14B, multiple magnets 1080A, 1080B, 1082A, 1082B are shown mounted to end wall 1060 (note that wiper seal 51 is not shown in FIG. 14D). Magnets 1080A, 1080B, 1082A, 1082B are pivotally mounted on pivot posts 1068A, 1068B, 1070A, 1070B, respectively. The amount by which each magnet may pivot is limited by the distance between parallel walls 1064, 1066 and the edges of magnets 1080A, 1080B, 1082A, 1082B adjacent parallel walls 1064, 1066. Specifically, magnet 1080A is shown in a full clockwise, pivoted position in dotted lines, and magnet 1080B is shown in a full counterclockwise, pivoted position in dotted lines. By permitting individual magnets to pivot in this manner, each magnet 1080A, 1080B, 1082A, 1082B is more likely to engage the corresponding plate mounted to fascia 47 along the entire length of the magnet, thereby accounting for misalignments and variations in the shape of fascia 47 and the magnets or plates mounted thereto.

FIGS. 15A and 15B show yet another embodiment of a magnetic latching mechanism according to the present invention. Latching mechanism 1100 generally includes a modified edge channel 1101 which carries magnet 1182, and a plate 1196. Edge channel 1101 is similar to edge channel 1001 of FIGS. 14A-14C and includes a pair of side walls 1156, 1158 which are connected together by an end wall 1160. A pair of angled walls 1190, 1192 extend from side walls 1156, 1158, respectively, and meet at central wall 1162, which supports wiper seal 51. Magnet 1182 is mounted to angled wall 1192. An optional second magnet 1180 may be mounted to angled wall 1190. Side walls 1156, 1158 and angled walls 1190, 1192, together with end wall 1160, form an interior space 1194.

Plate 1196 is mounted to fascia 47. Plate 1196 includes a pair of mounting walls 1198, 1103, a spacer wall 1105 extending from mounting wall 1198, and an angled wall 1107 for mating with magnet 1182. Plate 1196, in this embodiment, is made of a ferrous material.

As should be obvious from the figures, as room 32 moves toward the retracted position, magnet 1182 attracts and engages angled wall 1107 of plate 1196, thereby drawing fascia 47 into engagement with side wall 12 and compressing seal 50. If optional magnet 1180 is used, a ferrous plate is provided on the inner fascia (not shown) of room 32. Magnet 1180 thus engages the plate and holds room 32 in an extended position. It should also be understood that because magnet 1182 is mounted at an angle and plate 1196 provides angled wall 1107, room 32 may be centered between the edge channels 1101 disposed adjacent room side walls 36, 38. Additionally, the angled orientation of magnet 1182 permits the use of a thicker, more powerful magnet within gap 31 than did edge channel 1001 of FIGS. 14A-14C.

Referring now to FIG. 15B, plate 1196 of FIG. 15A has been replaced by a modified fascia with an added steel plate 1109. As shown, fascia 47 includes a pair of support walls 1111, 1113 which extend between perpendicular flange 47C and outer flange 47A. Support wall 1113 is formed at an angle relative to outer flange 47A which corresponds to the angle of magnet 1182. This modified embodiment operates in the same manner as the embodiment of FIG. 15A.

Referring now to FIGS. 16A and 16B, latching mechanism 1200 is substantially identical to latching mechanism 1100 of FIGS. 15A and 15B, except that magnet 1182 and optional magnet 1180 have been replaced with trapezoidal, internal magnet 1282. Magnet 1282 is sized to substantially fill internal space 1294 formed by edge channel 1201. Plate 1296 is substantially the same as plate 1196. As room 32 approaches the retracted position, magnet 1282 draws ferrous plate 1296 into engagement with edge channel 1201. Specifically, angled wall 1207 is drawn into engagement with angled wall 1292, thereby compressing seal 50 between fascia 47 and vehicle side wall 12.

As should be apparent from the foregoing, magnet 1282 may be a relatively large, powerful magnet to lock room 32 in the retracted position. Additionally, an inner fascia may be fitted with a plate similar to plate 1296 such that room 32 may be locked in the extended position. The power of magnet 1282 to lock room 32 in either the extended or retracted position reduces the possibility of a faulty seal, even where misalignment or non-uniform surfaces are issues. Also, since magnet 1282 is enclosed within edge channel 1201, the possibility of rust or other damage to magnet 1282 is substantially reduced. It should also be understood that edge channel 1201 may be formed into a variety of shapes, including a rectangular or square cross-section as opposed to the trapezoidal cross-section shown in FIG. 16A. Of course, magnet 1282 would also be modified so as to fit within interior space 1294. The trapezoidal cross-section of edge channel 1201 shown in FIG. 16A cooperates with angled wall 1207 of plate 1296 to center room 32 within opening 30 formed by vehicle side wall 12.

Referring now to FIG. 16B, latching mechanism 1200 may alternatively include a plate 1209 mounted to a non-ferrous, modified fascia 47. The configuration of fascia 47 and plate 1209 is identical to that shown and described in conjunction with FIG. 15B.

Referring now to FIGS. 17A and 17B, latching mechanism 1300 is shown according to another embodiment of the present invention. In FIG. 17A, edge channel 1301 is identical to edge channel 1201 of FIG. 16A except that edge channel 1301 may be formed of a ferrous material. Modified fascia 47 includes a perpendicular wall 1317 which extends from perpendicular flange 47C and has an angled end portion 1319. Fascia 47 further includes a perpendicular wall 1321 which extends from outer flange 47A and has an angled end portion 1323. Together, walls 1317, 1321, and end portions 1319, 1323 retain a magnet 1315 such that magnet 1315 can float. Magnet 1315 includes a body portion 1325 which is sized to extend between end portions 1319, 1323, and a rear portion 1327 sized to prevent magnet 1315 from passing through the slot formed by end portions 1319, 1323. As room 32 is moved toward the retracted position, magnet 1315 extends from fascia 47 and engages and locks to angled wall 1392 of edge channel 1301, thereby compressing seal 50 between fascia 47 and vehicle side wall 12. Of course, a similar fascia and magnet arrangement may be incorporated on the inner fascia (not shown) of room 32 such that room 32 may be locked in the extended position as well.

Referring now to FIG. 17B, edge channel 1301 is made of non-ferrous material. Accordingly, a steel plate 1329 is shown attached to angled wall 1392 so that magnet 1315 will become attracted to plate 1329 when room 32 is moved to the retracted position. A similar optional plate 1331 is shown (in dotted lines) for use in locking room 32 in the extended position.

FIGS. 18A and 18B show yet another embodiment of a latching mechanism according to the present invention. Latching mechanism 1400 includes a modified edge channel 1401 and a modified fascia 47. As shown, edge channel 1401 includes a pair of side walls 1456, 1458 which are connected together by an end wall 1460. Side wall 1456 extends into gap 31 perpendicularly from end wall 1460 and terminates in wall 1462 which carries wiper seal 51. Angled wall 1492 extends between side wall 1458 and side wall 1456 and carries magnet 1482.

Fascia 47 includes support wall 1411 and angled wall 1413 which carries steel plate 1409. As room 32 approaches the retracted position, magnet 1482 becomes attracted to and engages steel plate 1409 to lock room 32 in the retracted position. The angle of angled wall 1492 and plate 1409 also functions to center room 32 within opening 30. It should be understood that the relative positions of magnet 1482 and plate 1409 may be reversed.

Referring now to FIG. 18B, latching mechanism 1400 is shown employing a steel plate 1496 (similar to plate 1196 of FIG. 15A) instead of a modified fascia 47 with added plate 1409. Plate 1496 includes a mounting wall 1498 which is attached to perpendicular flange 47C of fascia 47, a spacer wall 1405 which extends perpendicularly from mounting wall 1498, a second mounting wall 1403 which is connected to outer flange 47A of fascia 47, and an angled wall 1407 extending between spacer wall 1405 and mounting wall 1403.

The alternate embodiment latching mechanism 1500 shown in FIG. 19A is substantially similar to latching mechanism 1200 of FIG. 16A. As indicated above, the trapezoidal cross-sectional shape of edge channel 1201 of FIG. 16A may be replaced with a rectangular shape, as shown in FIG. 19A. Edge channel 1501 includes parallel side walls 1556, 1558 which are connected together at one point by end wall 1560 and at their outer ends by second end wall 1533. Central wall 1562 extends from second end wall 1533 and supports wiper channel 51. Magnet 1582 substantially fills the inner space 1594 defined by the walls of edge channel 1501. In the embodiment shown, fascia 47 must be made of a ferrous material such that as room 32 is moved toward the retracted position, magnet 1582 becomes attracted to outer flange 47A of fascia 47 to retain room 32 in the retracted position.

Referring now to FIG. 19B, a standard fascia 47 may be used so long as a steel plate 1509 is mounted to outer flange 47A. The remaining components of latching mechanism 1500 as shown in FIG. 19B are identical to those shown in FIG. 19A.

FIGS. 20A and 20B show yet another embodiment of a latching mechanism according to the present invention. Latching mechanism 1600 includes a modified edge channel 1601 wherein central wall 1662 is recessed between angled walls 1690, 1692, thereby permitting a reduced width of gap 31. Edge channel 1601 includes a pair of parallel side walls 1656, 1658 which are joined together by end wall 1660. Angled wall 1690 extends from side wall 1656 and angled wall 1692 extends from side wall 1658. A support wall 1635 extends between angled wall 1690 and end wall 1660, and a support wall 1637 extends between angled wall 1692 and end wall 1660. Internal space 1694 being formed within the walls. Central wall 1662 extends perpendicularly from a center portion of end wall 1660 into gap 1631. Wiper seal 51 is carried by central wall 1662. A magnet 1682 is mounted to angled wall 1692, and an optional magnet 1680 (for use in retaining room 32 in the extended position) may be mounted to angled wall 1690.

Fascia 47 is modified in that an angled support wall 1613 extends between perpendicular flange 47C and outer flange 47A. A ferrous plate 1609 is mounted to support wall 1613. As room 32 is moved toward the retracted position, magnet 1682 is attracted to plate 1609, thereby securing room 32 in the retracted position and centering room 32 within opening 30.

Referring now to FIG. 20B, support wall 1613 and plate 1609 have been replaced with ferrous plate 1639 which includes a first mounting wall 1641, a second mounting wall 1643, and an angled wall 1645 extending between mounting walls 1641, 1643. Angled wall 1645 engages magnet 1682 when room 32 is in the retracted position.

FIGS. 21A and 21B show another embodiment similar to that shown in FIGS. 20A and 20B. Latching mechanism 1700, instead, includes a magnet 1782 which is enclosed within the space formed by walls 1758, 1760, 1737, and 1792. Similarly, a magnet 1780 is enclosed within the space formed by walls 1756, 1760, 1735, and 1790. As room 32 moves toward the retracted position, magnet 1782 is attracted to plate 1709, drawing room 32 into a fully retracted position. The angles of wall 1792 and plate 1709 cause room 32 to be centered within opening 30 as described above. When room 32 is moved toward the extended position, magnet 1780 is similarly attracted to a plate (not shown) mounted to an inner fascia (not shown) of room 32. Latching mechanism 1700 of FIG. 21B is identical to that shown in FIG. 21A except that the modified fascia 47 and plate 1709 configuration is replaced by a standard fascia 47 with a plate 1739 which is identical to plate 1639 shown in FIG. 20B.

FIGS. 22A and 22B show yet another embodiment of the latching mechanism according to the present invention. Latching mechanism 1800 includes edge channel 1801 which captures magnet 1882. Edge channel 1801 includes a pair of side walls 1856, 1858 which are connected together by end wall 1860. Side wall 1856 includes a perpendicularly extending end wall 1890 which opposes end wall 1892, also extending perpendicularly from side wall 1858. End wall 1890 supports central wall 1862 which extends perpendicularly from end wall 1890 into gap 31 and supports wiper seal 51 as described above. End walls 1890 and 1892 form opening 1850 through which magnet 1882 moves toward and away from room 32 as indicated by the arrow shown in FIG. 22A.

Magnet 1882 includes a body 1847, a pair of inner extensions 1851 and a pair of outer extensions 1849. As should be apparent from the drawing, inner extensions 1851 and outer extensions 1849 retain magnet 1882 within edge channel 1801 and limit its travel along the arrow shown in FIG. 22A. As room 32 approaches the retracted position, magnet 1882 becomes attracted to plate 1809 mounted to perpendicular flange 47C of fascia 47, to retain room 32 in the retracted position and seal the interior of the room from the elements.

Latching mechanism 1800 of FIG. 22B is identical to that shown in FIG. 22A except that a spring 1853 is shown attached between magnet 1882 and end wall 1860 of edge channel 1801. Spring 1853 biases magnet 1882 toward end wall 1860 such that when room 32 is moved away from the retracted position, magnet 1882 retracts within edge channel 1801 to prevent damage to the surface of room side wall 38.

Latching mechanism 1900 of FIGS. 23A and 23B is similar to latching mechanism 1800 of FIGS. 22A and 22B except that a camming mechanism is added to draw room 32 into the retracted position. Specifically, edge channel 1901 is identical to edge channel 1801. Magnet 1982 is attached to a camming apparatus 1955 which includes a body 1957 having a camming surface 1959 and inner extensions 1951. Fascia 47 includes a camming mate 1961 attached to perpendicular flange 47C. Camming mate 1961 includes an inner wall 1963 and a camming wall 1965 integral with inner wall 1963. A ferrous plate 1909 is attached to perpendicular flange 47C adjacent camming wall 1965 of camming mate 1961. As room 32 moves toward the retracted position, magnet 1982 becomes attracted to plate 1909 and camming surface 1959 moves along camming wall 1965 to draw room 32 further into the retracted position. Once magnet 1982 engages plate 1909, room 32 is locked in the retracted position mechanically by the engagement between camming surface 1959, camming wall 1965, and magnetically by the engagement between magnet 1982 and plate 1909.

Latching mechanism 1900 of FIG. 23B is identical to that shown in FIG. 23A except that a spring 1967 is shown attached between camming apparatus 1955 and end wall 1960. Spring 1967 biases camming apparatus 1955 (and magnet 1982) toward end wall 1960 as room 32 is moved away from the retracted position, thereby preventing damage to the surface of room side wall 38.

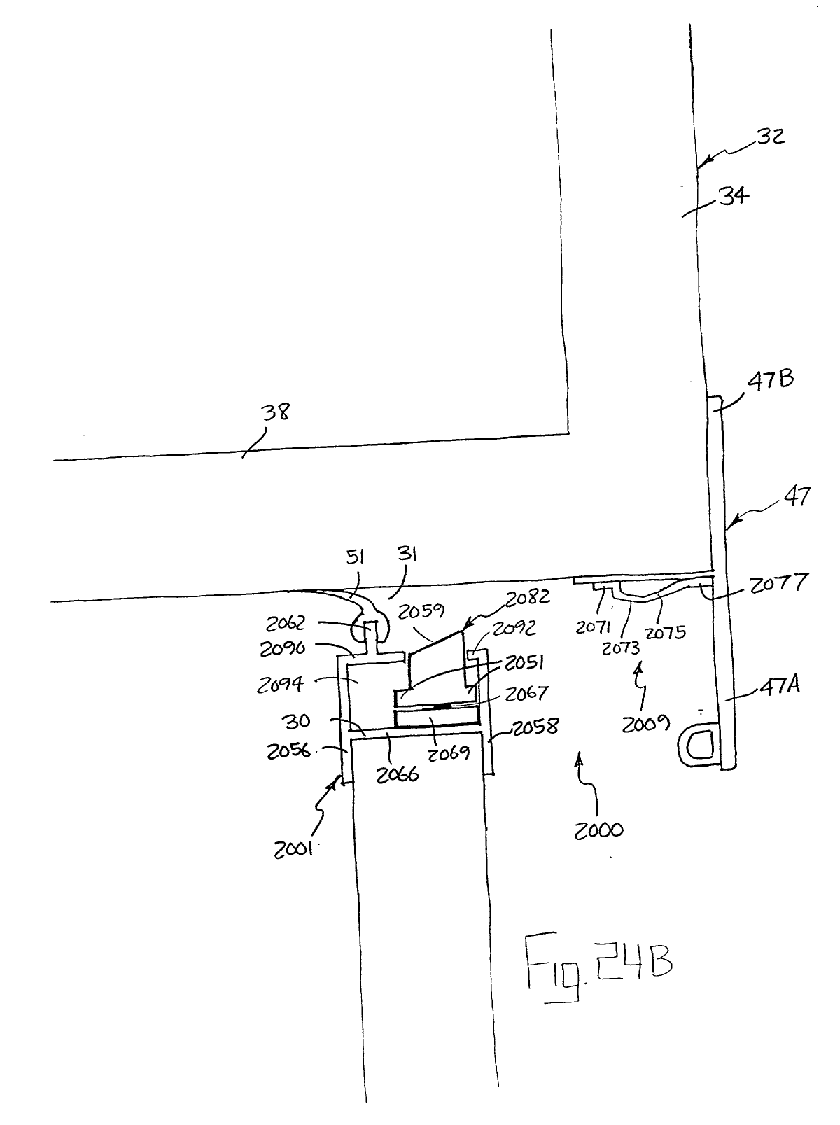

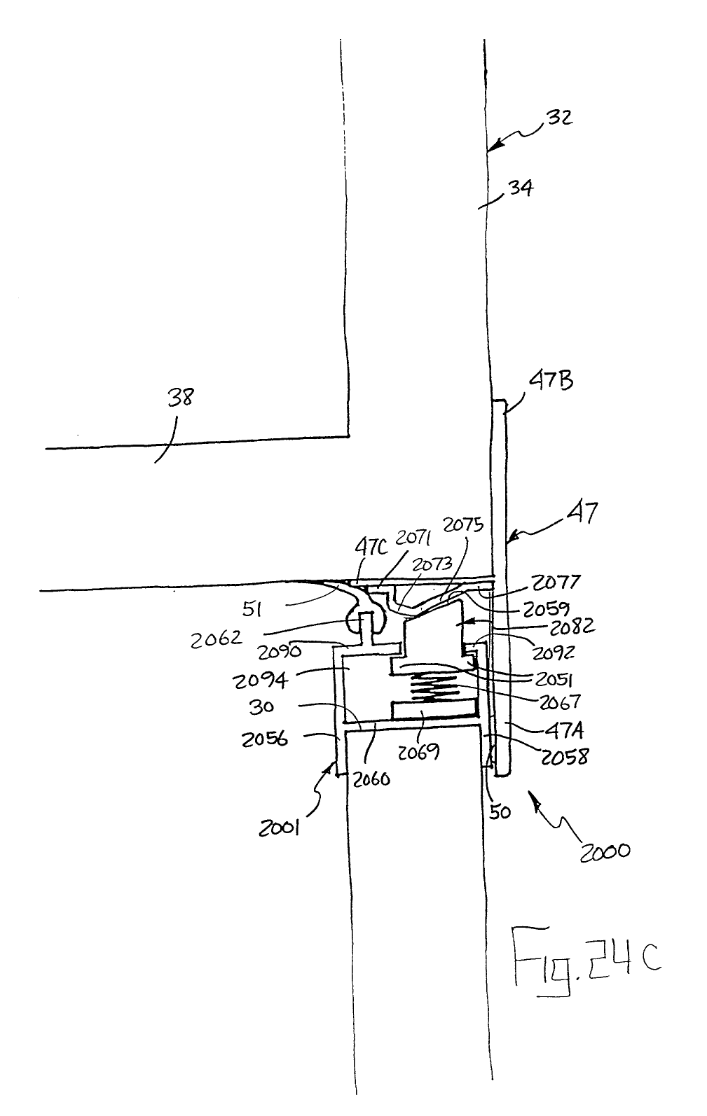

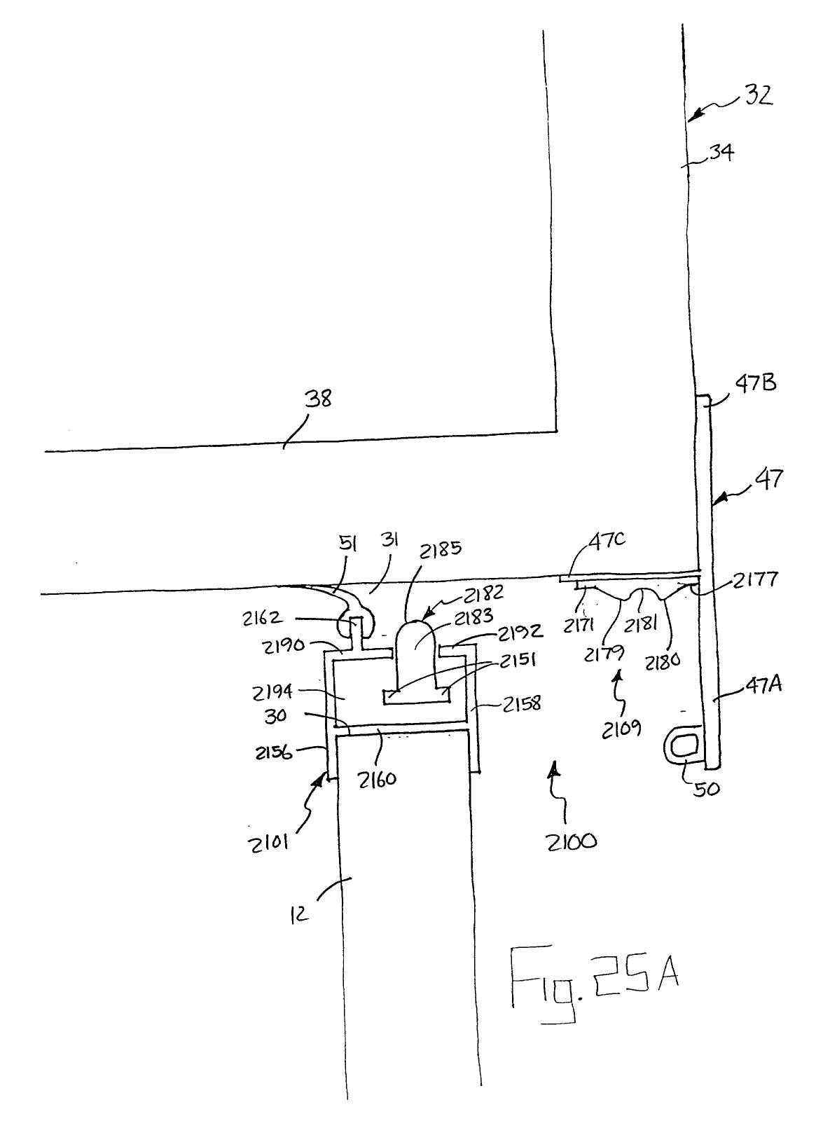

FIGS. 24A-24C depict latching mechanism 2000. Latching mechanism 2000 includes an edge channel 2001 which is identical to edge channel 1901 of FIGS. 23A and 23B. Enclosed within area 2094 is a portion of magnet 2082, spring 2067 and electromagnet 2069. Magnet 2082 includes a camming surface 2059 and extensions 2051 which prevent magnet 2082 from extending beyond end walls 2090, 2092. A spring 2067 is connected between magnet 2082 and electromagnet 2069. Electromagnet 2069 is attached to end wall 2060. Latching mechanism 2000 further includes a camming plate 2009 which is attached to perpendicular flange 47C of fascia 47. Camming plate 2009 includes a mounting wall 2071, a first camming wall 2073 extending from mounting wall 2071, a second camming wall 2075 extending from first camming wall 2073, and a second mounting wall 2077 extending from second camming wall 2075. Mounting walls 2071, 2072 are attached to perpendicular flange 47C of fascia 47 in a conventional manner.

Electromagnet 2069 is connected by wires (not shown) which power electromagnet 2069 in any of a variety of ways as power is applied to room 32 to move room 32 toward the retracted position. FIG. 24A depicts latching mechanism 2000 with electromagnet 2069 deactivated while room 32 is in the extended position. FIG. 24B depicts latching mechanism 2000 as room 32 is moved toward the retracted position with electromagnet 2069 activated. Electromagnet 2069 draws magnet 2082 toward electromagnet 2069 when activated against the biasing force of spring 2067. This prevents contact between magnet 2082 and the outer surface of side wall 38 of room 32. FIG. 24C depicts room 32 in the retracted position. As room 32 approaches the retracted position, electromagnet 2069 is deactivated and magnet 2082 is magnetically drawn toward plate 2009. Additionally, spring 2067 urges magnet 2082 toward plate 2009. As should be apparent from the drawings, electromagnet 2069 may be released before room 32 is moved fully into the retracted position. Magnet 2082 cammingly engages first camming surface 2073 of plate 2009 and rides over camming surface 2073 onto second camming surface 2075 to draw room 32 into a fully retracted position as shown in FIG. 24C.

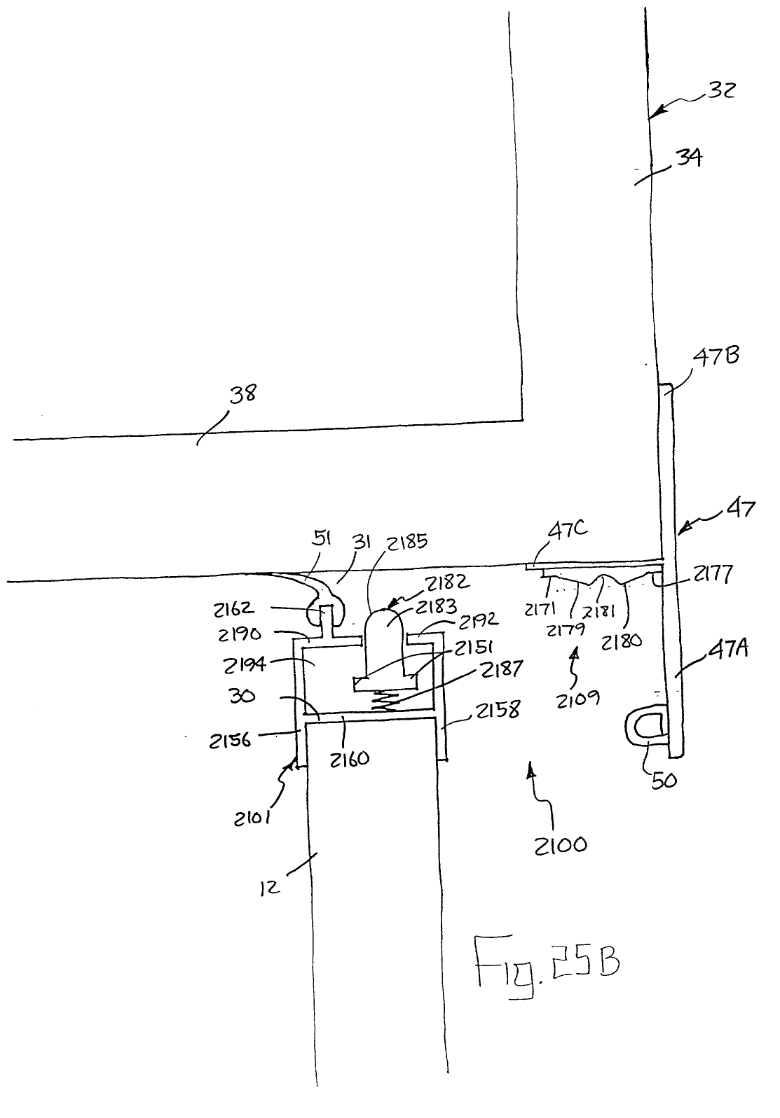

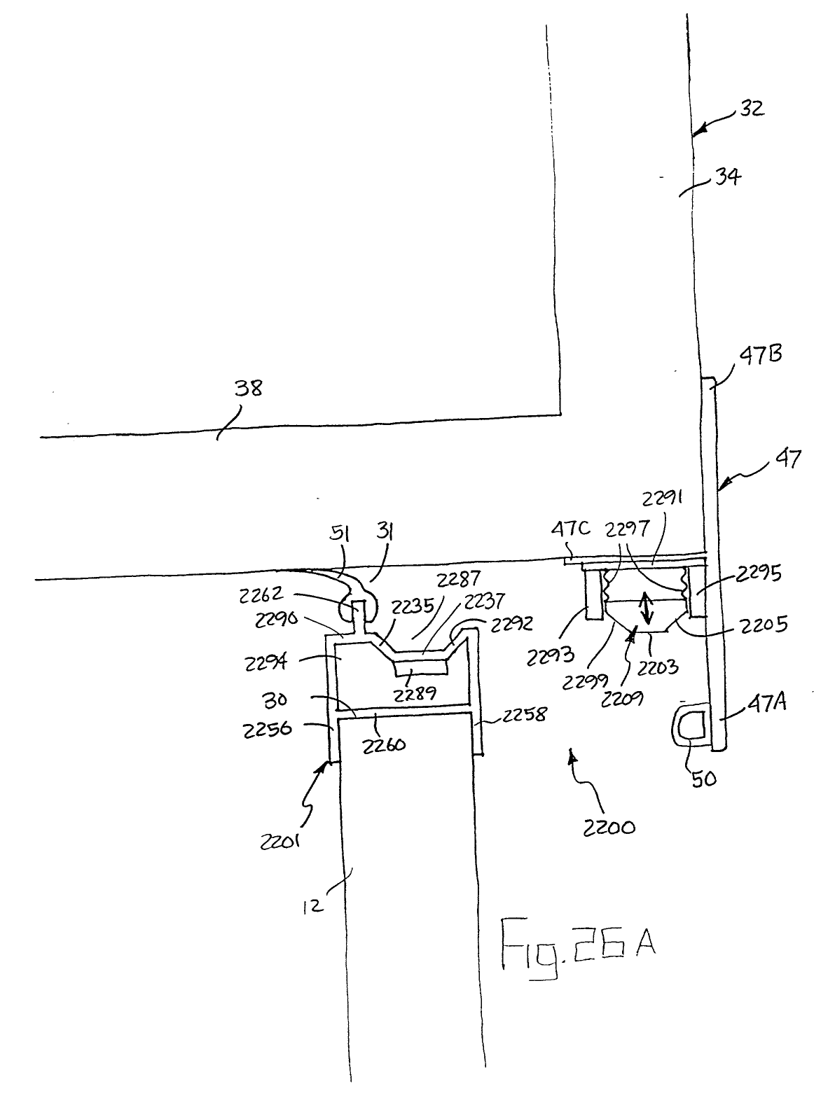

FIGS. 25A and 25B depict yet another embodiment of a latching mechanism according to the present invention. Latching mechanism 2100 includes an edge channel 2101 which is identical to edge channel 2001 of FIGS. 24A and 24B. Latching mechanism 2100 further includes a magnet 2182 having a body 2183 with a curved outer surface 2185. Magnet 2182 further includes extensions 2151 to retain magnet 2182 within edge channel 2101. Latching mechanism 2100 also includes a plate 2109 having a mounting wall 2171, a first curved wall 2179, a second curved wall 2180, and a second mounting wall 2177. Mounting walls 2171 and 2177 are attached to perpendicular flange 47C of fascia 47. Curved walls 2179 and 2180 form a recess 2181 which is sized to receive the curved outer surface 2185 of magnet 2182. As room 32 approaches the retracted position, magnet 2182 is attracted to plate 2109 and cams over first curved wall 2179 into recess 2181, thereby locking room 32 in the retracted position.

FIG. 25B depicts latching mechanism 2100 which is identical to that shown in FIG. 25A except that a spring 2187 is connected between magnet 2182 and end wall 2160 of edge channel 2101. Spring 2187 biases magnet 2182 toward end wall 2160 such that when room 32 is moved away from the retracted position, magnet 2182 does not engage and damage the outer surface of side wall 38 of room 32.

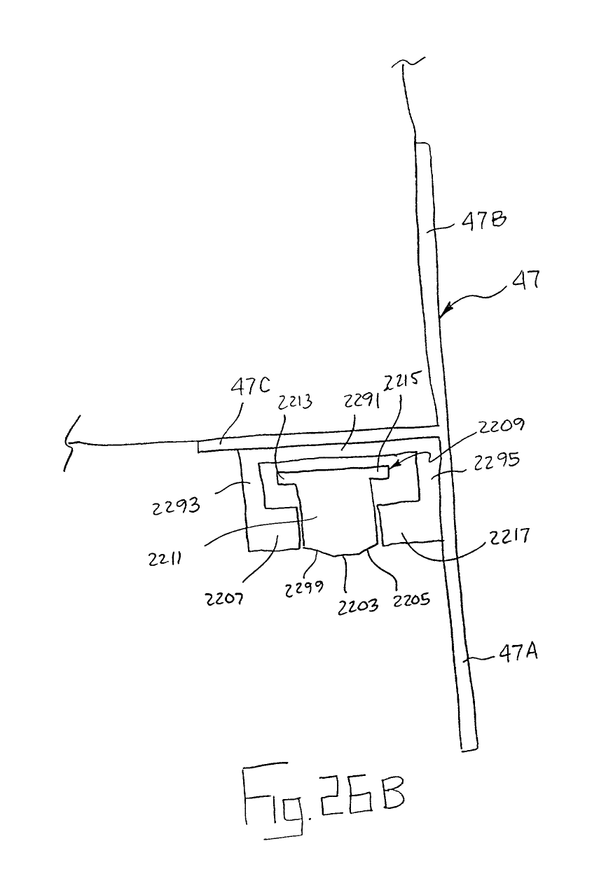

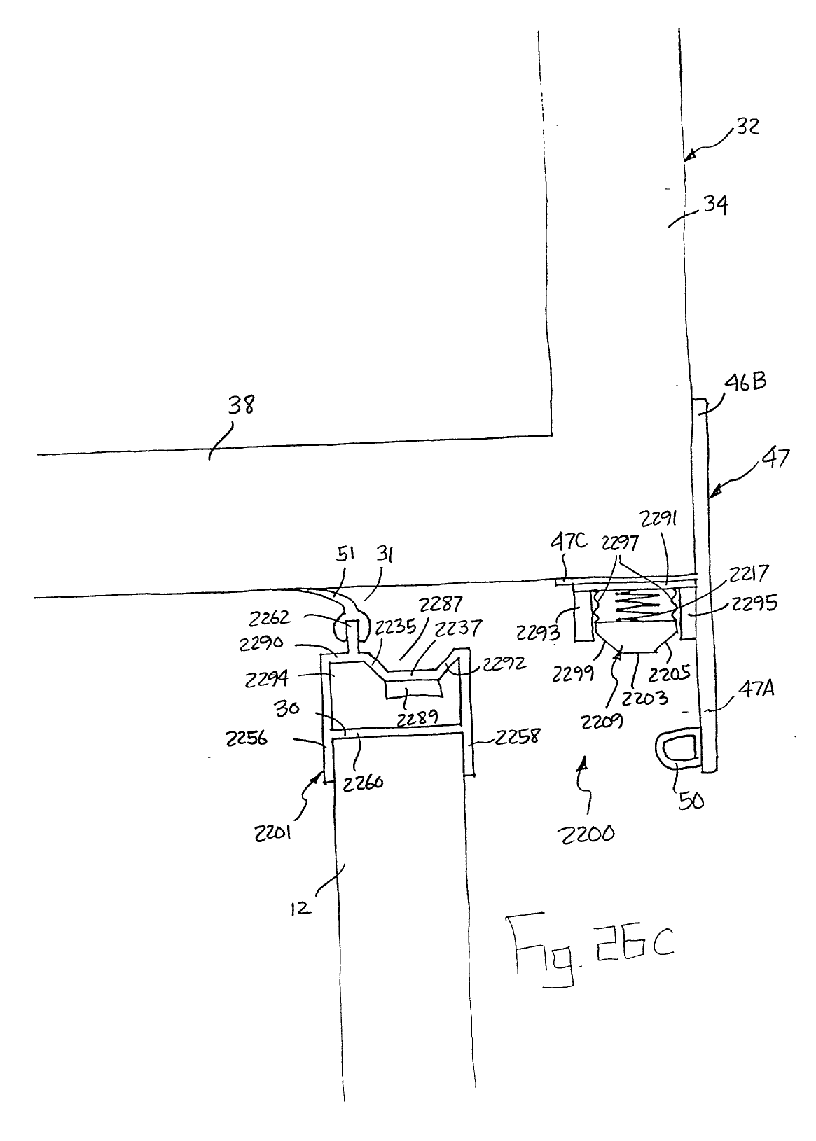

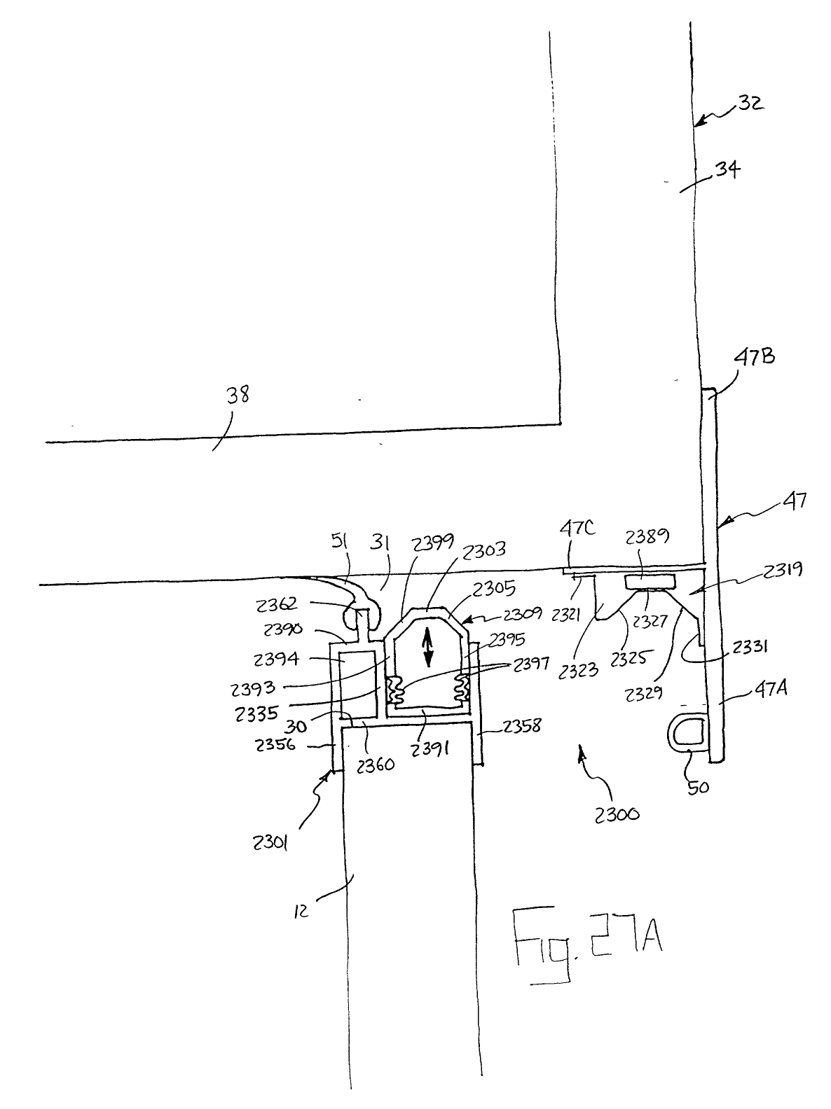

FIGS. 26A-26C show another embodiment of the present invention. Latching mechanism 2200 includes an edge channel 2201 and a magnet assembly including magnet 2209. Edge channel 2201 includes a pair of side walls 2256, 2258 connected together by an end wall 2260. A second end wall 2290 extends from side wall 2256 and carries central wall 2262. An angled wall 2235 extends from second end wall 2290. Another angled wall 2292 extends from one end of side wall 2258. Angled walls 2235 and 2292 are connected together by wall 2237. Walls 2235, 2237, and 2292 together form a recess 2287. A ferrous plate 2289 is mounted to an inner surface of wall 2237.

The magnet assembly includes a mounting wall 2291 and a pair of parallel extending support walls 2293, 2295. The distance between support walls 2293 and 2295 is approximately equal to the width of magnet 2209, thereby permitting magnet 2209 to move in the direction of the arrow shown in FIG. 26A, but preventing side-to-side movement of magnet 2209. Magnet 2209 is attached to mounting plate 2291 by flexible support 2297 which may have an accordion shape to permit movement of magnet 2209 toward and away from mounting wall 2291. As should be apparent from the drawing, as room 32 approaches the retracted position, magnet 2209 becomes attracted to plate 2289 and cams into recess 2287, thereby drawing room 32 toward the retracted position and holding room 32 in place.

Referring now to FIG. 26B, an alternate magnet assembly is shown which includes a magnet 2209 having a body 2211 with surfaces 2299, 2203, and 2205 at one end which are similar to surfaces 2299, 2203, and 2205 shown in FIG. 26A. At the other end of magnet 2209 are two extensions 2213, 2215. Magnet 2209 is captured within a space defined by mounting wall 2291, support walls 2293, 2295 and end walls 2207, 2217 which extend toward one another from support walls 2293, 2295, respectively. The distance between end walls 2207, 2217 is slightly greater than the width of body 2211 of magnet 2209 such that magnet 2209 may move toward and away from perpendicular flange 47C of fascia 47.

FIG. 26C shows a latching mechanism 2200 which is identical to that shown in FIG. 26A except that a spring 2218 is shown attached between mounting wall 2291 and magnet 2209. In the embodiment shown, spring 2218 biases magnet 2209 toward perpendicular flange 47C of fascia 47 to prevent interference between edge channel 2201 and magnet 2209 as room 32 approaches the retracted position. Additionally, an inwardly biasing spring assists the disengagement of magnet 2209 from plate 2289 as magnet 2209 cams out of recess 2287 when room 32 is moved away from the retracted position. It should be understood, however, that plate 2289 could be removed and magnet 2209 could be replaced with a similar piece of nonmagnetic steel. In such an embodiment, spring 2217 would bias the nonmagnetic piece of steel outwardly such that it would move into recess 2287 as room 32 is moved into the retracted position.

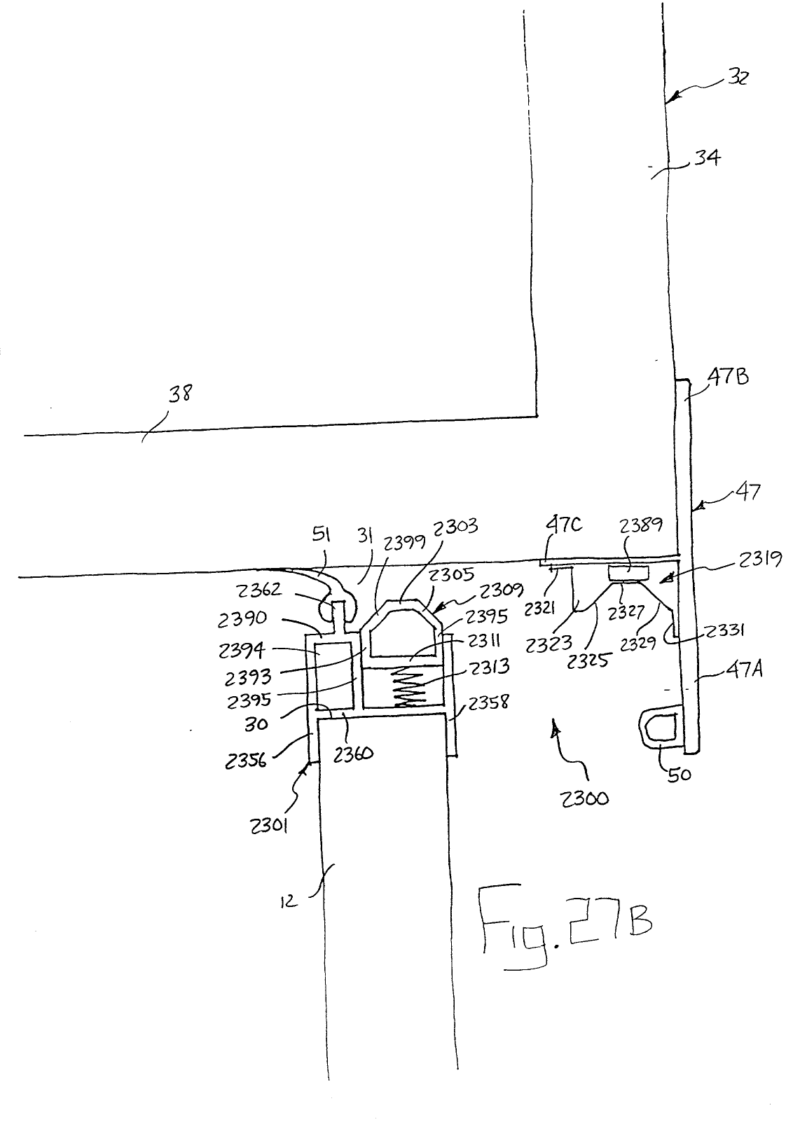

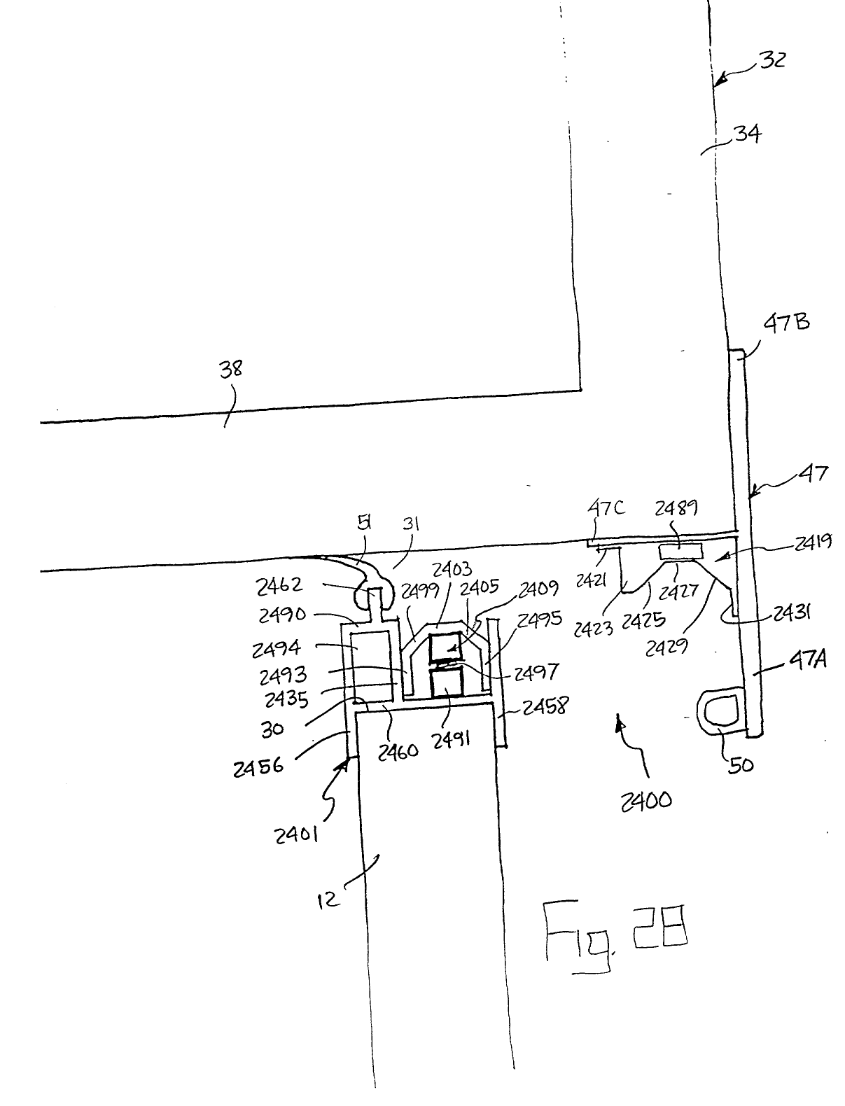

Latching mechanism 2300 is shown in FIGS. 27A and 27B. Latching mechanism 2300 includes a modified edge channel 2301 which includes a pair of side walls 2356, 2358 connected together by an end wall 2360. A second end wall 2390 extends from side wall 2356 and carries central wall 2362 which supports wiper seal 51. A support wall 2335 extends between second end wall 2390 and end wall 2360 as shown.

Magnet 2309 is formed into five walls including first wall 2393, second wall 2399, third wall 2303, fourth wall 2305, and fifth wall 2395. First wall 2393 and fifth wall 2395 are spaced apart to move in the direction of the arrow in FIG. 27A between support wall 2335 and side wall 2358. The ends of first wall 2393 and fifth wall 2395 are connected to a mounting wall 2391 by flexible retainer sections 2397. Mounting wall 2391 is connected to end wall 2360. Accordingly, magnet 2309 is retained partially within edge channel 2301, but may move toward and away from room 32.

Fascia 47 includes a bracket 2319 having a first mounting wall 2321 and a second mounting wall 2331. Bracket 2319 further includes a body 2323 between first wall 2321 and second mounting wall 2331 which is formed to define a recess having a first angled surface 2325, a second angled surface 2329, and a flat surface 2327 extending between the angled surfaces. Body 2323 also houses a steel plate 2389 which is positioned between flat surface 2327 and perpendicular flange 47C. As should be apparent from the drawing, the angles between magnet second wall 2399, third wall 2303, and fourth wall 2305 correspond to the angles between bracket surfaces 2325, 2327, and 2329.

As room 32 is moved toward the retracted position, wall 2305 of magnet 2309 cams against body 2323 of bracket 2319, thereby urging magnet 2309 toward edge channel end wall 2360. As room 32 moves further toward the retracted position, magnet 2309 becomes attracted to plate 2389 and cams into position within the recess defined by surfaces 2325, 2327, and 2329 to hold room 32 in the retracted position.

FIG. 27B shows a modified embodiment of magnetic latching mechanism 2300 wherein magnet 2309 includes a back wall 2311 and a spring 2313 connected between back wall 2311 and edge channel end wall 2360. Spring 2313 biases magnet 2309 toward edge channel end wall 2316 to prevent contact between magnet 2309 and the outer surface of room wall 38 as room 32 is moved between the extended and retracted positions. As room 32 approaches the retracted position, magnet 2309 becomes attracted to plate 2389 and cams into position as described above against the biasing force of spring 2313. As room 32 is moved out of the retracted position, magnet 2309 cams out of the recess formed by surfaces 2325, 2327, 2329 of bracket 2319 and is drawn toward edge channel end wall 2360.

It should be understood that magnet 2309 may be replaced with a nonmagnetic component of similar structure, and spring 2313 may be a compression spring which biases the non-magnetic component outwardly toward side wall 38 of room 32. As room 32 is moved toward the retracted position, the non-magnetic member would cam over body 2323 of bracket 2319 against the biasing force of spring 2313, and then snap into position within the recess defined by surfaces 2325, 2327, 2329 of bracket 2319 to hold room 32 in place.

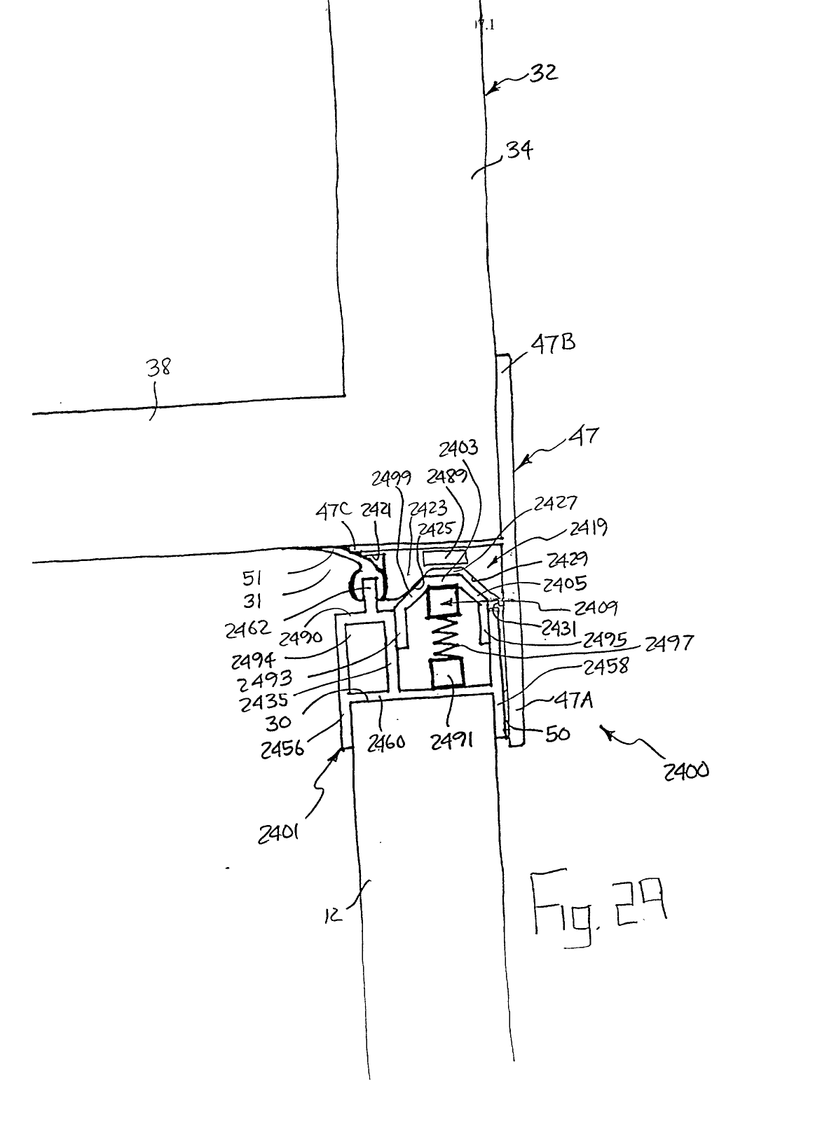

FIGS. 28A and 28B show an alternate embodiment of a magnetic latching mechanism according to the present invention. Latching mechanism 2400 includes a nonmagnetic latching member which is identical in structure to magnet 2309 of FIG. 27A, including walls 2493, 2499, 2403, 2405, and 2495. A magnet 2409 is attached to wall 2403 as shown in FIG. 28A. An electromagnet 2491 is connected to end wall 2460 of edge channel 2401 in alignment with magnet 2409. A spring 2497 is connected between magnet 2409 and electromagnet 2491. Bracket 2419 is identical to that shown in FIG. 27A.

Electromagnet 2491 may be electrically connected through wires (not shown) to the room-out and room-in buttons or switches (not shown) used to extend and retract room 32. Accordingly, when room 32 is retracted, for example, electromagnet 2491 is energized and draws magnet 2409 toward electromagnet 2491 against the biasing force of spring 2497 as shown in FIG. 28A. Accordingly, interference between wall 2403 and the outside surface of room side wall 38 is avoided. As room 32 reaches the retracted position, electromagnet 2491 is de-energized, thereby permitting magnet 2409 to move toward plate 2489 such that walls 2499, 2403, and 2405 cam into position in the recess defined by bracket 2419 as shown in FIG. 28B. Spring 2497 assists in moving magnet 2409 into magnet engagement with plate 2489. It should be understood, however, that spring 2497, alone, could function to force latching mechanism 2400 into the latched position as shown in FIG. 28B when electromagnet 2491 is de-energized. Conversely, magnet 2409, alone, could provide the latching function as described with reference to FIG. 27A.

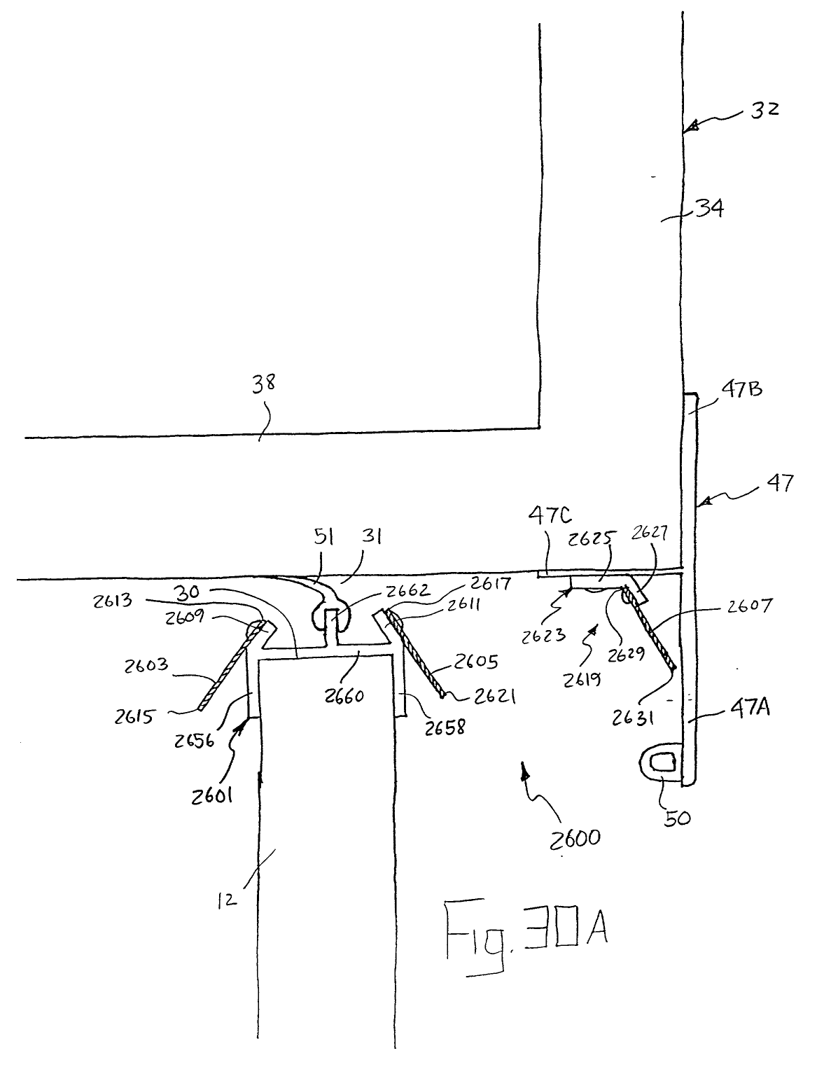

FIGS. 29A and 29B show yet another embodiment of a latching mechanism according to the present invention. As compared to the embodiment shown in FIG. 28A, the embodiment in FIG. 29A replaces magnet 2409, spring 2497, and electromagnet 2491 with expandable member 2597. Expandable member 2597 is attached to wall 2503 of the latching member 2407 and end wall 2560 of edge channel 2501. Bracket 2519 does not include a steel plate as was shown in FIGS. 27A, B and 28A, B. As room 32 is moved toward the retracted position, expandable member 2597 is filled with air, oil, or other suitable substance such that latching member 2407 is extended to cam into the recess formed by bracket 2319 as indicated in FIG. 29B. It should be understood that the travel of latching member 2407 may be limited in a variety of ways such as by expandable member 2597, studs extending from walls 2593, 2595 into slots formed in edge channel walls 2335, 2358, respectively, or other such structure. It should further be understood that latching member 2407 may be moved to the retracted position shown in FIG. 29A (during movement of room 32) by suction, a magnet mounted to latching mechanism 2407 and attracted to a plate mounted to edge channel 2501, or a spring extending between latching member 2407 and edge channel 2501.

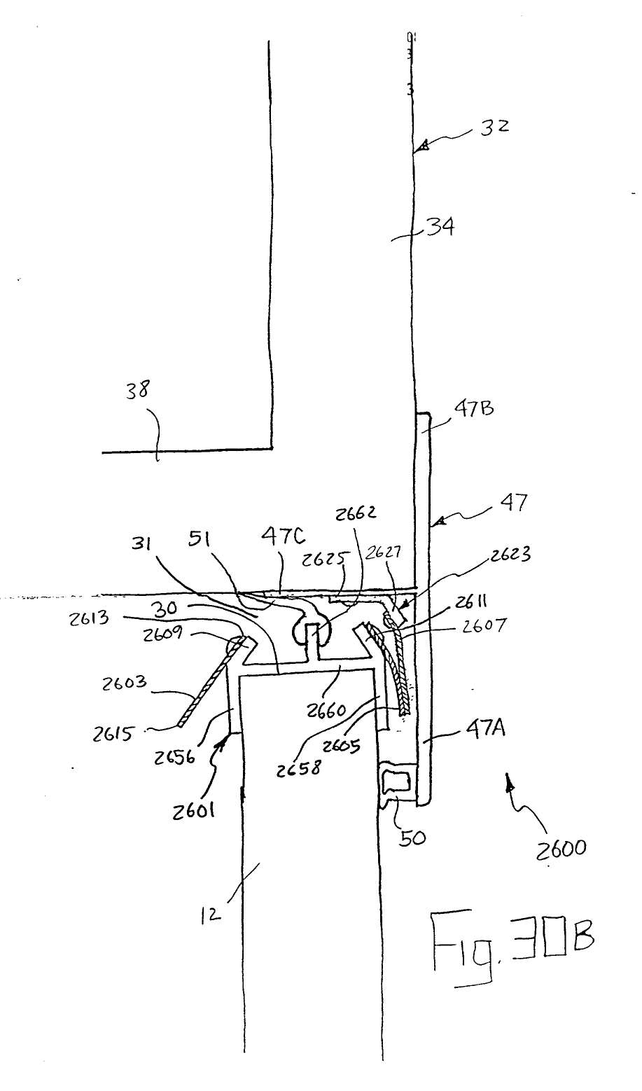

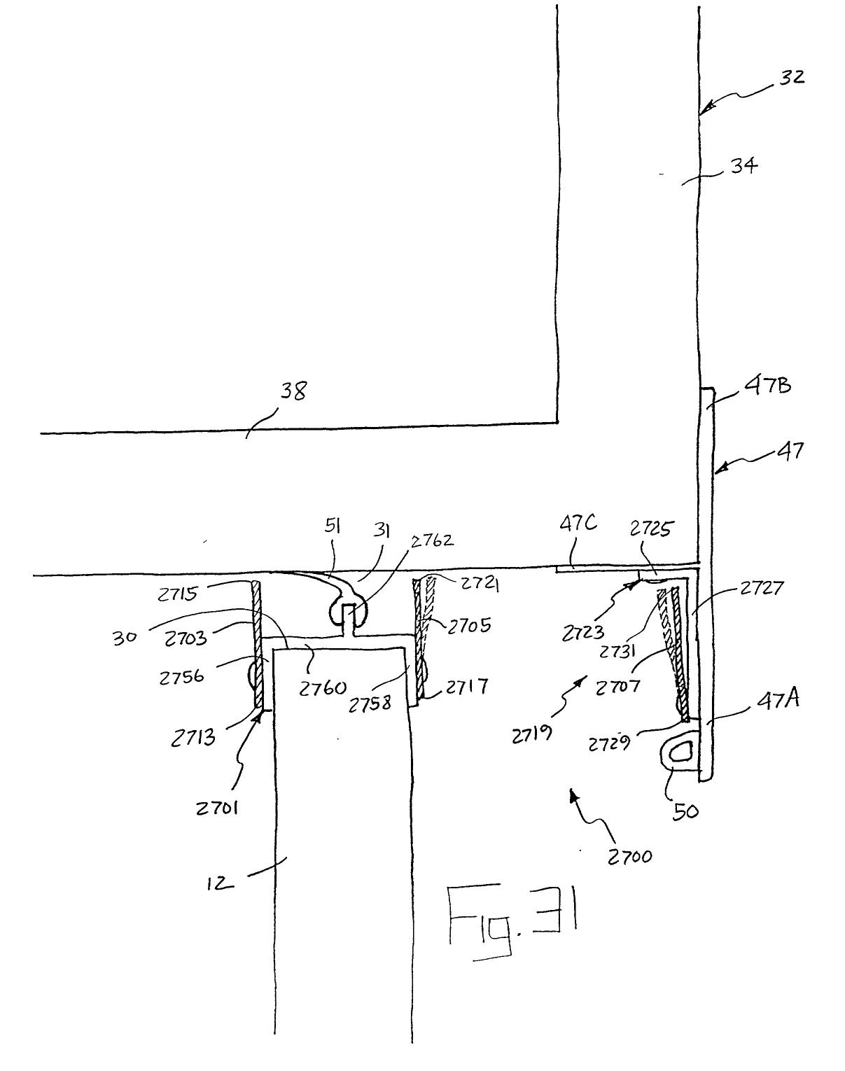

FIG. 30A shows yet another embodiment of a magnetic latching mechanism according to the present invention. Latching mechanism 2600 generally includes a modified edge channel 2601, edge channel magnets 2603, 2605, and mating magnet assemblies 2619 (only one shown). Edge channel 2601 includes a pair of side walls 2656, 2658 connected together by an end wall 2660. A portion 2609 of side wall 2656 extends into gap 31 at an angle as shown. A portion 2611 of side wall 2658 similarly extends into gap 31 at an angle as shown. A central wall 2662 extends from end wall 2660 and supports wiper seal 51 as described above. Magnets 2603, 2605 are elongated strips of flexible magnetic material which may extend the entire vertical length of room side wall 38, or across room ceiling 40 as described above. Magnet 2603 is attached along one edge 2613 to portion 2609 of side wall 2656 using any conventional fastening technique. Free edge 2615 of magnet 2603 extends unsupported into vehicle 10. Similarly, edge 2617 of magnet 2605 is attached to portion 2611 of side wall 2658 in a conventional manner. Free edge 2621 of magnet 2605 extends unsupported away from vehicle side wall 12, toward room fascia 47.

Magnet assembly 2619 includes magnet 2607 and bracket 2623. Magnet 2607 is similar in construction to magnets 2603 and 2605. Bracket 2623 includes mounting wall 2625 which is connected to perpendicular flange 47C of fascia 47. An angled wall 2627 extends from one edge of mounting wall 2625. As shown in the figure, angled wall 2627 is substantially parallel to portion 2611 of edge channel side wall 2658. Edge 2629 of magnet 2607 is attached to angled wall 2627 of bracket 2623 in a conventional manner. Free edge 2631 extends from bracket 2623 toward flange 47A as shown.

Referring now to FIG. 30B, as room 32 reaches the retracted position, magnets 2605 and 2607 become attracted to one another and flex into contact to seal the interior of vehicle 10 as shown. As should be apparent from the foregoing, the flexibility of magnets 2605, 2607 accommodates misalignment between fascia 47 and side wall 12 without using floating magnets as previously described. It should also be understood that bulb seal 50 is optional since magnets 2605, 2607 may provide both a sealing and a locking function. Magnet 2603 is also optional, and cooperates with another magnet assembly (not shown) mounted to an interior fascia (not shown) of room 32 to seal and lock room 32 in an extended position.

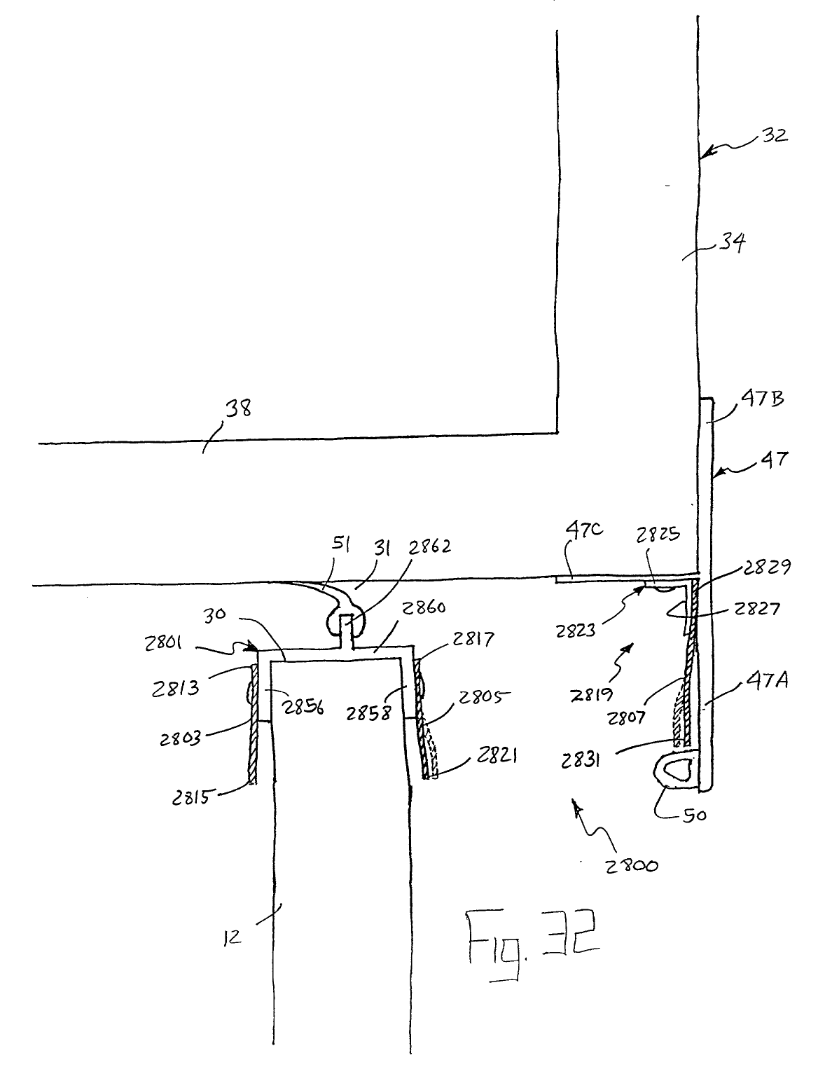

FIG. 31 shows another embodiment of the latching mechanism according to the present invention. Latching mechanism 2700 generally includes edge channel 2701, edge channel magnets 2703, 2705, and magnet assembly 2719. Edge channel 2701 is identical to edge channel 2601, except that portions 2609, 2611 are removed. Magnet 2703 is mounted to side wall 2756 such that free edge 2715 extends into gap 31 as shown. Similarly, magnet 2705 is mounted to side wall 2758 of edge channel 2701 such that free edge 2721 extends into gap 31.

Magnet assembly 2719 includes magnet 2707 and bracket 2723. Bracket 2723 includes mounting wall 2725 which is mounted to perpendicular flange 47C of fascia 47. A second mounting wall 2727 extends from one edge of mounting wall 2725 at a right angle, and is attached to flange 47A of fascia 47. Magnet 2707 is mounted to second mounting wall 2727 such that free edge 2731 is disposed adjacent mounting wall 2725 as shown. When room 32 approaches the retracted position, magnets 2705, 2707 flex (substantially into the positions indicated by dotted lines) and contact one another to seal and lock room 32 in the retracted position.

As should be apparent from the foregoing, bulb seal 50 and magnet 2703 (as well as its corresponding mating magnet assembly attached to the inner fascia of room 32) are optional as described above.

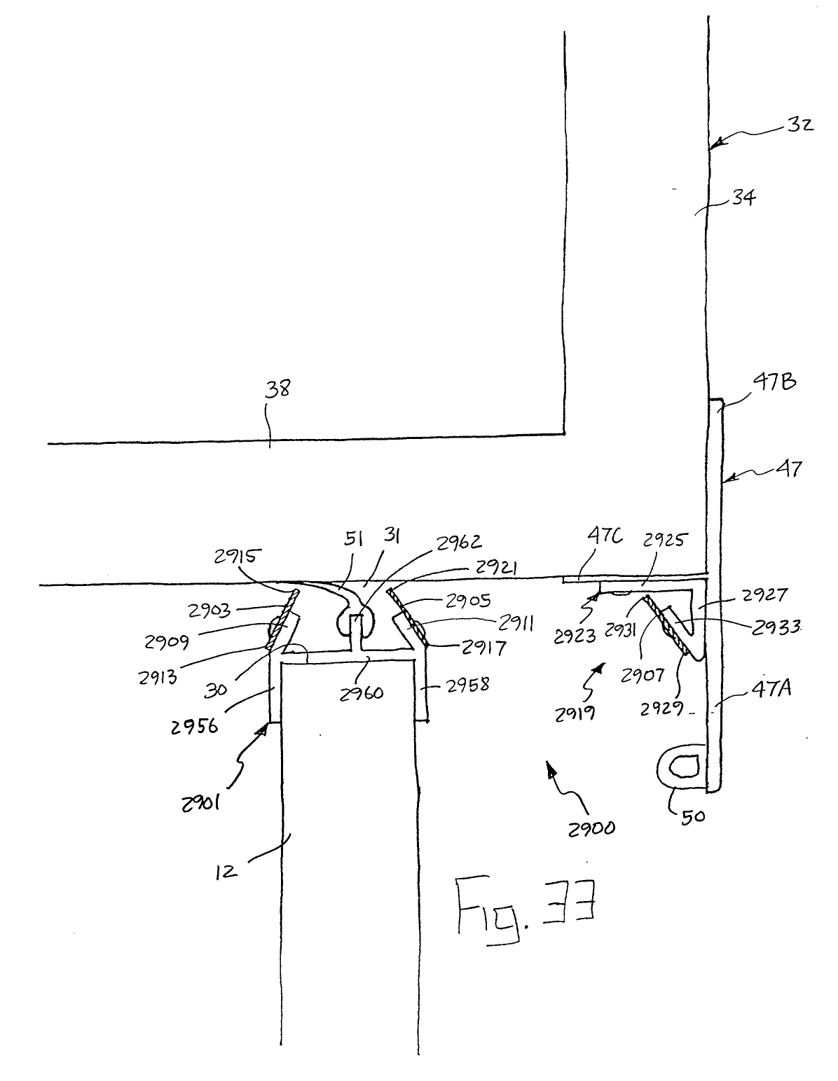

FIG. 32 shows another magnetic latching mechanism according to the present invention. Latching mechanism 2800 is similar to latching mechanism 2700 of FIG. 31 except that the free edges and captive edges of the flexible magnets have been reversed. Specifically, edge channel 2801 is identical to edge channel 2701. Magnet 2803 is connected to side wall 2856 of edge channel 2801 such that free edge 2815 is positioned away from gap 31. Likewise, magnet 2805 is connected to side wall 2858 such that free edge 2821 is positioned away from gap 31. Magnet assembly 2819 includes bracket 2823 and magnet 2807. Bracket 2823 includes mounting wall 2825 which is mounted to perpendicular flange 47C of fascia 47. Bracket 2823 also includes second mounting wall 2827 which extends from one edge of mounting wall 2825 at a right angle. Edge 2829 of magnet 2807 is sandwiched between second mounting wall 2827 and flange 47A of fascia 47. Screws or bolts (not shown) may be used to secure magnet 2807 in place. Free edge 2831 of magnet 2807 is thus disposed adjacent to seal 50. As indicated in dotted lines in FIG. 32, when room 32 reaches the retracted position, magnets 2805, 2807 flex into engagement, thereby sealing and locking room 32. When compared to magnets 2705, 2707 of FIG. 31, magnets 2805, 2807 which connect free ends 2821, 2831, may be less likely to spread apart and become disengaged as a result of wind during movement of vehicle 10.

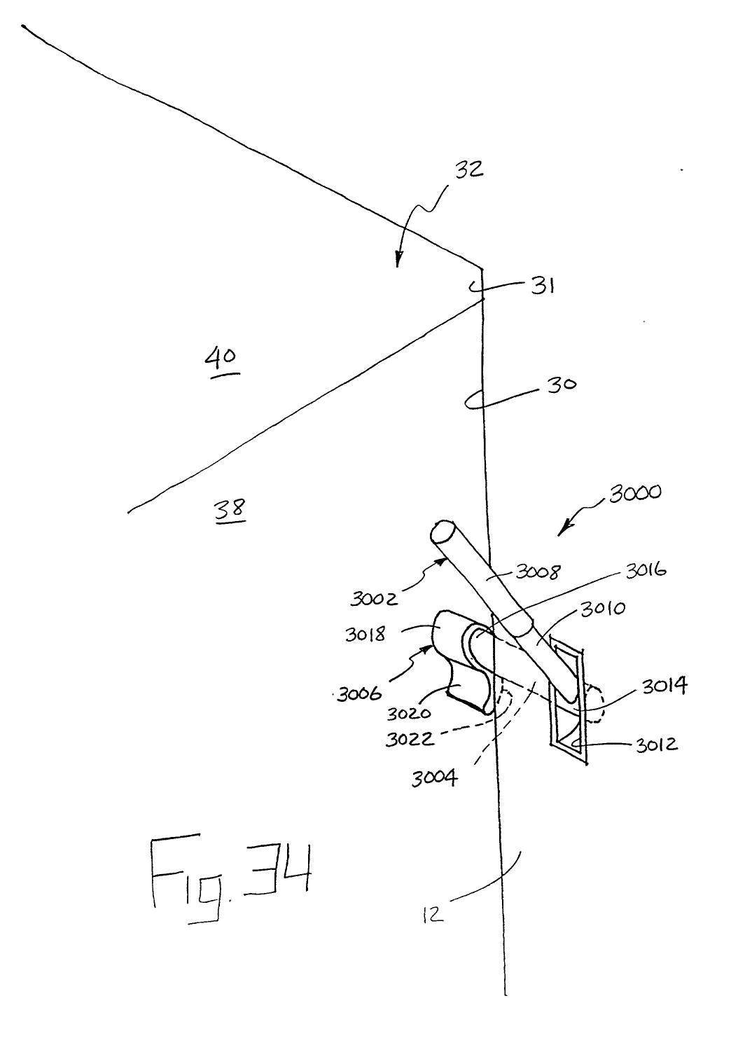

FIG. 33 shows yet another embodiment of a latching mechanism according to the present invention. Latching mechanism 2900 is substantially similar to latching mechanism 2600 of FIG. 30A except that the free edges and captive edges of the magnets of each embodiment have been reversed. Specifically, edge channel 2901 is identical to edge channel 2601. Magnet 2903 is mounted to portion 2909 such that free edge 2915 extends into gap 31. Similarly, magnet 2905 is mounted to portion 2911 such that free edge 2921 extends into gap 31.

Magnet assembly 2919 includes a bracket 2923 and a magnet 2907. Bracket 2923 includes a mounting wall 2925 which is mounted to perpendicular flange 47C of fascia 47. Bracket 2923 further includes a second wall 2927 which extends perpendicularly from one edge of mounting wall 2925 along flange 47A, and a support wall 2933 which extends from one edge of second wall 2927 at an angle toward mounting wall 2925 as shown. Support wall 2933 and portion 2911 of side wall 2958 are substantially parallel. Magnet 2907 is attached to support wall 2933 such that free edge 2931 is disposed adjacent mounting wall 2925 as shown. As should be apparent from the foregoing, as room 32 approaches the retracted position, magnets 2905, 2907 flex into engagement and seal and lock room 32 in the retracted position. Additionally, the angle of engagement between magnets 2905, 2907 provide a centering function to center room 32 in side wall opening 30.

As addressed above, the magnetic lock applied by any of the above-described embodiments when room 32 is in a retracted position may be overcome or broken in any of a variety of ways. For example, as room 32 is moved out of the retracted position, the weight of room 32 may be sufficient, along with the outward force applied by the drive mechanism, to overcome the locking force of the magnetic latching mechanism. Alternatively, an electromagnet could be connected to the room-out button to apply a repulsive magnetic force when the room-out button is actuated to break the lock of the magnetic latching mechanism. Additionally, as described above with reference to FIG. 3, when telescopic support members 44, 46 of the drive mechanism apply force to a lower portion of room 32, back wall 34 and fascia 47 of room 32 tend to peel away from side wall 12, or provide a fulcrum along the top edge of fascia 47 such that back wall 34 and fascia 47 act as a lever to disengage any magnet along the upper edge of fascia 47. Another fulcrum along the lower edge of room floor 35 transfers outward force to the upper portion of room 32 with outward movement of telescoping support members 44, 46 of the room drive mechanism. Specifically, as support members 44, 46 apply outward force to a lower portion of back wall 34, room 32 tends to begin to rotate slightly in a counterclockwise direction as viewed in FIG. 3. However, this rotation forces edge “A” of room floor 35 downwardly into engagement with vehicle floor 20. Any further outward force results in outward movement of room 32 to overcome the locking force of the magnetic latching mechanism.

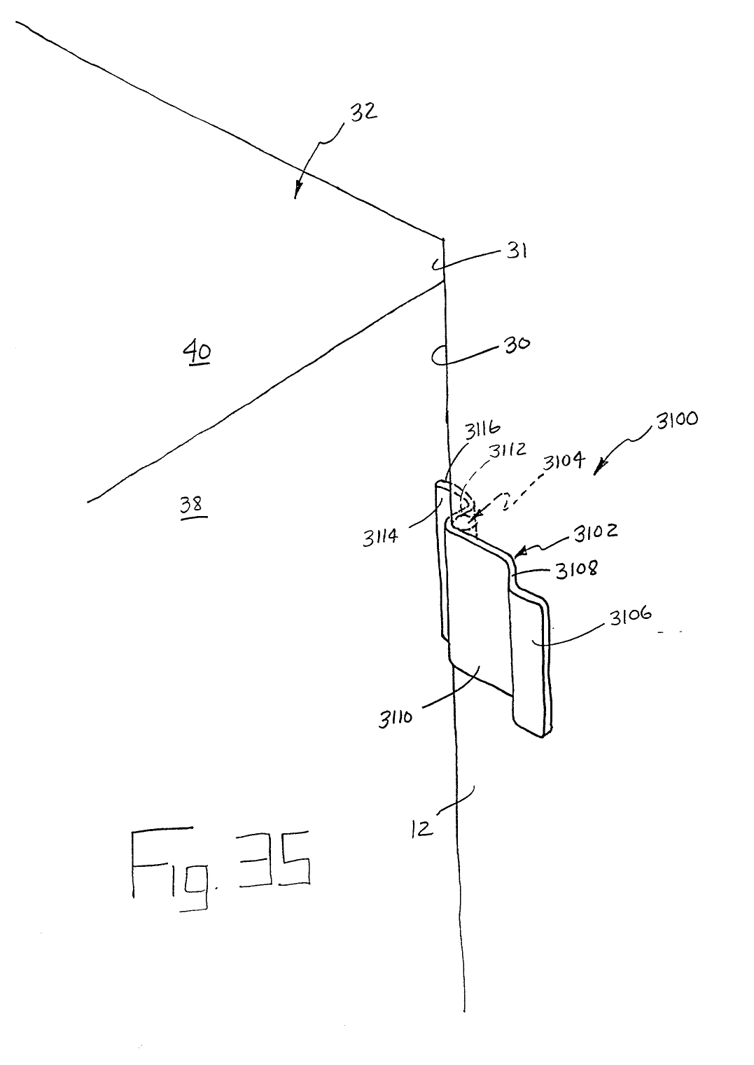

FIGS. 34 through 37 show manual releases for use with a latching mechanism according to the present invention. Release 3000 of FIG. 34 includes a lever 3002 connected to a drive rod 3004 which carries a cam member 3006. Specifically, lever 3002 includes a handle 3008 and a shaft 3010 which extends through a slot 3012 formed in vehicle side wall 12 adjacent opening 30 and room side wall 38. Shaft 3010 is connected to an end 3014 of drive rod 3004. The other end 3016 of drive rod 3004 is connected to cam member 3006. Drive rod 3004 is disposed substantially within vehicle wall 12 and is mounted for pivoting about its longitudinal axis which is substantially perpendicular to room side wall 38. Cam member 3006 includes a cylindrical body which receives and is connected to end 3016 of drive rod 3004, and a lever 3020 having a curved camming surface 3022 which faces fascia 47 (not shown) of room 32. As shown, cam member 3006 is disposed substantially within gap 31 formed between vehicle side wall 12 and room side wall 38. Of course, another release 3000 could be located on the other side of room 32 adjacent side wall 36.

In operation, when room 32 is magnetically locked in the retracted position, an operator may pull lever 3002 by handle 3008 downwardly to release the magnetic lock provided by a latching mechanism according to the present invention. As lever 3002 is rotated downwardly, drive rod 3004 rotates in a counterclockwise direction about its longitudinal axis. Accordingly, cam member 3006 rotates in a counterclockwise direction such that camming surface 3022 engages fascia 47. Further rotation of cam member 3006 applies outward force to fascia 47 through camming surface 3022 to disengage the magnetic lock of a latching mechanism according to the present invention. Release 3000 may be spring-loaded to return to the position shown in FIG. 34.

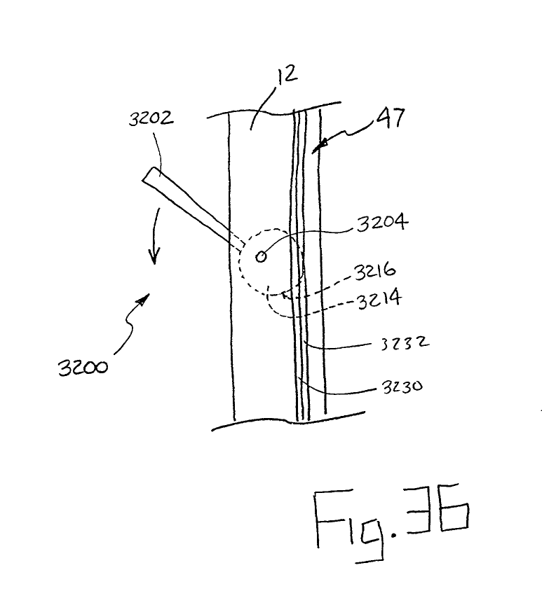

FIG. 35 shows another manual release 3100 for use in overcoming the locking force of a magnetic latching mechanism according to the present invention. Release 3100 includes a lever 3102 and a pivot rod 3104. Lever 3102 includes a handle portion 3106, an offset portion 3108 which extends from handle portion 3106 at an angle, a spacer portion 3110 which extends from offset portion 3108 and may be substantially parallel to handle portion 3106, another offset portion 3112 which extends at an angle from spacer portion 3110, and a drive portion 3114 which extends at an angle from offset portion 3112. Drive portion 3114 includes a camming surface 3116 which faces fascia 47 (not shown) of room 32. Offset portion 3112 is connected to pivot rod 3104 which is mounted to vehicle side wall 12 for pivotal movement about its longitudinal axis.

In operation, an operator may overcome the locking force of a magnetic latching mechanism according to the present invention by pulling handle portion 3106 away from side wall 12 such that drive portion 3114 pivots about drive rod 3104, causing camming surface 3116 to engage fascia 47 and move room 32 away from side wall 12. Release 3100 may also be returned to the position shown in FIG. 35 by a biasing spring. It should be apparent from the drawing that when room 32 is in its extended position, the interior fascia (not shown) of room 32 rests against spacer portion 3110, which lies flat against vehicle side wall 12.

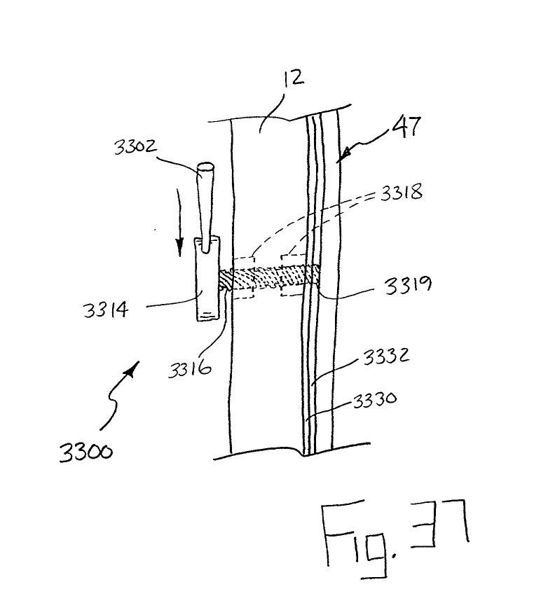

FIG. 36 shows another embodiment of a manual release 3200 for use in overcoming the locking force of a magnetic latching mechanism according to the present invention. Release 3200 includes a handle 3202 which extends through a slot (not shown) in vehicle side wall 12, and is connected to a cam member 3214. Cam member 3214 may be disc-shaped, and is mounted for rotation about a pivot rod 3204. Pivot rod 3204 is mounted between supports (not shown) within side wall 12. Cam member 3214 includes a camming surface 3216 for engaging fascia 47. As shown, a magnet 3230 mounted to side wall 12 is magnetically engaged with a plate 3232 mounted to fascia 47.

In operation, an operator may move lever 3202 downwardly in the direction of the arrow shown in FIG. 36. Since cam member 3214 receives pivot rod 3204 through an off-center opening, downward movement of lever 3202 causes cam member 3214 to move partially outwardly as it rotates about pivot rod 3204. Accordingly, camming surface 3216 forces fascia 47 away from side wall 12, thereby overcoming the locking force between magnet 3230 and plate 3232.

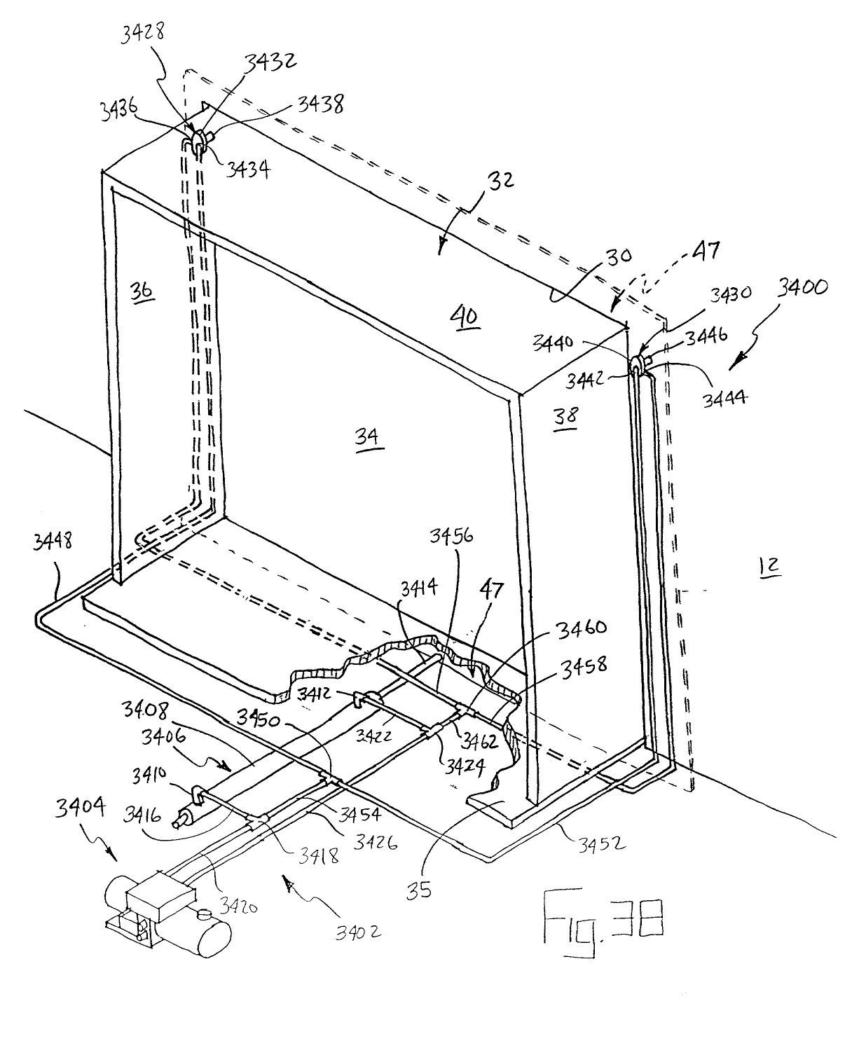

FIG. 37 depicts another embodiment of a manual release 3300 for use in overcoming the locking force of a magnetic latching mechanism according to the present invention. Release 3300 generally includes a lever 3302, a drive block 3314, a high lead screw 3316, and a pair of nuts 3318. Lever 3302 is attached to drive block 3314, which may be formed as a wheel or disk. Drive block 3314 includes an opening (not shown) for receiving screw 3316. Nuts 3318 are embedded or mounted within side wall 12 to prevent movement of nuts 3318. Screw 3316 is threaded through nuts 3318 (and a bore extending through side wall 12) such that end 3319 of screw 3316 engages fascia 47 when room 32 is in the retracted position.

To overcome the locking force of the attraction between magnet 3330 and plate 3332, an operator may move lever 3302 downwardly, rotating drive block 3314 such that drive screw 3316 turns through nuts 3318 to extend farther from side wall 12. As screw 3316 is threaded through nuts 3318, end 3319 of screw 3316 forces fascia 47 and plate 3332 away from magnet 3330, thereby overcoming the locking force of a latching mechanism according to the present invention.

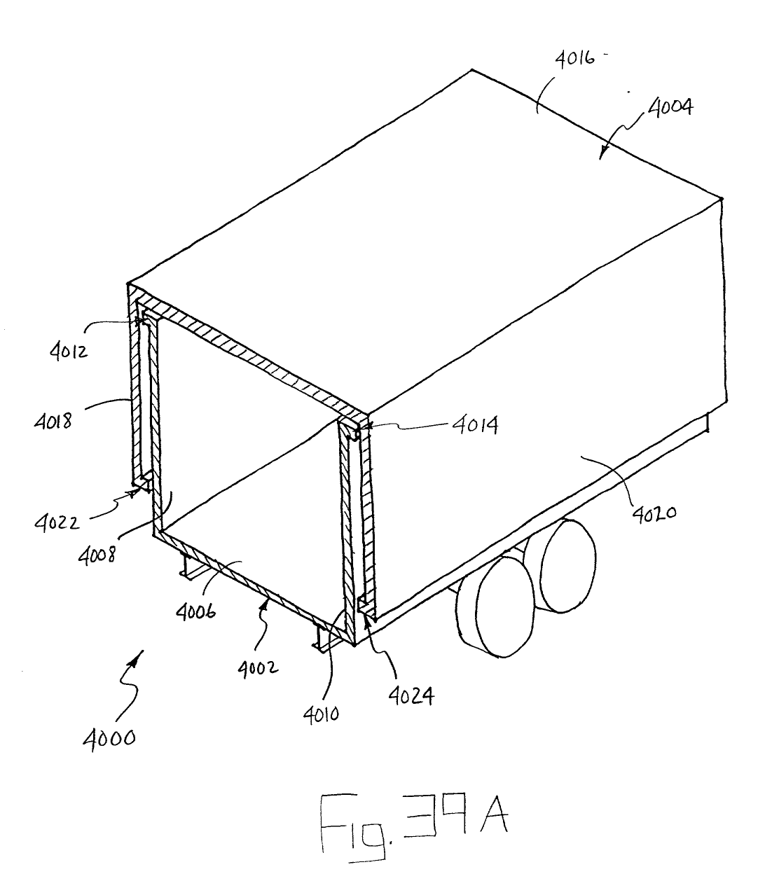

FIG. 38 shows an automatic release 3400 for use with a latching mechanism according to the present invention. Release 3400 is suited for use with a room 32 driven by a hydraulic actuation system 3402. Hydraulic actuation system 3402 includes a bi-directional pump 3404 connected to a hydraulic cylinder or ram 3406. Ram 3406 is mounted to the frame (not shown) of vehicle 10 and is positioned substantially perpendicular to room back wall 34. Ram 3406 includes a cylinder 3408 which has a first port 3410 at one end and a second port 3412 at the other end. Ram 3406 further includes a standard piston (not shown, but disposed within cylinder 3408 between first port 3410 and second port 3412) connected to a drive rod 3414. The other end of drive rod 3414 is connected to fascia 47 of room 32. Port 3410 is connected through tubing 3416 to T-coupling 3418. One side of T-coupling 3418 is connected to one pump port (not shown) through tubing 3420. Port 3412 is similarly connected through tubing 3422, T-coupling 3424, and tubing 3426 to the other port (not shown) of pump 3404.

Release 3400 includes a pair of pancake cylinders 3428, 3430 mounted to vehicle side wall 12 adjacent the upper corners of room 32. Cylinder 3428 includes a housing 3432 having a first port 3434 and a second port 3436. Cylinder 3428 also includes a push rod 3438. Cylinder 3430 similarly includes a housing 3440 having a first port 3442, a second port 3444, and a push rod 3446. First port 3434 of cylinder 3428 is connected by tubing 3448 to one side of T-coupling 3450. First port 3442 of cylinder 3430 is similarly connected by tubing 3452 to the other side of coupling 3450. The common opening of coupling 3450 is connected to coupling 3418 by tubing 3454. Second ports 3436, 3444 of cylinders 3428, 3430, respectively, are connected through tubing 3456, 3458 to a T-coupling 3460, which is connected by tubing 3462 to T-coupling 3424.

In operation, an operator actuates a room-out button (not shown) which causes pump 3404 to pump hydraulic fluid through tubing 3420. Hydraulic pressure is applied to cylinders 3428, 3430 through the plumbing shown to cause push rods 3438, 3446, respectively, to move outwardly relative to vehicle side wall 12 against fascia 47 of room 32. This outward pressure, combined with the outward force applied by ram 3406 when fluid is routed through port 3410 causing drive rod 3414 to move outwardly, both automatically disengages any magnetic latching mechanism and moves room 32 out of the retracted position. When room 32 is to be retracted, the operator actuates a room in switch (not shown) which causes pump 3404 to pump hydraulic fluid through tubing 3426. Hydraulic pressure is thus applied to second ports 3434, 3444 of cylinders 3428, 3430, respectively, causing push rods 3438, 3446 to retract within housings 3432, 3440, respectively. Additionally, hydraulic fluid is routed through second port 3412 of ram 3406 to retract drive rod 3414 into cylinder 3408. As such, room 32 is moved toward the retracted position, and push rods 3438, 3446 are retracted so as to avoid interference with the proper sealing between room fascia 47 and vehicle side wall 12.

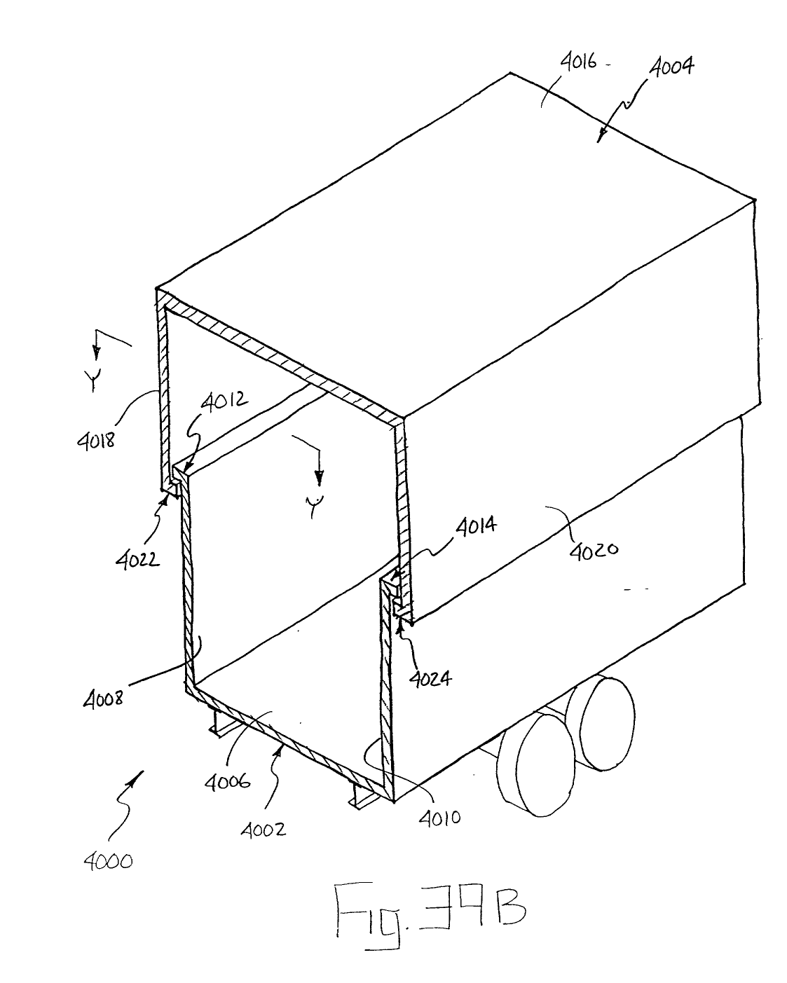

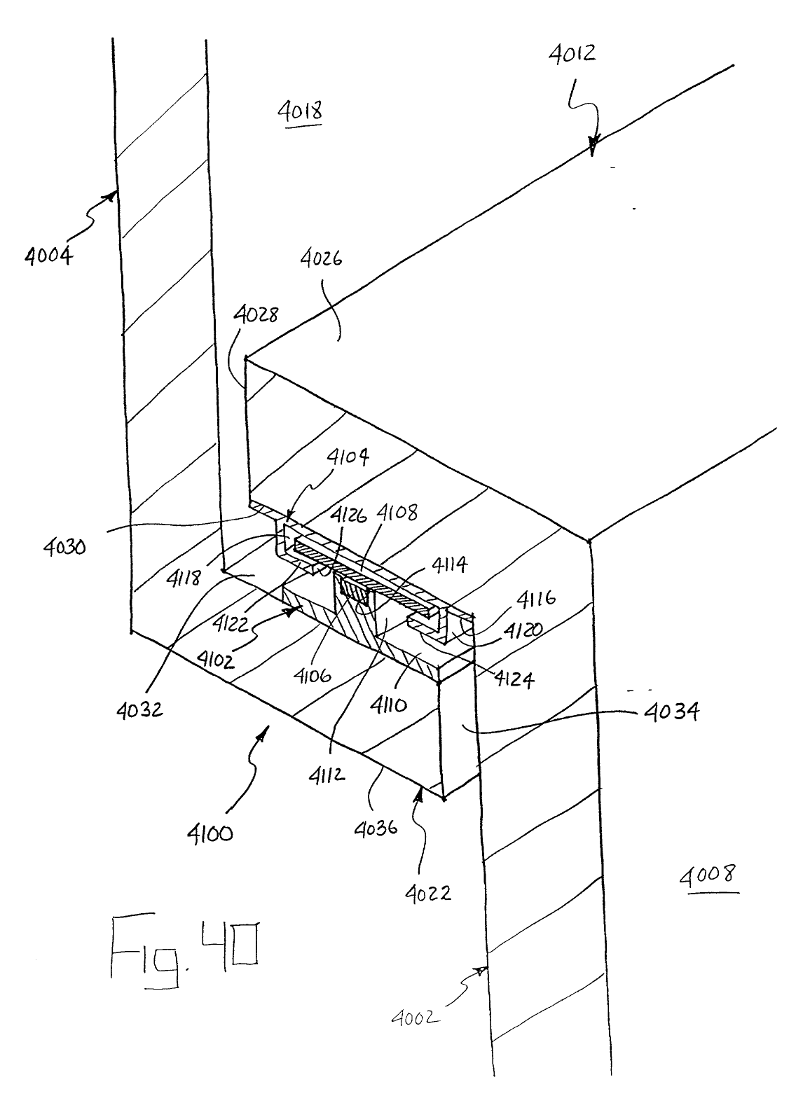

FIGS. 39A and 39B show another application for the various magnetic latching and sealing mechanisms described herein. Referring to FIG. 39A, a vertically expandable mobile living area 4000, such as a recreational vehicle or trailer, is shown. Area 4000 is defined by a lower structure 4002 and an upper structure 4004. Lower structure 4002 includes a floor 4006, a pair of parallel side walls 4008, 4010, and parallel end walls (none shown). A ledge 4012 extends perpendicularly outwardly from the upper edge of side wall 4008. Similarly, a ledge 4014 extends perpendicularly outwardly from the upper edge of side wall 4010. Similar ledges extend from the end walls and are integral with ledges 4012, 4014.

Upper structure 4004 includes a ceiling 4016, a pair of parallel side walls 4018, 4020, and a pair of end walls (not shown). As shown, the distance between side walls 4018, 4020 is slightly greater than the distance between the outer edge surfaces of ledges 4012, 4014. A ledge 4022 extends perpendicularly inwardly from the lower edge of side wall 4018. Similarly, a ledge 4024 extends perpendicularly inwardly from a lower edge of side wall 4020. Similar ledges extend from the end walls (not shown) and are integral with ledges 4022, 4024. As shown, the distance between the inwardly facing surfaces of ledges 4022, 4024 is slightly greater than the distance between side walls 4008, 4010 of lower structure 4002.

Referring now to FIG. 39B, upper structure 4004 is shown in its extended position, wherein the vertical dimension of area 4000 is increased. Upper structure 4004 may be moved between the retracted position (FIG. 39A) and the extended position (FIG. 39B) using any of a number of conventional drive mechanisms. As shown, when upper structure 4004 is in the extended position, ledge 4022 is disposed adjacent ledge 4012, and ledge 4024 is disposed adjacent 4014.

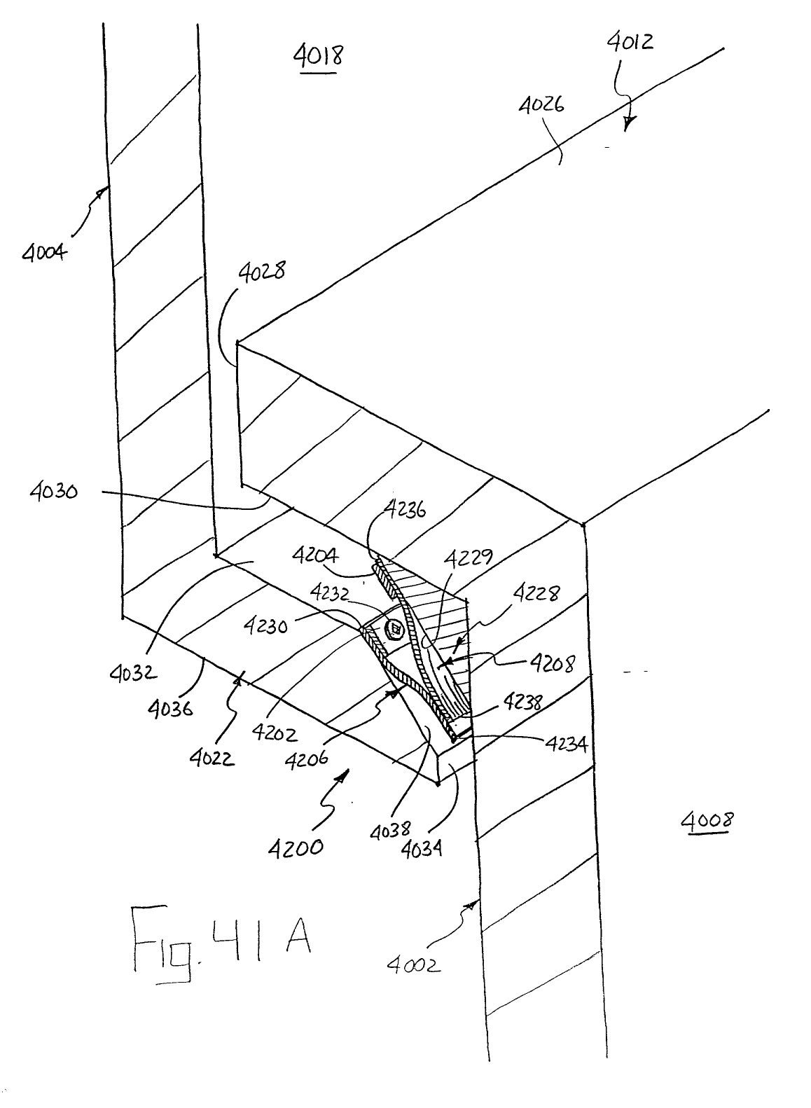

FIG. 40 shows one embodiment of a magnetic seal according to the present invention for use with a vertically expanding room. As shown in FIG. 40, ledge 4012 includes an upper surface 4026, an outer surface 4028, and a lower surface 4030. Similarly, ledge 4022 includes an upper surface 4032, an inner surface 4034, and a lower surface 4036. Magnetic seal 4100 generally includes a lower bracket 4102, a upper bracket 4104, a magnet 4106, and a plate 4108. Lower bracket 4102 includes a body 4110 which is mounted to upper surface 4032 of ledge 4022 using any conventional fastening technique, and a rib 4112 projecting from body 4110. Along its upper edge, rib 4112 defines a channel 4114 which is sized to receive magnet 4106. Magnet 4106 is attached or fastened within channel 4114 using any conventional technique.

Upper bracket 4104 includes a mounting wall 4116 which is attached to lower surface 4030 of ledge 4012. A pair of parallel walls 4118, 4120 extend perpendicularly from mounting wall 4116. A pair of opposed retaining walls 4122, 4124 extend toward one another in substantially the same plane, perpendicular to parallel walls 4118, 4120, respectively. Retaining walls 4122, 4124 define a slot 4126. Plate 4108 is retained within the channel defined by upper bracket 4104. As should be apparent from the figure, as upper structure 4004 is moved upwardly into the extended position such that ledge 4022 is moved near ledge 4012, magnet 4106 becomes attracted to plate 4018, thereby providing a seal around the perimeter of mobile living area 4000. Plate 4108 floats within upper bracket 4104 because the distance between mounting wall 4116 and retaining walls 4122, 4124 is greater than the thickness of plate 4108. Accordingly, ledge 4022 need not be precisely spaced apart from ledge 4012 when upper structure 4004 is in the extended position for plate 4108 and magnet 4106 to provide the above-described seal.

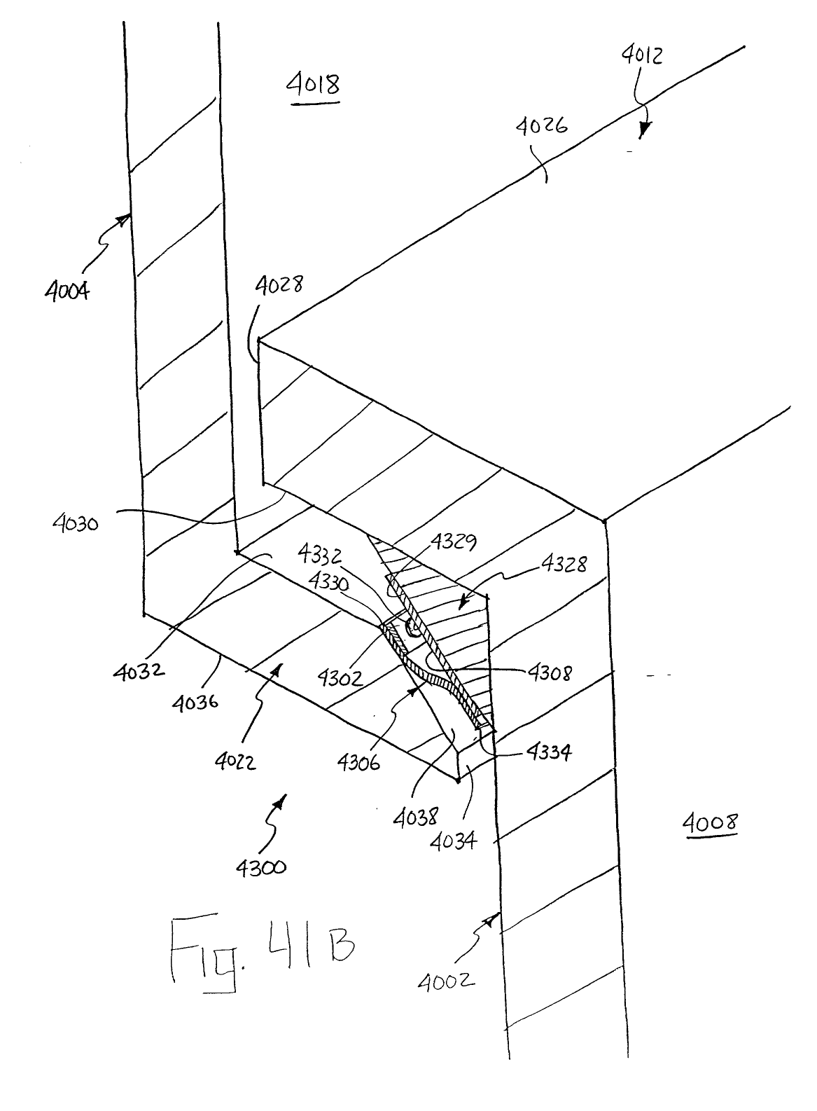

FIG. 41A depicts yet another embodiment of a magnetic seal according to the present invention, used in conjunction with vertically expanding mobile living space 4000. Magnetic seal 4200 is mounted to a modified upper structure 4004 wherein ledge 4022 includes an angled surface 4038 between upper surface 4032 and inner edge 4034. Magnetic seal 4200 generally includes a first, flexible magnetic strip 4206, a retaining bar 4202, a second, flexible magnetic strip 4208, and a second retaining bar 4204. First magnetic strip 4206 includes a captive edge 4230 and a free edge 4234. First magnetic strip 4206 is sandwiched between retaining bar 4202 and angled surface 4038 using standard fasteners 4232 (one shown). Second magnetic strip 4208 is attached to a wedge 4228 having an angled lower surface 4229 which is substantially parallel to angled surface 4038 of lower ledge 4022. Wedge 4228 is attached lower surface 4030 of upper wedge 4012 and the outer surface of side wall 4008 of lower structure 4002 using any conventional fastening technique. Second magnetic strip 4208 includes a captive edge 4236 and a free edge 4238. Captive edge 4236 is sandwiched between angled surface 4229 and second retaining bar 4204 using standard fasteners (none shown). When upper structure 4004 reaches the extended position shown in FIG. 41A, first magnetic strip 4206 becomes attracted to second magnetic strip 4208. Both strips flex slightly toward one another and engage to provide a magnetic seal about the perimeter of the interface between lower structure 4002 and upper structure 4004.

Magnetic seal 4300 of FIG. 41B is identical to magnetic seal 4200 except that second magnetic strip 4208 and retaining bar 4204 have been replaced with a ferrous plate 4308 which is attached in a conventional manner to angled surface 4329 of wedge 4328. Accordingly, when upper structure 4004 reaches the extended position as shown in FIG. 41B, first magnetic strip 4306 becomes attracted to and flexes into engagement with plate 4308 to provide the desired seal.

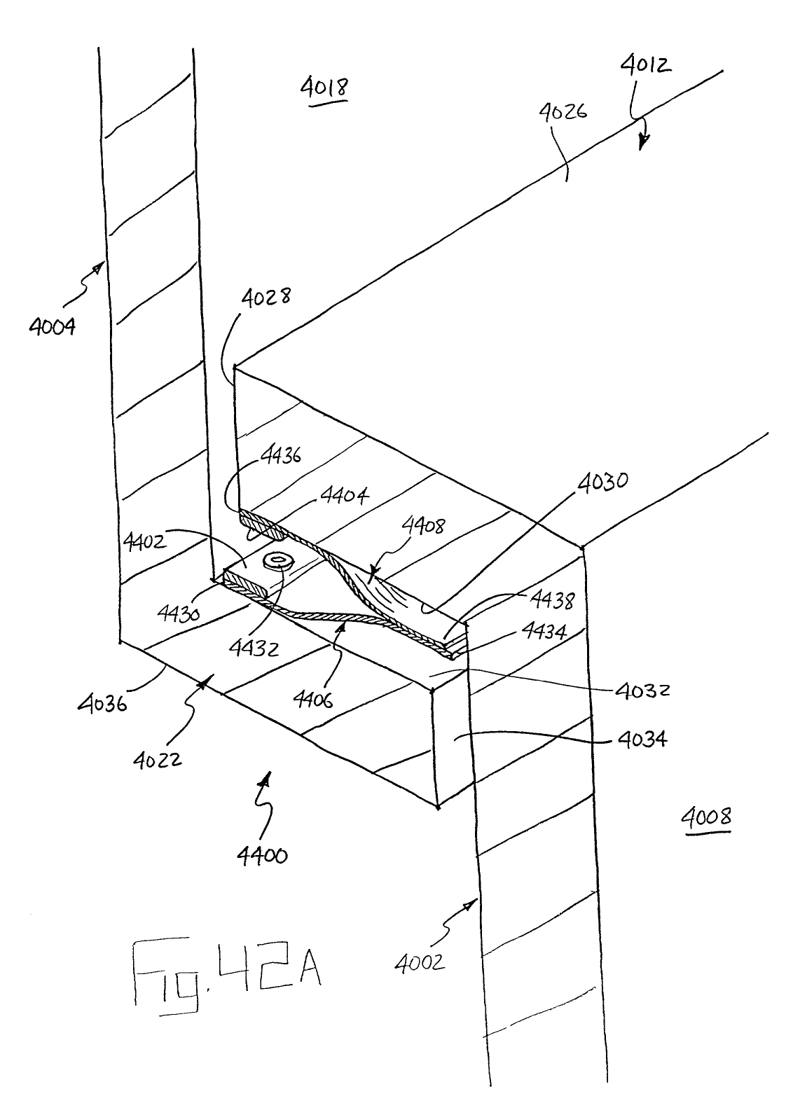

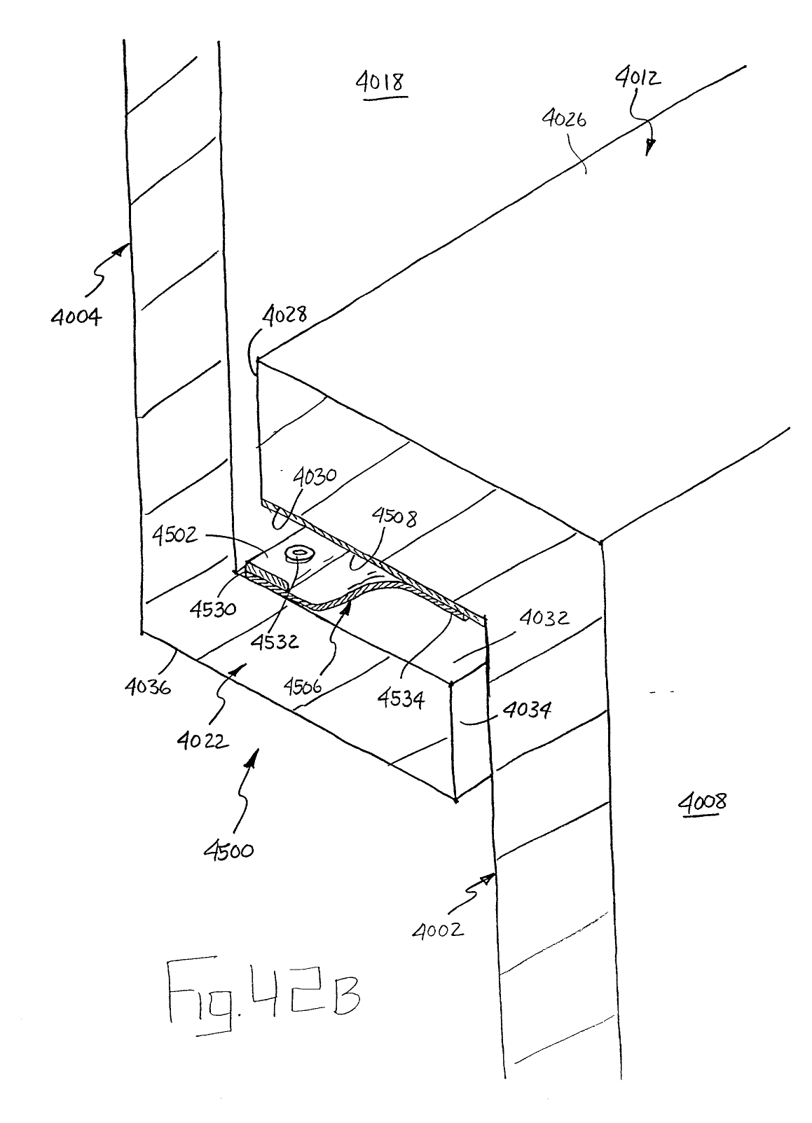

Magnetic seal 4400 of FIG. 42A is similar to magnetic seal 4200 of FIG. 41A, but mounted between standard lower ledge 4022 and standard upper ledge 4012. Specifically, magnetic seal 4400 includes a first magnet 4406, a retaining bar 4402, a second magnetic strip 4408, and a second retaining bar 4404. Captive edge 4430 of first magnetic strip 4406 is sandwiched between retaining bar 4402 and upper surface 4032 of lower ledge 4022 using standard fasteners 4432 (one shown). Similarly, captive edge 4436 of second magnetic strip 4408 is sandwiched between second retaining bar 4404 and lower surface 4030 of upper ledge 4012 using standard fasteners (none shown). When upper structure 4004 reaches the extended position as shown in FIG. 42A, free edge 4434 of first magnetic strip 4406 becomes attracted to free edge 4438 of second magnetic strip 4408. The magnetic strips flex into engagement with one another to provide the desired seal.

Magnetic seal 4500 of FIG. 42B is identical to magnetic seal 4400 of FIG. 42A except that second magnetic strip 4408 and retaining bar 4404 are replaced with a ferrous plate 4508 which is attached using conventional fasteners to lower surface 4030 of upper ledge 4012. Accordingly, when upper structure 4004 reaches the extended position as shown in FIG. 42B, free edge 4534 of first magnetic strip 4506 flexes into engagement with plate 4508 to provide the desired seal.

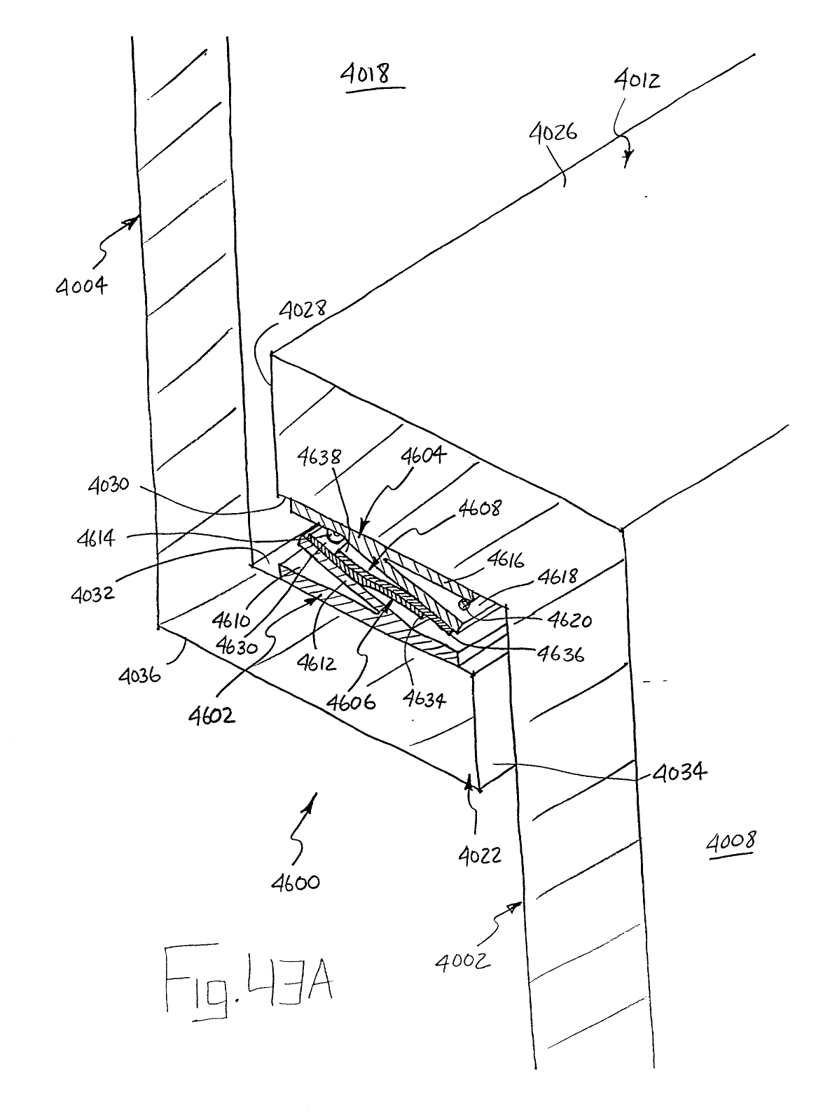

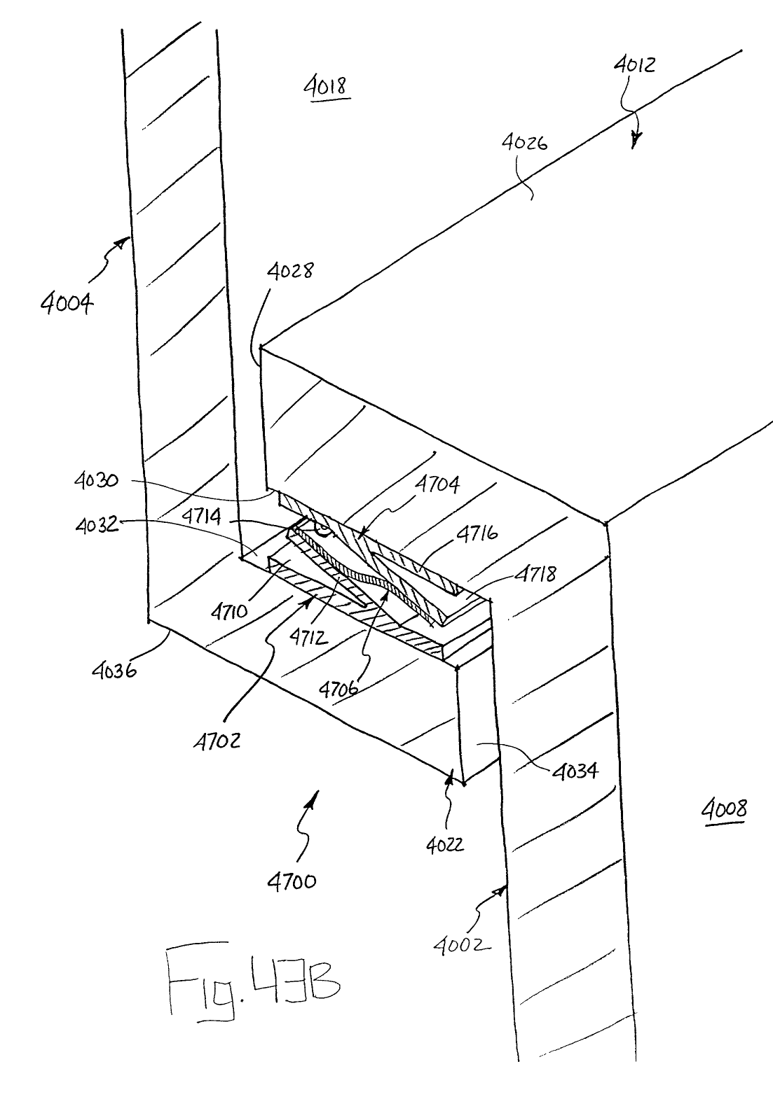

FIG. 43A shows another embodiment of a magnetic seal according to the present invention. Magnetic seal 4600 generally includes a first bracket 4602, a second bracket 4604, a first magnetic strip 4606, and a second magnetic strip 4608. First bracket 4602 includes a mounting wall 4610 which is attached to upper surface 4032 of lower ledge 4022. An angled wall 4612 extends from mounting wall 4610 toward side wall 4018 of upper structure 4004. Captive edge 4630 of magnetic strip 4606 is attached to angled wall 4612 using standard fasteners 4614 (one shown). Similarly, second bracket 4604 includes a mounting wall 4616 which is attached to lower surface 4030 of upper ledge 4012 using conventional fasteners. An angled wall 4618 extends from mounting wall 4616 toward side wall 4008 of lower structure 4002. Captive edge 4636 of second magnetic strip 4608 is attached to angled wall 4618 using conventional fasteners 4620 (one shown). When upper structure 4004 is moved to the extended position as shown in FIG. 43A, free edge 4634 of first magnetic strip 4606 becomes attracted to and flexes into engagement with second magnetic strip 4608. Additionally, free edge 4638 of second magnetic strip 4608 becomes attracted to and flexes into engagement with first magnetic strip 4606. Accordingly, the desired seal is provided about the perimeter about the interface between upper structure 4004 and lower structure 4002.

Magnetic seal 4700 of FIG. 43B is identical to magnetic seal 4600 of FIG. 43A except that second magnetic strip 4608 has been removed and second bracket 4704 is made of ferrous material. Accordingly, when upper structure 4004 is moved into the extended position as shown in FIG. 43B, magnetic strip 4706 becomes attracted to and flexes into engagement with angled wall 4718 of second bracket 4704 to provide the desired seal.

Although the present invention has been shown and described in detail, the same is to be taken by way of example only and not by way of limitation. Numerous changes can be made to the embodiments described above without departing from the scope of the invention.

What is claimed is:

1. A recreational vehicle having a main living area and an expandable living area, said expandable living area being extendable and retractable through an opening in said main living area, said recreational vehicle further comprising magnetic latching means for holding said expandable living area in a retracted position.

2. The recreational vehicle of claim 1, wherein said expandable room portion includes a slide out room movable through a sidewall of a recreational vehicle, said slide out room having a back wall portion larger in dimension than said opening defining a portion of said backwall overlapping said sidewall from the exterior of the vehicle, and further comprising a bulb seal positioned intermediate said overlapping portion and said sidewall.

3. The recreational vehicle of claim 2, wherein said magnetic latching means is comprised of a magnet mounted to an inner surface of said exterior overlapping portion and being attractable towards said sidewall.

4. The recreational vehicle of claim 2, wherein said magnetic means is mounted to said sidewall.

5. The recreational vehicle of claim 4, wherein said magnetic means is mounted to an edge forming said opening.

6. The recreational vehicle of claim 5, wherein said magnetic means includes a channel circumscribing said opening, and further comprising at least one magnet mounted within said channel.

7. The recreational vehicle of claim 6, wherein said magnetic means further includes a ferrous plate mounted to an inner surface of said exterior overlapping portion, for magnetic attraction to said at least one magnet.

8. The recreational vehicle of claim 6, wherein said slide out room further comprises a rear overlapping portion for abutting an inner surface of said sidewall when said slide out room is in the fully extended position, to define an inner overlapping portion, and a seal intermediate said inner overlapping portion and said sidewall.

9. The recreational vehicle of claim 8, wherein said magnetic means further includes a second magnet mounted within said channel, said second magnet being profiled for attracting said inner overlapping portion thereto, retaining said slide out room in the fully extended position.

10. The recreational vehicle of claim 6, including an electromagnet mounted near the at least one magnet, the electromagnet being of differing polarity than the magnet, whereby the electromagnet when activated will repel the magnet from the sealing surface.

11. The recreational vehicle of claim 1, wherein said magnetic means further comprises a camming member and a cooperable camming surface to cam said expandable living area into a sealed condition.

12. The recreational vehicle of claim 11, wherein said magnetic means is comprised of at least one magnet positioned adjacent to said opening.

13. The recreational vehicle of claim 12, wherein said at least one magnet is defined as said camming member.

14. The recreational vehicle of claim 12, wherein said at least one magnet is mounted adjacent to said camming member, with a magnetically member positioned adjacent to said camming surface.

15. A latching mechanism for latching an expandable room section to a main section of a recreational vehicle, wherein the latching mechanism is magnetic.

16. The magnetic latching mechanism set forth in claim 15, wherein said magnetic latching mechanism is comprised of a magnetic member positioned adjacent to either the expandable room section or the main section, and magnetically attractable material positioned adjacent to the other of said expandable room section or the main section.

17. The magnetic latching mechanism as set forth in claim 16, wherein the expandable room has a fascia having a seal thereon, and the fascia is profiled for sealing engagement against a mating surface on the main section.

18. The magnetic latching mechanism as set forth in claim 17, wherein the seal is integral with said magnet.

19. The magnetic latching mechanism as set forth in claim 15, wherein a secondary latching mechanism is provided to latch said expandable room portion when in the fully extended position.

20. The magnetic latching mechanism as set forth in claim 17, wherein said magnets or said magnetically attractable members are mounted within a periphery of a channel portion which circumscribes an opening through a main wall.

21. The magnetic latching mechanism as set forth in claim 20, wherein said secondary latching mechanism is also mounted within said channel member.

22. The magnetic latching mechanism as set forth in claim 21, wherein said expandable portion further comprises a rear fascia portion, whereby when in the fully retracted position said front fascia is adjacent an outer surface of said channel portion, and when in the fully extended position, said rear fascia is adjacent an inner surface of said channel portion, said magnetic member being positioned proximate said outer surface, and said secondary magnets being positioned proximate said inner surface.

23. The magnetic latching mechanism set forth in claim 22, wherein said channel comprises a mounting plate, a slot, parallel side walls, and opposed end walls, the mounting plate being fixed to the outer flange, the magnet floating within the channel such that the magnet seals over the entire length even if the outer flange and the side wall are not parallel.

24. The magnetic latching mechanism set forth in claim 23, wherein a plurality of magnets float in the channel such that the magnetic attraction against the sealing surface is more effective.

25. The magnetic latching mechanism set forth in claim 24, wherein an edge channel is affixed over the side wall, the wiper seal being attached to the edge channel and extending into a gap, the gap being between the edge channel and slide out room side wall.

26. The magnetic latching mechanism set forth in claim 15, further wherein a release mechanism to release said expandable room from the side wall when magnetically latched together.

27. The magnetic latching mechanism set forth in claim 26, wherein the release mechanism is a manual release used to separate the slide out room from the side wall after the two are latched together.

28. The magnetic latching mechanism set forth in claim 27, wherein the manual release comprises a drive rod, a lever, and a cam member drive rod connects the lever to the cam member such that when the lever is pulled, the cam member puts pressure on the slide out room separating the slide out room from the side wall.

29. The magnetic latching mechanism set forth in claim 27, wherein the manual release comprises a lever and a pivot rod the lever rotates around the pivot rod, such that pulling the lever separates the slide out room from the side wall.

30. The magnetic latching mechanism set forth in claim 27, wherein the manual release comprises a handle, a cam member, and a pivot rod, the pivot member is through the cam member in an off center manner, such that pulling the handle causes the cam member to put pressure upon the slide out room, separating the slide out room from the side wall.

31. The magnetic latching mechanism set forth in claim 26, wherein said release mechanism is an automatic release actuated through movement of said expandable room.

32. The magnetic latching mechanism set forth in claim 31, wherein said automatic release mechanism comprises a hydraulic actuator system that when activated provides a force to separate the slide out room and the side wall.

33. The magnetic latching mechanism set forth in claim 16, wherein an electromagnet is mounted near to the magnet, the electromagnet being of opposite polarity than the magnetic member, such that the electromagnet when activated will repel the expandable room from the side wall.

34. The magnetic latching mechanism set forth in claim 16, wherein the magnet is attached to a flexible seal, and the flexible seal being fixed to the outer flange allowing the magnet to be substantially parallel to the sealing surface, the flexible seal preventing elements from getting to the slide out room when the slide out room is retracted.

35. The magnetic latching mechanism set forth in claim 34, wherein a compressible seal is attached to the flexible seal, the compressible seal further sealing the outer flange and the side wall when the slide out room is retracted.

36. The magnetic latching mechanism set forth in claim 15, wherein a booster magnet is located near the magnet, the booster magnet increasing the power of the magnet.

37. The magnetic latching mechanism set forth in claim 36, wherein the booster magnet forms a continuous strip around the entire fascia.

38. The magnetic latching mechanism set forth in claim 15, wherein said excomprising complementary flexible magnet members.

39. The magnetic latching mechanism set forth in claim 38, wherein each flexible magnet member comprises a free end and a captured end.

40. The magnetic latching mechanism set forth in claim 39, wherein said expandable room section is movable through an opening of main section, said first flexible magnet has the captured end mounted adjacent to said opening, and said second flexible magnet has the captured end mounted to, and movable with, said expandable portion.
